(19) United States
(12) Patent Application Publication
(10) Pub. No.: US 2025/0144460 A1
(43) Pub. Date: May 8, 2025

(54) ENVIRONMENTALLY-SAFE WATER-BASED FIRE RETARDANT BIOCHEMICAL COMPOSITIONS FORMULATED USING ALKALI METAL SALTS, FREE FROM PHOSPHATES, NITRATES, AND AMMONIUM-SALTS, FOR NON-CORROSIVE AERIAL AND GROUND DELIVERY ONTO PROPERTY REQUIRING LONG-TERM PROTECTION AGAINST WILDFIRE

(71) Applicant: Mighty Fire Breaker LLC, Lima, OH (US)

(72) Inventor: Stephen Conboy, Carlsbad, CA (US)

(73) Assignee: Mighty Fire Breaker LLC, Lima, OH (US)

(21) Appl. No.: 18/814,508

(22) Filed: Aug. 24, 2024

Related U.S. Application Data
(63) Continuation-in-part of application No. 18/669,077, filed on May 20, 2024.
Application No. 18/669,077 is a continuation-in-part of application No. 18/496,862, filed on Oct. 28, 2023.
Application No. 18/496,862 is a continuation of application No. 17/167,084, filed on Feb. 4, 2021, now Pat. No. 11,865,390.

(51) Int. Cl. A62D 1/00; A62C 3/02; A62C 27/00; C09K 21/02

(52) U.S. Cl. CPC A62D 1/0035; A62C 3/02; C09K 21/02; A62C 3/0242; A62C 3/0271; A62C 27/00; A62D 1/005

(57) ABSTRACT

A fire retarding biochemical liquid composition including: a dispersing agent realized in the form of a major amount of water, for dispersing alkali metal ions dissolved in the water; a major amount of a first fire retarding agent realized in the form of a first alkali metal salt of a nonpolymeric saturated carboxylic acid, specifically, tripotassium citrate, for providing metal potassium ions dispersed in the water when the at least one alkali metal salt is dissolved in the water to form a mixed retardant solution; a minor amount of a second fire retarding agent realized in the form of a second alkali metal salt of a nonpolymeric saturated carboxylic acid, specifically, sodium benzoate (SB), for providing metal sodium ions dispersed in the water when the at least one alkali metal salt is dissolved in the mixed retardant solution, for functioning as a secondary fire retardant agent and also inhibiting surface corrosion reactions involving metals contacting the mixed retardant solution, including specific metals, namely 2024-T3 Aluminum, 4130 Steel, Yellow Brass, and Az31B Magnesium; a minor amount of thickening agent in the form of a biomolecular polymer consisting of polysaccharides, for increasing the viscosity of the mixed retardant liquid during application operations; a minor amount of coloring agent in the form of fugitive color dye powder, or non-fugitive pigment powder, for imparting a visible color (e.g. red or green) when the fire retarding biochemical liquid composition is applied to a surface to be protected against fire, as water molecules in the retardant liquid coating evaporate to the environment during drying, to form a thin fire retardant coating deposited on the treated surfaces having a characteristic visible color, and comprising potassium and sodium salt crystals mixed within the polysaccharides of the biomolecular polymer. Wet and dry concentration formulations of the fire retarding biochemical liquid composition are disclosed for use with both serial and ground delivery methods and apparatus.

### RELATED CASES

The present patent application is a Continuation-in-Part (CIP) of: copending U.S. patent application Ser. No. 18/669,077 filed May 20, 2024, which is a Continuation-in-Past of co-pending: U.S. patent application Ser. No. 18/496,862 filed Oct. 28, 2023, which is a Continuation of U.S. patent application Ser. No. 17/167,084 filed Feb. 4, 2021, now U.S. Pat. No. 11,865,390; wherein each said US patent application is commonly owned by Mighty Fire Breaker LLC and incorporated herein by reference as if fully set forth herein.

### BACKGROUND OF INVENTION

### Field of Invention

The present invention is directed towards improvements in long-term fire retarding (i.e. inhibiting) chemical formulations that are environmentally-clean, water-soluble, non-corrosive and sustainable for use in serial and ground delivery applications, and based on the use of alkali metal salts that protect property against wildfire by reducing the risk of fire ignition and flame spread when applied after dried on treated surfaces.

### BRIEF DESCRIPTION OF THE STATE OF KNOWLEDGE IN THE ART

Conventional methods of wildfire fighting defense are proving inadequate for many reasons including the change in demographics where people live and work relative to presence of wildfire. This is having many consequences including:
Making firebreaks with bulldozers and shovels have not viable in most urbanized communities;
Making firebreaks by lighting backfires ineffective and often dangerous as wildfires themselves;
Making the air-dropping of water-based fire retarding chemical liquid from high above urban areas often dangerous and not viable during proactive wildfire defense.

Current methods of wildfire defense and fighting are becoming unsustainable because the financial losses due to wildfire are exceeding what the insurance industry is willing to insure, as the damage caused by wildfire to the environment is typically catastrophic and destructive. Notwithstanding, any effort to thin or otherwise remove dead trees and debris from ground surfaces will be helpful in reducing the risk of wildfire ignition risk and flame spread in urban regions, especially near power poles, buildings, and utility structures.

FIG. 1 provides a table summarizing the primary conventional methods currently being used when fighting and defending against wild fires and forest fires, alike: aerial water dropping illustrated in FIG. 2A; aerial fire retardant chemical (e.g. PhosChek® MVP-F Fire Retardant) dropping illustrated in FIGS. 2B1, 2B2 and 2B3; physical fire break by bulldozing, to stall the advance of wild fire; physical fire break by pre-burning, to stall the advance of wild fire; and chemical fire breaks by dropping fire retardant chemical such as PhosChek® MVP-F chemical over land, to stall the advance of wild fire.

While these methods are used frequently in the USA, the results have not been adequate in most instances where wild fires rage across land under strong prevailing winds. It will be helpful at this juncture to review the nature of conventional fire retardants being in fighting wildland fires by the USDA Fire Service, and others around the world.

### Composition of Phoschek™ MVP-F Fire Retardant: MAP, DAP, Gum Thickener & Coloring Agent

PhosChek® MVP-F is a dry concentrate formulation that uses a combination of monoammonium phosphate [MAP; NH4H2PO4] and diammonium phosphate [DAP; (NH4)2HPO4] as the fire-retardant salts. PhosChek® MVP-F fire retardant also contains a gum thickener to provide a medium viscosity product for improved drop characteristics. The formulation contains a coloring agent having a fluorescent red color. The color fades over time with exposure to sunlight. A quick look at the chemical composition of the MAP and DAP components of PhosChek® fire retardant will be illuminating.

Monoammonium phosphate (MAP) is soluble in water and crystallizes as the anhydrous salt in the tetragonal system, as elongated prisms, or needles. It is practically insoluble in ethanol. Solid monoammonium phosphate (MAP) can be considered stable in practice for temperatures up to 200° C., when it decomposes into gaseous ammonia NH3 and molten phosphoric acid H3PO4. At 125° C. the partial pressure of ammonia is 0.05 [mm Hg]. A solution of stoichiometric monoammonium phosphate is acidic (pH 4.7 at 0.1% concentration, 4.2 at 5%).

According to the diammonium phosphate MSDS from CF Industries, Inc., decomposition starts as low a 70° C. “Hazardous Decomposition Products: Gradually loses ammonia when exposed to air at room temperature. Decomposes to ammonia and monoammonium phosphate at around 70° C. (158° F.). At 155° C. (311° F.), DAP emits phosphorus oxides, nitrogen oxides and ammonia.”

When air-dropped from planes, the gum thickener contained in PhosChek® MVP-F fire retardant binds MAP and DAP to water to increase the mass and viscosity, to help drop the water-based composition onto a raging wildfire in effort to extinguish it, but less so in applying the fire retardant salt content to combustible surfaces to proactive reduce fire ignition and flame spread. When Phoschek® airdrops are made on targeted property of home owners and towns in effort to protect the targeted property against wildfire, depositing the red-colored Phoschek® MVP-F fire retardant coating all over ground surfaces, the weight of air-dropped fire retarding chemical liquid is often dangerous to people and animals beneath the airplane or helicopter tanker supporting the retardant delivery operations.

Many photographs are posted on the WWW showing the airdropping of Phoschek® MVP-F fire retardant from airplanes and helicopters (i.e. air-tankers). However, these firefighting operations should be viewed as a final effort to save property and lives from a raging wildfire, and the most effective use of a long-term fire retardant formulation, such as Phoschek® MVP-F, would be to apply the water-based chemical retardant long before the arrival of a wildfire so as to proactively create a chemical firebreak on and/or before property to be protected.

While the physical consequences of dropping Phoschek® MVP-F fire retardant from airplanes can be problematic in highly populated areas in the WUI Region, the US EPA has identified other important environmental issues associated with the dispensing of phosphorus-based and nitrogen-based long-term chemical fire retardants, such as Phoschek® MVP-F fire retardant, during aerial liquid retardant drop operations.

While generally not considered harmful to humans, these phosphorus and nitrogen based wildland fire fighting products can cause unintended harm to ecosystems if these chemical products are not used carefully. Components of these mixtures can be toxic to aquatic life (for example, if they are accidentally dropped into streams or bodies of water). For this reason, the US Forest Service has promulgated a policy of not dropping retardant within 300 or more feet of waterways. In addition, use of these fire retardant mixtures may contribute to reduced plant diversity in areas of re-growth after a fire.

Clearly, phosphorus, like nitrogen, is a critical nutrient required for all life. The most common form of phosphorus used by biological organisms is phosphate (PO₄), which plays major roles in the formation of DNA, cellular energy, and cell membranes (and plant cell walls). Phosphorus is also a common ingredient in commercial fertilizers. Through decades of scientific research, testing and study, phosphorus is known to be a significant contributor to freshwater, coastal, and estuarine algal blooms. Too much phosphorus can stimulate excess growth of algae, which leads to: (i) low dissolved oxygen levels; (ii) potential for harmful algal toxins; (iii) blockage of sunlight needed by organisms and plants in the water, and (iv) degraded habitat conditions for benthic macroinvertebrates and other aquatic life—commonly known as “nutrient pollution.” Sources of excess phosphorus to rivers and streams, lakes, and coastal waters include: fertilizers; runoff from urban areas; leaking septic systems; and discharges from wastewater treatment plants.

In appropriate quantities, phosphorus can be used by vegetation and soil microbes for normal growth. However, in excess quantities, phosphorus can lead to water quality problems such as eutrophication and harmful algal growth. Some aquatic resources, such as wetlands, naturally serve as sinks for phosphorus found in sediments or dissolved in water. However, since phosphorus generally occurs in small quantities in the natural environment, even small increases can negatively affect water quality and biological condition.

To make matters even more complex, in the USA, for my long-term fire retardant product to be qualified for use on federal land during wildland firefighting applications (e.g. to be dropped from airplanes, helicopters, and ground-based vehicles alike), the long-tam fire retardant product must be approved by the USDA Fire Service (FS) and listed on the USDA Fire Service's Qualified Product Listing (QPL) that is governed by the USDA FS's “Long-Term Retardant, Wildland Firefighting” Specification 5100-304d dated Jan. 7, 2020 (hereinafter “the USDA FS Specification”).

In general, the USDA FS Long-Term Retardant, Wildland Firefighting Specification 5100-304d covers Products that are intended for use in wildland firefighting. This involves mixing and loading the fire retardant product at mobile or permanent sites (e.g. permanent air tanker bases), and delivering and applying the mixed fire retardant to combustible property from the air and ground. The tests prescribed in the Specification are selected to assess the effectiveness of the products to meet the USDA Fire Service's goals and objectives. The prescribed toxicity and environmental tests are selected to minimize hazards to firefighters, members of the general public, and the environment.

Products that have been submitted for evaluation as described in the Specification 5100-304d and submission procedures associated therewith, and which have successfully met the requirements stated in the Specification, shall be added to the Forest Service Qualified Products List (QPL) with specific use designations based on the requirements for each use or application. Under the Specification, Fire Retardant, Long-Term is a product containing one or more inorganic salts to reduce the intensity of a fire. The product contains water which saves to aid in uniform distribution of the fire retardant salts over the target fuel. The long-term fire-retardant product continues to be an effective fire retardant after the water, that it originally contained, has completely evaporated. In contrast, a fire suppressant is any agent used to extinguish the flaming and glowing phase of combustion by direct application to the burning fuel.

Long-term retardants for fighting fires in Class A fuel are covered by the Specification 5100-304d, and the submitter (e.g. manufacturer or distributer) shall specify the Classifications of the wildland fire chemical product, for which qualification is sought Class A Fuels are materials such as vegetation, wood, cloth, paper, rubber, and some plastics in which combustion can occur at or below the surface of the material. The evaluation under the Specification shall be conducted following teat methods and requirement contained in the Specification, based on the Classifications requested by the submitter, namely:
(i) Wet Concentrate or Dry Concentrate;
(ii) Color or Uncolored;
(iii) Storability;
(iv) Application Methods;
(v) Viscosity Range; and
(vi) Base Type (from which the Product will be deployed/applied).

Each Product Classification submitted under the Specification shall be based on product features detailed in the Specification and defined below.

Wet Concentrate: A long-term retardant Product that consists of a single, liquid component which is mixed with water to prepare a Mixed Product which is a combination of a Wet Concentrate and Water at the qualified Mix Ratio for use in fire management activities. Under the Specification, a Component is each combination of ingredients, packaged together by the manufacturer for use in preparation of the mixed product by the user.

Dry Concentrate: A long-term retardant Product that consists of a single, dry component which is mixed with water to prepare the Mixed Product which is a combination of a Dry Concentrate and Water at the qualified Mix Ratio for use in fire management activities.

Color. A long-term retardant Product may be uncolored or colored. Each mixed product shall be classified as uncolored, non-fugitive (typically iron oxide) colored, or fugitive colored. All products qualified and approved for aerial application of any type shall be either iron oxide colored or fugitive colored. Fugitive Color is any coloring agent which imparts a high degree of visibility to the Mixed Product when first applied to wildland fuels, but will gradually disappear over several months.

In the Specification 5100-304d, the Mix Ratio is the proportion (i.e. ratio) of Concentrate and Water in the Mixed Product.

The Mix Ratio can be expressed in several ways:
Pounds of Dry Concentrate added to a gallon of Water,
Gallons of Wet Concentrate to be added to a gallon of Water;
Volume percentage of Concentrate and Water—typical for foams and wet concentrate water
enhancers.

Storability: All Concentrates shall be evaluated as Stored Products unless qualified as a Pretreatment, Non-Storable Product under the Specification.

Mixed Products. Each Mixed Product shall be classified to indicate the Type and Length of Storage, for which the product is designed, and whether or not recirculation is required or recommended.

Storable (Products. A Storable Concentrate Product should be stable for at least 52 weeks. For dried powder (Dry) Concentrates, the Mixed Product should stable for at least 52 weeks. Products may be recirculated in storage and recirculation may be required to obtain a homogeneous and usable product.

Not Storable (Products). A Not Storable Concentrate Product should be stable for a length of at least 52 weeks. A Mixed Product should be stable for at least 14 days. Products are mixed or blended during transfer to aircraft or other application devices. With Not-Storable Products, minimal additional mixing or recirculation is necessary. These products are not routinely stored in the mixed form, except in application equipment where recirculation is not available.

Pretreatment. Non-storable (Product) Under the Specification, a Pre-treatment Retardant is a product designed specifically for ignition prevention, it is applied prior to an incident in areas at increased risk of wildfire starts, such as roadsides or power line rights-of-way. Pretreatment Products are intended for immediate use only. Thus, Pretreatment, Non-Storable Products are not evaluated for storability beyond 14 days. Also, a Pretreatment Concentrate Product is not storable. Also, a Pretreatment Mixed Product is not storable. A Pretreatment Non-Storable Product shall be used for fire prevention pretreatment only. Pretreatment Products are not qualified for use or storage at permanent airtanker bases. Pretreatment Products are not intended for use in direct support of wildfires. Pretreatment Products are intended for use in helicopter buckets or ground (HB/G) applications only. Pretreatment Products are generally durable, and may remain effective for an extended period of time. However, durability is not evaluated as part of this Forest Service Specification.

Application Methods. Under the Specification 5100-304d, each Mixed Product shall be classified based on the Application Methods listed below:
(i) HF—Fixed-wing (all delivery systems) land-based, multi engine aircraft having a tank and delivery system for serial application of wildland fire chemicals.
(ii) FW—Multi-Engine-Fixed-wing (all delivery systems)—land-based, single-engine (SEAT) aircraft having a tank a [symbol] delivery system for serial application o [symbol] wildland fire chemicals.
(iii) HB/G—Helicopters having a bucket suspended below the helicopter such th [symbol] no chemical is likely to contact the helicopter during normal fire operations al ground-based application equipment such as wildland engines, portable pumps, and other such devices.

Viscosity Range. Each Mixed Product shall be classified based on the Viscosity of the Product. Mixed Products must achieve the desired viscosity by hydration of an appropriate amount of guar gum, guar gum derivatives, xanthan gum, or other thickeners that impart elasticity as well a viscosity. Hydration is the action of a combination of concentrate with water required to produce a thickened product. Viscosity is a measure of the resistance of a liquid to flow, reported in centipoise [cP].
High Viscosity Mixed product with a viscosity between 801 and 1500 centipoise [cP].
Medium Viscosity Mixed product with a viscosity between 401 and 800 [cP].
Low Viscosity Mixed product with a viscosity between 150 and 400 [cP].

Base Type. The evaluation of each Product shall be conducted following the test methods and requirements contained in the Specification, based on the Classifications described.

Qualification for use on specific Base Types shall be determined by the performance and storage needs of the Product.

Temporary/Mobile Bases: Not storable mixed products are suitable; storable products may be suitable. Small volumes of mixed product storage capability and limited auxiliary equipment, including recirculation, are available.

Permanent Bases: Storable mixed products or mixed products made from wet concentrates are suitable. Recirculation is possible, large/long-term storage capability, and auxiliary equipment is readily available.

### Qualification Testing Requirements:

For a Wildland Fire Chemical Product to achieve USDA FS Qualification Product Listing (QPL), the Product must pass Qualification Testing for wildland fire chemical products performed prior to use (Forest Service Manual (FSM) 5100, Chapter 5160, Section 5162).

Testing shall include a laboratory evaluation and may include a field evaluation during firefighting operations as outlined in the Specification.

As part of the Manufacturer Submission Process, the submitter (i.e. manufacturer, distributor, or supplier) shall make a request for evaluation to the USDA Forest Service, Branch Chief for Fire Equipment and Chemicals.

The submitter shall submit a Formulation Disclosure Sheet (SF 5100-37) including the required information on all ingredients contained in the formulation. Full disclosure of the types and amounts of each chemical in the product, the Chemical Abstract Services (CAS) number, quality or grade, and manufacturer or source shall be included for each ingredient. The manufacturing process, manufacturing site, and other related information about each ingredient should also be provided. The submitter shall specify the Mix Ratio for which the product is designed, and qualification is being sought.

The following safety information shall be submitted to the US Government for review, prior to shipping the product for testing:
(i) SDS for each ingredient of the proposed product from the manufacturer/supplier shown on the formulation disclosure sheet.
(ii) SDS for the proposed product from the manufacturer/supplier shown on the formulation disclosure sheet.
(iii) Optional: Summary of any toxicity or related safety test results conducted by or for the manufacturer prior to submission to the US Government.

Also, the submitter shall provide completed Technical Data Sheets (SF 5100-38 and SF 5100-39) providing all required information on the physical properties and characteristics of the long-term retardant. A description of the field mixing and handling requirements shall be included.

Other Technical Information. The submitter shall provide information regarding laboratory mixing, field mixing, handling, loading, and any special cleanup procedures that are required for laboratory or field personnel.

Unacceptable Ingredients. The following ingredients shall not be accepted:
Sodium ferrocyanide (Yellow Prussiate of Soda or YPS)
Dichromates
Thiourea
Borate or other boron-containing compounds
Polychlorinated biphenols (PCB)
Polybrominated diphenyl ethers (PBDE)
Nonylphenol ethoxylates (NPE)
Ammonium Sulfate
Per- and polyfluoroalkyl substances (PFAS), including but not limited to:
   Perfluorooctanoic acid (PFOA)
   Perfluorooctanesulfonate (PFOS) compounds

Environmental and Health Regulations. As part of the overall review, the Government shall complete a review of environmental regulations as they apply to the formulation and the ingredients of the formulation. Specifically, the status of each chemical with regard to the regulatory lists shown below shall be determined.

Additional regulations or restrictions may be added in the future.
a. National Toxicology Program's Annual Report on Carcinogens.
b. International Agency for Research on Cancer (IARC) Monographs for Potential Carcinogens.
c. 40 Code of Federal Regulations (CFR) 355 Appendix A.—Comprehensive Environmental Response, Compensation, and Liability Act (CERCLA), List of Extremely Hazardous Substances and their Threshold Planing Quantities.
d. 40 CFR 302.4. —CERCLA, List of Hazardous Substances and Reportable Quantities.
e. 40 CFR 261.33. —Resources Conservation and Recovery Act (RCRA), Acutely Hazardous and Toxic Wastes.
f. 40 CFR 372. —Superfund Amendment and Reauthorization Act (SARA) Title III, see 313, Emergency Planning and Community Right to Know (EPCRA), Toxic Release Inventory (TRI).

### Chemical Profile and Risk Assessment.

All chemical profiles and risk assessments shall be performed by the Government or an approved third party selected by the Government, using accepted methodology.

Chemical Profile. When no existing chemical profile exists or the existing profile is out of date, a new profile shall be developed by the Government or qualified third party selected by the Government, at Government expense.

Risk Assessment. A risk assessment shall be performed by the Government or a qualified party selected by the Government, at submitter expense, prior to a product placement on the Qualified Products List (QPL). If a risk assessment is required before the laboratory evaluation is performed, based on information developed, the Government shall notify the submitter of the flagged chemicals found during the review of the regulatory lists as required by the Specification.

Environmental Consultation with Relator Agencies. A new product may be included in environmental consultation with the Federal regulatory agencies [U.S. Fish and Wildlife Service (FWS) and National Oceanic and Atmospheric Administration—National Marine Fisheries Service (NMFS)]. The extent of the consultation will be based on the similarities and differences to other products from the same submitter. The composition of a product, the results of laboratory testing required by the Specification, applicable chemical profiles, and product risk assessments will be shared with these regulatory agencies to inform them of the characteristics of the product and assist them in making their determination. The consultation will result in a formal statement of findings from each regulatory agency.

### Health and Safety.

Mammalian Toxicity and Irritation Tests. As required by the Specification, the mammalian toxicity and irritation performance of the concentrate and mixed product shall be determined in accordance with the Specification.

Concentrate. The toxicity of the Wet or Dry Concentrate shall meet the requirements in Table 1 when tested in accordance with the Specification.

Mixed Product. The toxicity of the Mixed Product shall meet the requirements in Table 2 of FIG. 3C2 when tested in accordance with the Specification.
LC50 is the concentration of product in water that results in the death of 50 percent of the aquatic test specimens within a specified time frame. LC50, in this document, is expressed as milligrams of product in a liter of solution.
LD50 is the dosage of a product at which 50 percent of the test animals die within a specified time frame. LD50, in this document, is expressed as milligrams of the product per kilogram of body weight of the test animal.
Report of Mammalian Toxicity and Irritation Test Results. The results of the toxicity testing shall be certified by the testing laboratory and submitted to the Government.
Review of Mammalian Toxicity and Irritation Test Results. When the test results for a concentrate indicate that personal protective equipment/safe handling procedures are needed, the manufacturer shall make recommendations to be added to the product label and the Safety Data Sheet (SDS). The results and related recommendations shall be reviewed by the Government.
Aquatic Toxicity. The LC50 for rainbow trout exposed to the concentrate shall be greater than 200 mg/L when tested in accordance with the Specification
Combustion-Retarding Effectiveness. All mixed retardants shall meet one the combustion retarding effectiveness set forth in the Specification.
Required Retarding Salt Concentration. A product containing one of the following retarding salts or mixtures of salts at or greater than the listed concentrations may not require a burn test
The salt concentration shall be verified by chemical analysis during the evaluation.
   a. Diammonium phosphate (DAP), industrial grade or better (NPK #21-53-0), in the mixed retardant at a concentration of 10.6 percent or greater.
      Fertilizer grade and other lower grades shall be burn tested to establish an acceptable mix ratio.
   b. Monoammonium phosphate (MAP), industrial grade or better (NPK #12-62-0), in the mixed retardant at a concentration of 9.2 percent or greater.
      Fertilizer grade and other lower grades shall be burn tested to establish an acceptable mix ratio.
   c. P2O5 in fertilizer grade ammonium polyphosphates (APP; NPK #10-34-0 or 11-37-0) in the mixed retardant at a concentration of 8.0 percent or greater total phosphate.
   d. Combinations of DAP and MAP, industrial grades or better, having a total of 10.6 percent DAP (NPK #21-53-0) equivalents or greater using the conversion rules described as follows: Use the DAP concentration without conversion; and Use the MAP concentration multiplied by 1.15.
   e. Fertilizer grade DAP or MAP, alone or in combination shall require a burn test.

Combustion-Retarding Effectiveness Test. When a mixed retardant does not meet one of the criteria in the Specification indicated above, the product shall undergo a fire effectiveness test in accordance with the Specification.

Reduction Index. A Redaction Index greater or equal to the Reduction index of the standard chemical, 10.6% percent DAP, shall be acceptable. Reduction Index provides a measure of the reduction in fire intensity (i.e. flame spread and weight loss) during the combustion retarding effectiveness teat.

Physical Properties. In accordance with the Specification, the physical properties of the Dry and Wet Concentrate (Products) and all Mixed Retardants shall be determined as specified in the Specification. These teat results shall define the standard characteristics for the submitted product and be used to address quality issues.

Physical Properties of the Dry Concentrate. In accordance with the Specification, the retarding salt content of the Dry Concentrate Product shall be determined. The values determined shall be used as baseline values for stability tests as required in the Specification. A Retarding Salt is any single salt or combination of salts that impart combustion retarding effectiveness.

Physical Properties of the Wet Concentrate. In accordance with the Specification, the retarding salt content, viscosity, density, and pH of the Wet Concentrate Product shall be determined. The values determined shall be used as baseline values for stability tests as required in the Specification.

Physical Properties of the Mixed Retardant. In accordance with the Specification, the retarding salt content, the refractometer reading, steady-state viscosity, density, and pH of the Mixed Retardant shall be determined. The values determined shall be used as baseline values for stability tests as required in the Specification.

When the mixture is prepared in 70° F. fresh water, no viscosity less than 150 or greater than 1500 centipoise shall be acceptable.

Maximum Density of the Retardant for Aerial Applications. A maximum density of the Mixed Retardant shall be no greater than 9.2 lbs./gallon. If a retardant meets all other criteria but exceeds this maximum density, it will be acceptable for use from ground applications only. Density is the mass in grams of 1 milliliter (mL) of Product.

pH. The pH shall be measured and tested in accordance with the Specification. A pH between 4.0-10.0 pH units is acceptable. pH provides a measure of the acidity or alkalinity of a solution, represented on a numeric scale with 7 representing neutral solutions. Higher numbers represent alkaline solutions, and lower numbers represent acidic solutions.

Materials Effects. As required by the Specification, the effects of the wet concentrate and mixe [symbol] retardant on metallic and non-metallic materials shall be determined in accordance with the Specification. Intergranular Corrosion (IGA). When tested in accordance with the Specification, the alloys specified shall no evidence of intergranular corrosion as summarized in Table 4.

Helicopter Fixed Tank. When tested in accordance with the Specification, coupons made of alloy 2024-T3 aluminum and Az-31B magnesium shall not exhibit intergranular corrosion following exposure to mixed retardant during the uniform corrosion tests.

Multi-Engine, Fixed-Wing Air Tanker. When tested in accordance with the Specification, coupons made of alloy 2024-T3 aluminum shall not exhibit intergranular corrosion following exposure to mixed retardant during the uniform corrosion tests.

Single-Engine, Fixed-Wing Air Tanker. When tested in accordance with the Specification, coupons made of alloy 2024-T3 aluminum shall not exhibit intergranular corrosion following exposure to mixed retardant during the uniform corrosion tests.

Helicopter Bucket and Ground Based Application Equipment. There are no intergranular corrosion requirements for helicopter buckets.

Coupon, for Corrosion. A metal test specimen, approximately 1 in ×4 in ×⅛ in (2.5 cm×10.2 cm×0.3 cm), made of 2024-T3 aluminum, AISI 4130 steel, C26000 yellow brass, or Az31B magnesium for use in uniform corrosion testing.

Coupon, for Large Stability. A metal sample, approximately 2 in×12 in×⅛ in (5 cm×30 cm×0.3 cm), made of mild steel or 2024-T3 aluminum for use in outdoor stability testing.

Effects of Concentrate and Mixed Product on Non-Metallic Materials. In accordance with the Specification, the wet concentrates and all mixed retardants shall be tested to determine their effect on the non-metallic materials listed in Table 5 and their ability to meet the requirements of the Specification.

Effect of Exposure to Wet Concentrate and Mixed Product on Non-Metallic Materials. When tested as required in the Specification, the changes in hardness and volume of each of the materials listed in Table 5 of FIG. 3C5 shall be determined.

Abrasion. When tested in accordance with the Specification, all wet concentrates and mixed retardants prepared from dry concentrates, shall be tested for the abrasiveness of the retardant to aluminum 2024-T3.

Pumpability. When tested in accordance with the Specification, the pumpability of all wet concentrates and mixed retardants prepared from dry concentrates shall be determined. A minimum flow rate of 18 gallons (68.1 liters) per minute is required.

Product Stability. When tested in accordance with the Specification, concentrates and mixed retardants shall meet all applicable requirements of stability set forth in the Specification.

Outdoor Storability. When tested in accordance with the Specification, the concentrate and mixed products shall meet all applicable requirements of the Specification. Compliance with the criteria in Table 6 of FIG. 3C6 shall be determined. Pending the results of this testing, a designation of the stability will be determined a either “Storable” or “Not Storable.”

Concentrates. All concentrates shall meet the requirements of the Specification.

Dry Concentrates. Dry concentrates shall be stored outdoors for 52 weeks, unless product is classified as pretreatment, non-storable as described in the Specification. The stored concentrate shall have no visual separation such as discoloration or caking. Lumps shall fit through a 0.25-inch (0.625 cm) sieve-size. The stored concentrate shall be used to prepare mixed retardant.

Wet Concentrates. Wet concentrates shall be stored outdoors for 52 weeks, unless product is classified as pretreatment, non-storable as described in the Specification.

There shall be no separation resulting in particles larger than 0.25-inch (0.625 cm) sieve-size.
The stored concentrate shall be tested to determine the following properties:
   a. Viscosity,
   b. Density, and
   c. pH.

The results will be evaluated to the pass/fail criteria of Table 7 of FIG. 3C7.

The stored concentrate shall be used to prepare mixed retardant as required in the Specification.

Mixed Retardant from Stored Concentrate. The mixed retardant shall be prepared from the stored concentrate and tested as required in the Specification.

Physical Properties of Mixed Retardant from Stored Concentrate. The mixed retardant shall be prepared and tested to determine the following properties:
a. Steady State Viscosity,
b. Density, and
c. pH.

These values shall be within the allowable variation, as shown in Table 6 of FIG. 3C6. The original values from fresh concentrate are used as the baseline for this testing.

Stability of Mixed Retardant from Stored Concentrate. The mixed retardant shall be stored outdoors for 14 days, in accordance with the Specification, for freshly prepared mixed retardant. All products shall meet the acceptance criteria listed in Table 6 of FIG. 3C6 for the 14-day stability tests. The stored mixed retardant shall be tested as required in the Specification.

Corrosivity of Mixed Retardant from Stored Concentrate. The mixed retardant shall be tested to determine uniform and intergranular corrosion and shall meet the uniform and intergranular corrosion requirements of the Specification.

Outdoor Stability of the Fresh Mixed Retardant. In accordance with the Specification, the fresh mixed retardant shall be stored outdoors for 14 days. At the end of the storage period, the stored mixture shall be examined visually and shall have no separation resulting in particles larger than 0.25-inch (0.635 cm) sieve size. The stored mixed retardant shall be tested as required in the Specification.

Stability of the Mixed Retardant: Storable. In accordance with the Specification, dry concentrate products shall be mixed and stored outdoors for 52 weeks.

Following recirculation, there shall be no separation resulting in crystals or other particles larger than 0.25-in (0.635 cm) sieve size.

The mixed retardant shall be tested to determine the following physical properties:
a. Steady-State Viscosity, in accordance with the Specification,
b. Density, in accordance with the Specification, and
c. pH, in accordance with the Specification.

These values shall be within the allowable variation (from the initial values) of physical properties, on the fresh mixed retardant, as shown in Table 7 in FIG. 3C7. The mixed retardant shall meet the corrosion requirements shown in Table 3 for uniform and intergranular corrosion (Table 4 in FIG. 3C4) when tested in accordance with the Specification.

Stability of the Mixed Retardant: Not Storable. In accordance with the Specification, the mixed retardant shall be stored outdoors for 14 days. Following recirculation, there shall be no separation resulting in crystals or other particles larger than 0.25-in (0.635 cm) sieve size.

The mixed retardant shall be tested to determine the following physical properties:
a. Steady-State Viscosity,
b. Density, and
c. pH.

These values shall be within the allowable variation from the initial values, determined physical properties, on the fresh retardant, as shown in Table 6 of FIG. 3C6.

### Storable and Not-Storable Products.

All wet concentrates shall be evaluated as “Storable” products.
Dry concentrates shall be evaluated for stability in both concentrate and mixed forms.

Optional: Accelerated Stability Testing on Concentrate and Mixed Retardant. In accordance with the Specification, and Appendix A the product concentrate and mixed retardant (prepared from dry concentrate) shall be subjected to temperature cycling. This testing shall only be performed when interim qualification is being sought in accordance with Appendix A of the Specification.

The mixed retardant shall be tested to determine the following properties defined in the Specification:
a. Steady-State Viscosity,
b. Density, and
c. pH.

Changes in these properties shall be calculated and compared to the original results to meet the acceptance values of Table 7 in FIG. 3C7.

The liquid concentrate will be evaluated to the limits of Table 6 in FIG. 3C6. All concentrates shall be used to prepare mixed retardant which shall be tested as required in the Specification.

Mixed Retardant Prepared from Accelerated Stability Testing-Cycled Concentrate.

As required by the Specification, mixed retardant prepared from temperature-cycled concentrate and fresh water shall be tested in accordance with the Specification to determine the following properties defined in the Specification:
a. Steady-State Viscosity,
b. Density, and
c. pH.

Changes in these properties shall be calculated and compared to the original results to meet the acceptance values of Table 6 of FIG. 3C6.

Resistance of Wet Concentrates and Mixed Retardant to Microbial Growth. After 14 days in storage in accordance with the Specification, wet concentrates and mixed retardant shall show no visible sign of microbial contamination, including growths on the surface or within the fluid, significant discoloration, or other change in appearance.

Color Properties. All mixed retardants shall be evaluated in accordance with the Specification and meet the requirements thereof as applicable for the color system used.

Acceptable Colors. Color of the long-term retardants shall be easily identifiable as different from that of colored water enhancers. In accordance with the Specification, Long-term retardant shall be uncolored or a shade of red in the color spectrum greater than 590 nm. Pink hues that don't fail within the conventional color spectrum of visible light may also be permitted at the discretion of the Government.

Opacity of Mixed Retardant. When tested in accordance with the Specification, mixed retardant shall be tested to determine their opacity on a black-white block opacity chat.

Color of Iron-Oxide Colored Retardant. The iron-oxide colored mixed retardant shall contain a minimum of at least 12 grams of iron oxide per gallon to impart red color to the mixed retardant.

Laboratory Evaluation of Fugitive-Colored Mixed Retardant. As required by the Specification, fugitive-colored mixed retardant shall be tested to determine the opacity and fading of films applied in accordance with the Specification

Fading of Fugitive-Colored Mixed Retardant. In accordance with the Specification, at the end of the exposure period, the mixed retardant with fugitive colorant shall be no more colored than a sample of the uncolored mixed product, applied and treated in the same manner as the mixed retardant.

Operational Field Evaluation (OFE). In accordance with the Specification, after meeting requirements thereof, an analysis shall be undertaken to determine the need for an Operational Field Evaluation (OFE). A copy of the analysis shall be provided to the submitter. The analysis will document the rationale for no field test or provide a summary of the issues and performance to be addressed during the field evaluation.

Product for the operational field evaluation shall be purchased by the Government according to the classification established during qualification testing. The product shall perform satisfactorily as determined by the Government under operational conditions during a fire season. An acceptable test should include firefighting operations on a variety of fuel types, slopes, aspects, and exposures. Formulations shall be listed on the QPL as either fully qualified, or interim qualified, prior to an OFE.

### Standard Test Procedures for the Evaluation of Wildland Fire Chemical Products (STP)

Detailed test methods used to evaluate Qualified Products are described in “Standard Test Procedures for the Evaluation of Wildland Fire Chemical Products (STP), and summarized below.

### Health and Safety Testing of Qualified Products:

Mammalian Toxicity and Irritation Tests (STP-1.3). As required by the Specification, mammalian toxicity and irritation test on Wet and Dry Concentrates and the Mixed Retardant, shall be conducted by an independent biological testing laboratory approved by the Government.

All testing shall be conducted in compliance with 40 CFR 160 and 792 Good Laboratory Practice Standards, in accordance with EPA/OCSPP Health Effects Test Guidelines, series 870 and shall include:
a. OCSPP 870.1100, Acute Oral Toxicity
b. OCSPP 870.1200, Acute Dermal Toxicity
c. OCSPP 870.2400; Primary Eye Irritation
d. OCSPP 870.2500; Primary Dermal Irritation

Report of Test Results. The results of the mammalian toxicity and irritation testing shall be certified by the testing laboratory and submitted directly to the Government as required by the Specification.

Review of Mammalian Toxicity and Irritation Test Results. When required in accordance with the Specification, the Government shall review the results of the testing and the submitter's recommended protective gear and safe handling procedures to ensure adequate protection for firefighters and the general public who may come into contact with the product.

Fish Toxicity (STP-1.5). The toxicity of the concentrate to rainbow trout (Oncorhynchus mykiss) shall be determined in accordance with OCSPP 850.1075, Ecological Effects Test Guidelines, Fish Acute Toxicity Test, Freshwater and Marine. Static test (non-renewal) conditions in ASTM soft water (described in ASTM E729) at 12±2° C. shall be maintained throughout the 96-hour test period. All fish shall be 60±15 days post hatch.

Combustion Retarding Effectiveness Test (STP-2.1). When the retardant does not meet the salt content requirements of the Specification, the combustion retarding effectiveness of the mixed retardant shall be determined.

Fuel beds of aspen excelsior or Ponderosa pine needles shall be prepared and treated with mixed retardant or 10.6-percent diammonium phosphate (control) and then dried at standard temperature and humidity to remove the water contained in the retardant or control.

The mixed retardant-treated fuel beds shall be tested and the effect of the mixed retardant on the rate of flame spread, and rate of fuel weight loss determined.

The reduction index shall be calculated by comparing the rate of flame spread and rate of weight loss of the retardant-treated and control-treated beds to the untreated beds made from the same fuels as the treated beds.

Physical Properties. The concentrate and the mixed retardant shall be tested to determine the retarding salt content, refractometer reading, viscosity, steady state viscosity, density, and pH.

Retarding Salt Content Test (STP-4.1). The mixed retardant shall be tested using recognized analytical methods to determine the retarding salt content. Ortho and total phosphate shall be determined in accordance with AOAC accepted tat methods.

Refractometer Reading (STP-4.2). The refractometer reading of a properly mixed retardant shall be determined using a hand-held refractometer that incorporates the arbitrary scale found in industrial fluid testers or the Brix scale when needed.

Viscosity Test (STP-4.5). The viscosity of all wet concentrates and mixed retardants at 70° F. shall be measured using a Brookfield Viscometer, model LVF, or equal, set at 60 rpm with the appropriate spindle. The same spindle shall be used for the initial and final viscosity measurements to determine stability performance.

Steady State Viscosity. The viscosity of the mixed retardant at 10 minutes, 1 hour, 4 hours, 8 hours, 1 day, and daily for 8 days after mixing shall be determined as described in the Specification.

Viscosity values shall be graphed against time. The viscosity value corresponding to the plateau of the viscosity curve, typically 24 hours, shall be determined. This shall be referred to as the steady state viscosity.

Density Test (STP-4.3). The density of the wet concentrate and mixed retardant shall be determined to the nearest 0.001 g/mL by fluid displacement or electronic density meter.

pH Value Test (STP-4.4). The pH of wet concentrates and mixed retardant shall be determined using a full range pH meter, capable of being read to 0.1 pH.

Materials Effects Tests. Wet concentrates and mixed retardant shall be tested to determine uniform and intergranular corrosion of selected alloys and the effects to non-metallic materials.

Uniform Corrosion (STP-5.1). The wet concentrate and mixed retardant, prepared with fresh water, of all concentrates shall be tested for uniform corrosion as summarized below. Test coupons of 2024-T3 aluminum, 4130 steel, UNS C26000 yellow brass, and Az31B magnesium shall be engraved with a unique identification number, measured, cleaned, dried, and weighed. Each coupon shell be immersed in the test solution and allowed to remain undisturbed at the required conditions for 90 days. At the end of the test duration, each coupon shall be cleaned, dried, and weighed, and the corrosion rate calculated. All corrosion rates for the same product, alloy, immersion condition and temperature shall be averaged.

### Effect of Wet Concentrate and Mixed Retardant on Non-Metallic Materials (STP-5.3).

The wet concentrate and all mixed retardants shall be tested to determine their effect on non-metallic materials, as summarized below.

Prior to exposure of the non-metallic materials, the hardness and volume of each non-metallic sample shall be determined. A hand-held durometer shall be used to measure the hardness and either fluid displacement or dimensional analysis shall be used to determine the volume. The test pieces of each non-metallic material shall be exposed for 20 cycles. Each cycle shall consist of the material being immersed in the fluid at night and on weekends and in the air during the work day. At the end of the test period, each test piece shall be rinsed, allowed to air dry, and the hardness and volume of each piece determined on the same day as the exposure ends. The change in hardness and volume from the initial value of each shall be calculated. If the result of either exceeds the allowable maximum, the measurements shall be repeated the next day and the change calculated. No additional measurements shall be allowed. The results of the last set of measurements taken shall be used to determine performance.

Abrasion Test (STP-5.4). The abrasiveness of the wet concentrate or mixed retardant from dry concentrate to aluminum 2024-T3 shall be determined as summarized below.

A disc and a wear plate made of aluminum 2024-T3 shall be installed on the apparatus, parallel to each other with a 0.020-inch (0.5-mm) gap between them, and submerged in retardant. The top plate shall be rotated at 1100 rpm for 50 hours. The plate and disc shall be measured to the nearest 0.001 inch (0.025 mm) before and after the test. The maximum wear on the disc and the wear plate shall be added to determine the total abrasion.

Pumpability Test (STP-7). The pumpability of the wet concentrate or mixed retardant from dry concentrate shall be determined as summarized below.

The test apparatus shall consist of a storage tank, a pump and a scale-mounted weighing tank. The time required for the retardant to be transferred from the storage tank to the weighing tank shall be determined. The change in weight over time shall be used to calculate the flow rate of the product.

Product Stability Test. As required by the Specification, all concentrates and mixed retardant shall be tested for product stability as summarized in the Specification.

Outdoor Storage Test (STP-6.1). Concentrates and mixed retardant shall be tested to determine the effects of storage in outdoor weather conditions.

Concentrates. Each retardant concentrate shall be evaluated to determine outdoor stability in accordance with the Specification.

Dry Concentrates. Each Dry Concentrate shall be evaluated for outdoor stability according to the Specification.

To document the initial condition of the Product, the fresh dry concentrate shall be examined visually to determine the general condition of the concentrate, including the fluidity, presence or absence of lumps, the case of crumbling the lumps, or visually separate layers. The fresh concentrate shall then be stored, in large sample containers outdoors at NTDP-Missoula and NTDP-Sm Dimas for 52 weeks. At the end of the 52 week storage period, the samples shall be examined visually to determine that changes in the general condition, such as fluidity and/or presence of hard lumps, have not occurred. The stored dry concentrate shall be used to prepare mixed retardant in accordance with the Specification.

Wet Concentrates. Each Wet Concentrate shall be evaluated for outdoor stability in accordance with the Specification.

The initial condition of the fresh concentrate shall be documented including the presence or absence of crystals or other solids greater than 0.25 inch (0.635 cm). During outdoor stability testing, a 4130 grade steel coupon is suspended in the fresh concentrate, and the container sealed. The fresh concentrate shall then be stored in large sample containers outdoors at NTDP-Missoula and NTDP-San Dimas for 52 weeks. At the end of the 52 week storage period, the steel coupon shall be removed, and samples shall be inspected to determine that changes in the general condition of the concentrate have not occurred and tested as required in the Specification. The stored concentrate shall be circulated and used to prepare mixed retardant in accordance with the Specification.

Mixed Retardants from Stored Concentrate. The Mixed Retardant Product shall be prepared from Stored Concentrate (i.e. Dry Concentrate or Wet Concentrate) as follows.

The Mixed Product shall be prepared from stored Concentrate and fresh water and tested to determine the density, pH, and steady-state viscosity. The Mixed Product shell be prepared from stored concentrate and fresh water and tested to determine the outdoor stability and corrosivity of the Mixed Retardant produced from stored concentrate.

Mix Retardant. Each Mixed Retardant shall be evaluated to determine outdoor stability in accordance with the Specification.

Storable. The Mixed Retardant shall be stored in large sample containers, each containing a large, 4130 steel stability coupon, outdoors at NTDP-Missoula and NTDP-San Dimas for 52 weeks. At the end of the 52-week storage period, the sample shall be mixed for one minute with low shear (at 1800 rpm) with a 2-bladed propeller-type stirrer. The recirculated sample shall then be tested to determine steady-state viscosity, density, refractometer, and pH value, and to determine uniform corrosion and intergranular corrosion.

Not Storable. The Mixed Retardant shall be stored in large sample containers, each containing a large, 2024-T3 aluminum stability coupon, located outdoors at NTDP-Missoula and NTDP-San Dimas for 14 days. At the end of the 14-day storage period, the sample container shall be opened. The stored product shall be mixed for one minute with low shear (1800 rpm) using a 2-bladed propeller-type stirrer. The recirculated sample shall be tested in accordance with the Specification to determine, steady-state viscosity, density, refractometer, and pH value.

Resistance to Microbial Growth Test. The Mixed Retardant shall be observed, and assessed for microbial contamination. The physical appearance of the Mixed Retardant, including growths on the surface or within the fluid, significant discoloration, or other changes shall be described and recorded at the initiation of the teat and after the 14 days have elapsed.

Color Properties. The iron oxide-colored, fugitive-colored, and uncolored mixed retardant shall be evaluated to determine the color characteristics of the mixed products.

Laboratory Visibility Test of Fugitive-Colored Retardant. The mixed retardant shall be tested to determine the opacity and fading characteristics of the fugitive-colored retardant

Preparation of the Test Panels. The fugitive-colored product and the product without color, as a control, shall be used to prepare the teat panels. Four teat panels of plate glass shall be treated by applying a 0.064 inch (4 GPC) thick layer of the teat product with a Gardner knife or equivalent. Four control panels shall be treated in the same manner with the uncolored product.

Light Exposure of the Mixed Retardant. The test and control panels shall be exposed outdoors to natural light at a test facility acceptable to the Government. All exposures shall be performed in accordance with ASTM G-24 (Standard Recommended Practice for conducting Natural Light Exposures) until 50,000 Langley are accumulated. Visual observations and photographic records shall be made after each 10,000 Langleys of exposure. At the end of the exposure period, the test panels shall be returned to the laboratory for final assessment in accordance with the Specification.

Opacity of the Mixed Retardant. The opacity of the mixed retardant film on black-white block opacity chart shall be determined immediately after application and again after 24 hours.

Assessment of Fading. The acceptability of fading of the test panels shall be assessed.

The outer edges of the film shall not be considered during the assessment. This area, the outer edge of the film, approximately 1 in (2.5 cm), shall be removed or masked.

Each panel shall be examined, and the appearance of the film shall be compared with the appearance of the control panels. The appearance of the panels with the test material shall be neutral in color and not significantly different from the appearance of the control material.

Spectral Evaluation. The mixed retardant shall be tested to determine the spectral color wavelength.

Laboratory Spectral Color Evaluation of Mixed Retardant. The mixed retardant shall be tested to determine the spectral color value in accordance with the Specification.

Spectral Color Analysis. The mixed retardant shall be tested to determine the acceptability to the designated wavelength range. The testing instrument shall be a HunterLab Spectrophotometer (or equivalent) capable of determining L, a, b, color values or other acceptable color-space values.

Operational Field Evaluation (STP-12). The Government shall determine the need for an operational field evaluation (OFE) based on the nature of the formulations and/or results of the laboratory evaluation. All laboratory testing shall be completed prior to conducting an operational field evaluation (OFE). An OFE may be initiated, if all preliminary criteria are met in accordance with requirements for Interim Qualification. When an operational field evaluation is required, a test plan will be developed by the Government. The evaluation will be conducted in accordance with the developed tat plan. Detailed test methods are described in Standard Test Procedures for the Evaluation of Wildland Fire Chemical Products.

Wildland Fire Chemical Products that have been evaluated in accordance with the Standard Test Procedures and satisfy the USDA Forest Service's Specification summarized above, shall be deemed qualified for use in fighting wildland fires on federal property, and listing on the USDA FS's Qualified Product List (QPL).

### Searching for Better Solutions for Fighting Wildfires Fires by Way of Aerial Delivery

Despite the existence of strict quality standards for Wildland Fire Chemical Products established by the USDS Fire Service, as detailed above, it is clear that the use of phosphorous and nitrogen rich fire retardants to defend combustible property against wildfires, does not represent the very best in technology capable of advancing the art of wildland firefighting and promoting greater firefighter and environmental safety, especially within the rapidly expanding wildfire urban interface (WUI) regions across the USA, and countries around the world. Applicant believes the world can and must do significantly better in response to the growing threat of climate-change driven wildfires, and develop better solutions for fighting wildfires and forest fires.

A brief overview of the state of the art in the field of fire inhibiting/retarding chemistry will be very helpful at this juncture.

Back in 2012, U.S. Pat. No. 8,273,813 assigned to BASF Aktiengesellshaft provided a comprehensive overview of the state of the art at that time, representing worldwide efforts to develop and deliver chemical solutions for preventing and fighting wildfires and forest fires around the world.

As disclosed in BASF's U.S. Pat. No. 8,273,813, firefighters have long utilized solutions of inorganic salts, for example, alkali metal or alkaline earth metal salts of carbonic acid, phosphoric acid, or boric acid. The salts augment the extinguishing action of water and are used as concentrated solutions. As disclosed, these inorganic salts are effective because they release inert gases, for example carbon dioxide from carbonates, or melt and so form an air-impervious layer on combustible materials. In either case, access of air to combustible material is controlled. The disadvantage with this approach is the formation of a coating which is later difficult to remove. They have no cooling effect and are barely able to extinguish burning matter, since the latter, like water as well, runs off very rapidly. Any protective effect is solely due to preceding and repeated spraying of objects. A salt solution does not adhere to smooth or waxy objects, such as leaves, planks, or glass panes, to any significant extent, if at all.

Since the 1970s, the use of salts of organic carboxylic acids, for example oxalic acid, tartaric acid, or citric acid, has been known in the field of firefighting. In contradistinction to inorganic salts mentioned above, the coatings formed from the salts of organic carboxylic acids are easy to remove after the fire has been extinguished. Examples of the use of salts of organic carboxylic acids in firefighting are identified in the following patent documents: DE-C 13 02 520, DE-A 35 25 684, EP-A 059 178, EP-A 426 178, U.S. Pat. Nos. 1,278,718, 4,888,136, 5,945,025, and WO 88/00482. A brief overview of these prior art references will be useful at this juncture.

DE-C 13 02 520 discloses the use of alkali metal salts of oxy carboxylic acids in dry extinguishing powders.

DE-A 35 25 684 describes solutions consisting of citric acid/citrate, potassium hydroxide and water that are useful for firefighting and for impregnating combustible materials. More particularly, the solution is said to be capable of binding acidic gases generated in a fire.

EP-A 059 178 describes the use of concentrated solutions of alkali metal salts of citric acid as extinguishing compositions.

EP-A 426 178 discloses fire-retardant asphalt compositions, the fire-retarding component comprising potassium citrate and a silicone polymer.

U.S. Pat. No. 1,278,718 discloses compositions consisting of concentrated solutions of alkali metal salt of citric acid and alkali metal bicarbonate, as filling for fire extinguishers.

U.S. Pat. No. 4,988,136 describes the use of aluminum salts of citric acid and of lactic acid for fire-retarding impregnations of cellulosic fibers.

U.S. Pat. No. 5,945,025 describes compositions of potassium citrate and sodium bicarbonate for firefighting.

WO 88/00482 discloses compositions of matter for firefighting and for producing fire-retarding coatings based on alkali metal salts of citric acid.

The compositions mentioned above can be applied as aqueous solutions and retain their fire-retarding effect even after drying, and therefore, have a pronounced long-term effect in retarding fire ignition and flame spread.

The use of hydrogels was proposed more than 35 years, for example in U.S. Pat. Nos. 3,229,769 and 5,849,210, for the purpose of cooling the source of the fire by retaining water close to the flame. These hydrogels are produced from a water-absorbing polymer and water. The hydrogel binds the water and so stops the water from flowing away from the source of the fire. Because hydrogels can maintain a large amount of water near the fire, hydrogels have a good immediate extinguishing effect. In contrast, the long-term effect of hydrogels is poor. Hydrogels can dry and thereby rapidly lose their effect. The remaining salt-like dried hydrogels have a very low fire-retarding effect.

U.S. Pat. No. 8,273,813 (assigned to BASF) proposed combining water-absorbing polymers with fire-retarding asks to form fire-retarding compositions having a good immediate extinguishing effect and a good long-term effect. This prior art fire retarding chemical solution is schematically depicted in FIG. 3A.

As illustrated in FIG. 3B, Hartindo's aqueous-based anti-fire (AF) chemical solution AF31 employs as its active ingredient, tripotassium citrate, or TPC, dissolved in water, with minor amounts of a natural gum added to provide some cling. Hartidino's AF31 chemical solution has been used by others in many diverse applications, namely: (i) preventing and suppressing peat fires in Malaysia, as disclosed on Hartindo's WWW site, (ii) treating wood to provide Class-A fire-protection as taught in U.S. Pat. No. 10,260,232 (Conboy); and (iii) proactively treating native fuel, ground cover and fixtures and buildings on real property, for the purpose of defending life and property against the threat of wildfires as taught in U.S. Pat. No. 10,653,904.

Clearly, in these times of climate change and narrowing gaps between wildfire regions and urbanized areas, we must adapt to and defend against wildfires in new, better and smarter ways, especially when using aircraft and ground vehicles, containing metal alloy components used to mix, pump, store and apply mixed long-term fire retardant chemical products by aerial delivery on property and ground applications at risk of fire ignition and flame spread in the presence of wildland wildfire.

Thus, there is a great need for better, safer, and more effective fire retardant (i.e. inhibiting) chemical compositions that can be applied to proactively defend property and life from wildfires in the rapidly expanding WUI region, and to do so, (i) without producing smoke and creating risk of injury to firefighters, property owners, animals and the human population at large, (ii) without corroding metal alloy and plastic components used in aerial delivery and ground applications, and (iii) without polluting the air and water of our natural environment, while overcoming the shortcomings and drawbacks of prior art compositions, apparatus, and methodologies.

### OBJECTS AND SUMMARY OF THE PRESENT INVENTION

Accordingly, a primary object of the present is to provide new and improved environmentally-safe water-based fire retardant biochemical compositions formulated using non-corrosive alkali metal salts for mixing with water, free from phosphates, nitrates, nitrogenous compounds, and ammonium-salts, and designed for delivery onto combustible ground surfaces requiring long-term protection against fire ignition and flame spread caused by wildfire, while overcoming the shortcomings and drawbacks of prior art compositions and methods.

Another object of the present invention is to provide new and improved fire retarding biochemical liquid comprising: a dispersing agent realized in the form of a major amount of water, for dispersing alkali metal ions dissolved in the water, a major amount of a first fire retarding agent realized in the form of a first alkali metal salt of a nonpolymeric saturated carboxylic acid, specifically, tripotassium citrate, for providing potassium ions dispersed in the water when the at least one alkali metal salt is dissolved in the water to form a mixed retardant solution; a minor amount of a second fire retarding agent realized in the form of a second alkali metal salt of a nonpolymeric saturated carboxylic acid, specifically, sodium benzoate (SB), for providing sodium ions dispersed in the water when the at least one alkali metal salt is dissolved in the mixed retardant solution, for inhibiting surface corrosion reactions involving metals contacting the mixed retardant solution, including specific metals, namely 2024-T3 Aluminum, 4130 Steel, Yellow Brass, and Az31B Magnesium, while functioning as a secondary fire retardant agent; and a minor amount of thickening agent in the form of a biomolecular polymer consisting of polysaccharide chains, for increasing the viscosity of the mixed retardant liquid during application operations, when the fire retarding biochemical liquid composition is applied to a surface to be protected against fire, while water molecules in the retardant liquid evaporate during drying, to form a thin fire retardant coating not having a characteristic color (e.g. red or green) comprising potassium and sodium salt crystals mixed within polysaccharide chains of biomolecular polymer material, to provide long duration fire protection on the treated surfaces.

Another object of the present invention is to provide such a new and improved fire retarding biochemical liquid, wherein the thickening agent comprises Xanthan gum which is an extracellular polysaccharide produced by the bacterium Xanthomonas, and wherein the primary structure of xanthan gum is a biomolecular polymer that consists of a cellulose backbone of β-glucose-linked β-units substituted on glucose residues replaced by a side-chain trisaccharide.

Another object of the present invention is to provide a new and improved a fire retarding biochemical liquid comprising: a fire inhibiting agent realized in the form of major amount of a first alkali metal salt of a nonpolymeric saturated carboxylic acid, specifically, tripotassium citrate (TPC), for providing metal potassium ions to be dissolved and dispersed in a quantity of water, a minor amount of a second fire retarding agent realized in the form of a second alkali metal salt of a nonpolymeric saturated carboxylic acid, specifically, sodium benzoate (SB), for providing metal sodium ions dispersed in the water when the at least one alkali metal salt is dissolved in the mixed retardant solution, for inhibiting surface corrosion reactions involving metals contacting the mixed retardant solution, including specific metals, namely 2024-T3 Aluminum, 4130 Steel, Yellow Brass, and Az31B Magnesium, while functioning ass secondary fire retarding agent along with the potassium ions; a minor amount of thickening agent such as biomolecular polymer consisting of polysaccharide chains, for increasing the viscosity of the mixed retardant liquid during application operations; a minor amount of coloring agent in the form of fugitive red dye powder or non-fugitive red iron oxide pigment powder, for imparting a visible color (e.g. red or green) of fugitive or non-fugitive type, when the fire retarding biochemical liquid composition is applied to a surface to be protected against fire; wherein the dry powder components described above are mixed together and dissolved in a major amount of water to produce a mixed retardant solution in either read-to-use non-diluted form, or wet concentrate form for mixing with a specified amount of water, to produce a mixed fire retardant product adapted for application to combustible surfaces by serial or ground delivery application, while water molecules in the retardant liquid evaporate during drying, to form a thin fire retardant coating having a characteristic red color and comprising potassium and sodium salt crystals mixed within the polysaccharide chains of biomolecular polymer material, to provide long duration fire protection over the treated combustible surfaces.

Another object of the present invention is to provide a new and improved fire retarding biochemical liquid comprising: a major amount of a first fire retarding agent realized in the form of a first alkali metal salt of a nonpolymeric saturated carboxylic acid, specifically, tripotassium citrate, for providing potassium ions to be dissolved and dispersed in a quantity of water, a minor amount of a second fire retarding agent realized in the form of a second alkali metal salt of a nonpolymeric saturated carboxylic acid, specifically, sodium benzoate (SB), for providing sodium ions dispersed in the water when the at least one alkali metal salt is dissolved in the mixed retardant solution, and for inhibiting surface corrosion reactions involving metals contacting the mixed retardant solution, including specific metals, namely 2024-T3Aluminum, 4130 Steel, Yellow Brass, and Az31B Magnesium, while functioning as a secondary fire retardant agent along with potassium ions from the first fire retarding; a minor amount of thickening agent such as biomolecular polymer consisting of polysaccharide chains, for increasing the viscosity of the mixed retardant liquid during application operations, when the fire retarding biochemical liquid composition is applied to a combustible surface to be protected against fire; wherein the dry powder components described above are mixed together and dissolved in a major amount of water to produce a mixed retardant solution in either read-to-use non-diluted form, or wet concentrate form for mixing with a specified amount of water, for application to combustible surfaces by aerial or ground delivery, while water molecules in the retardant liquid evaporate during drying, form a thin fire retardant coating not having a characteristic color and comprising potassium and sodium salt crystals mixed within the polysaccharide chains of the biomolecular polymer material, to provide long duration fire protection over the treated combustible surfaces.

Another object of the present invention is to provide the environmentally safest fire inhibiting biochemical liquid solutions possible for use in forming, by air-delivery and ground application of alkali metal salt crystal and polysaccharide fire retardant coatings on combustible surfaces to be protected against all sources of fire, including wildfire.

Another object of the present invention is to provide new and improved environmentally-clean biochemicals designed for use in safe and effective proactive long term fire retarding applications.

Another object of the present invention is to provide biochemical retarding compositions that are soluble in water, and safe and non-toxic to the environment and animal and plant life living in it.

Another object of the present invention is to provide a new and improved environmentally-clean aqueous-based fire retarding biochemical liquid composition of the present invention consisting of tripotassium citrate (TPC) as a primary fire retardant salt, sodium benzoate as a secondary fire retardant salt and corrosion inhibiting agent, and a thickening in the form of a biomolecular polymer consisting of polysaccharides, dissolved in a major quantity of water functioning as a solvent, carrier, and dispersant in the chemical composition.

Another object of the present invention is to provide new and improved environmentally-clean wildfire retarding biochemical liquid compositions formulated by (i) dissolving in a major quantity of water, a major amount of tripotassium citrate (TPC) functioning as a primary fire retarding salt, with a minor amount of a second quantity of sodium benzoate added to the water and functioning as a secondary fire retarding salt and also a corrosion inhibiting agent, and a minor amount of thickening agent in the form of a biomolecular polymer consisting of polysaccharides, so as to form a mixed fire retardant solution of desired viscosity for delivery onto ground surface targets, and after applying the mixed retardant solution to the ground surface targets, forming thin fire retarding coatings which, once dried, provide proactive long duration fire protection until dissolved by rainwater and other atmospheric elements.

Another object of the present invention is to provide a new and improved ecologically-friendly mixed fire retarding biochemical liquid composition, based on combining alkali metal salts derived from different kinds of non-polymeric saturated carboxylic acids, and dissolving the alkali metal salts in water with a thickening agent consisting of polysaccharides, so as to form thin fire-retarding alkali metal salt crystal and polysaccharide based coatings, wherein the aqueous-based fire retarding biochemical liquid is formulated using (i) alkali metal potassium salts derived from citric carboxylic acid, (ii) alkali metal sodium salts derived from benzoic carboxylic acid, (iii) the polysaccharides of a biomolecular polymer material, such as wood cellulose fiber, dissolved in a major amount of water, and a (iv) a coloring agent dissolved in the major amount of water to impart a characteristic color (e.g. green) to the mixed fire retarding biochemical liquid for delivery to ground surface targets by way of aerial or ground delivery methods.

Another object of the present invention is to provide a mixed fire retarding biochemical liquid composition comprising: a major amount of water for providing an aqueous solution; a major amount of alkali metal potassium salt derived from citric carboxylic acid dissolved in the aqueous solution; a minor amount of alkali metal sodium salt derived from benzoic carboxylic acid, dissolved in the aqueous solution; a minor amount of thickening agent in the form of polysaccharides of a biomolecular polymer, specifically wood cellulose fiber, dissolved in the aqueous solution; and a minor amount of a coloring agent dissolved in the aqueous solution to form a mixed retardant liquid and impart a characteristic color (e.g. green) of fugitive color type to the mixed fire retarding biochemical liquid for delivery to ground surface targets by way of serial or ground delivery methods, so as to form thin fire-retarding potassium and sodium salt crystal and polysaccharide based coatings, that provide long duration proactive fire protection to the ground surface targets.

These and other benefits and advantages to be gained by using the features of the present invention will become more apparent hereinafter and in the appended Claims to Invention.

### BRIEF DESCRIPTION OF THE DRAWINGS

The following Objects of the Present Invention will become more fully understood when read in conjunction of the Detailed Description of the Illustrative Embodiments, and the appended Drawings, wherein:

FIG. 1 is a table listing conventional prior art methods for fighting and defending against wild fires including (i) serial water drop methods using airplanes and helicopters, (ii) serial fire retardant chemical (e.g. PhosChek® Fire Retardant) drop using airplanes and helicopters, (iii) physical fire breaks formed by bulldozing land and other landscaping methods to remove combustible vegetation from the land, (iv) physical fire breaks by pre-burning combustible material on the land, and (v) chemical fire break by fire retardant chemical drop;

FIG. 2A is a first image illustrating a prior art method of wild fire suppression involving an airplane dropping water on a wild fire from the sky;

FIG. 2B1 is a second image illustrating a prior art method of wild fire suppression involving an airplane dropping prior art chemical fire retardant (e.g. PhosChek®) on a wild fire, from the sky;

FIG. 2B2 is third image showing a prior art ground-based tank containing the chemical fire retardant (e.g. PhosChek® fire retardant chemical) that is shown being contained in a storage tank in FIG. 2B2, and dropped from an airplane in FIG. 2B1;

FIG. 2B3 is a fourth image showing a prior art ground-based tank containing a supply of PhosChek® fire retardant chemical mixed in the tank shown in FIG. 2B3, and dropped from an airplane in FIG. 2B1;

FIG. 2B4 is a schematic representation illustrating the primary components of the PhosChek® fire retardant chemical, namely monoammonium phosphate (MAP), diammonium hydrogen phosphate (DAP) and water;

FIG. 3A is a schematic representation illustrating the primary active components of the fire-retardant chemical disclosed and claimed in BASF's prior art U.S. Pat. No. 8,273,813 to Beck et al., namely tripotassium citrate (TPC) and a water-absorbing polymer dissolved in water,

FIG. 3B is a schematic representation illustrating the primary components of Hartidino's prior art AF-31 fire retardant chemical, namely, tripotassium citrate (TPC) and a natural gum dissolved in water, as described in the Material Safety Data Sheet for Hartindo AF31 (Eco Fire Break) dated Feb. 4, 2013 (File No. DWMS2013);

FIG. 3C is a schematic representation illustrating the prior art Specification 5100-304d dated Jan. 7, 2020, issued by the US Department of Agriculture (USDA) Forest Service (FS) under the title “ONG-TERM RETARDANT, WILDLAND FIREFIGHTING” which governs all wildland fire fighting chemicals registered on the USDA FS's Qualified Product Listing (QPL) and approved for use in firefighting on federally owned/managed land in the USA;

FIG. 3C1 is Table 1 from the prior art USDA FS Specification 5100-304d for Long-Term Wildland Firefighting Retardant, describing the toxicity and irritation requirements for Wet or Dry Concentrate Product manufacture under the USDA FS Specification 5100-304d;

FIG. 3C2 is Table 2 from the prior art USDA FS Specification 5100-304d for Long-Term Wildland Firefighting Retardant, describing the toxicity and irritation requirements for Mixed Product manufactured under the USDA FS Specification 5100-304d;

FIG. 3C3 is Table 3 from the prior art USDA FS Specification 5100-304d for Long-Term Wildland Firefighting Retardant, describing the maximum allowable corrosion rates (mils-per-year) allowed for specific metals, namely 2024-T3Aluminum, 4130 Steel, Yellow Brass, and Az31B Magnesium, when exposed to Wildland Fire Chemical Products under the USDA FS Specification 5100-304d;

FIG. 3C4 is Table 4 from the prior art USDA FS Specification 5100-304d for Long-Term Wildland Firefighting Retardant, describing whether or not intergranular corrosion is allowable for specific alloy metals, namely 2024-T3 Aluminum and Az-31-B Magnesium, when used in specific Application Methods and exposed to Wildland Fire Chemical Products under the USDA FS Specification 5100-304d;

FIG. 3C5 is Table 5 from the prior art USDA FS Specification 5100-304d for Long-Term Wildland Firefighting Retardant, describing the effect of exposure to Wet Concentrate and Mixed Product on Non-Metallic Materials, and determining the changes in hardness and volume of each of the materials, caused by exposure to Wildland Fire Chemical Products under the USDA FS Specification 5100-304d;

FIG. 3C6 is Table 6 from the prior art USDA FS Specification 5100-304d for Long-Term Wildland Firefighting Retardant, describing the allowable variation of physical properties (i.e. steady-state viscosity, density and pH) of Mixed Retardant (stored for 14 days) and Mixed Retardant prepared from Concentrate and stored for 52 weeks, under the USDA FS Specification 5100-304d;

FIG. 3C7 is Table 7 from the prior art USDA FS Specification 5100-304d for Long-Term Wildland Firefighting Retardant, describing the allowable variation of physical properties (i.e. steady-state viscosity, density and pH) of Mixed Retardant (stored for 52 weeks) and Wet Concentrates stored for 52 weeks, under the USDA FS Specification 5100-304d;

FIG. 4A is schematic representation of the wireless system network of the present invention designed for managing the supply, production and delivery of the environmentally-clean mixed fire retarding biochemical liquid products of the present invention on private and public property for the purpose of reducing the risks of property damage and/or destruction and harm to life caused by wild fires;

FIG. 4B is a schematic representation illustrating exemplary multi-spectral imaging (MSI) and hyper-spectral imaging (HSI) based remote sensing technology platforms supported by the US Geological Survey (USGS) Agency including, for example, the MODIS (Moderate Resolution Imaging Spectroradiometer) satellite system, the World View 2 Satellite System, the Octocopter unmanned airborne system (UAS) (e.g. OnyxStar Hydra-12 heavy-lifting drone), and the SenseFly eBee SQ UAS, for use in supporting and practicing the system network of the present invention;

FIG. 4C is a perspective view of the OnyxStar Hyra-12 heavy lifter drone supporting MSI and HSI camera systems, and providing remove data sensing services that can be used to help carry out the GPS-directed methods of wild fire suppression disclosed herein in accordance with the principles of the present invention;

FIG. 5A is a perspective view of an exemplary mobile computing device deployed on the system network of the present invention, supporting (i) the mobile fire retardant management application of the present invention deployed as a component of the system network of the present invention as shown in FIGS. 4A and 4B, a well as (ii) conventional wildfire alert and notification systems as shown in FIGS. 3A through 3E;

FIG. 5B shows a system diagram for an exemplary mobile client computer system deployed on the system network of the present invention;

FIG. 6 is a schematic representation of a specification of the environmentally-clean fire retardant biochemical composition (i.e. aqueous solution) of the present invention for proactively fire-protecting combustible surfaces, comprising (i) a major amount of water, (ii) a major amount of metal alkali salt dissolved in the water, specifically tripotassium citrate (TPC), wherein the resulting water-based liquid solution is stable when mixed so that its chemical components do not precipitate in the aqueous solution when stored in a storage container for long periods, making the aqueous solution ready for use in diverse temperature environments ranging from, for example, about 32 F to about 130 F, (iii) a minor amount of one or more salts derived from another saturated non-polymerized carboxylic acid, specifically sodium benzoate (SB), inhibiting metal alkali ions in the aqueous solution from undergoing chemical reactions with the metal ions present in the surfaces of metal components used in mixing, pumping, storing and applying mixed fire retardant solution during use and application, (iv) a minor amount of colorant (e.g. fugitive dye powder or non-fugitive pigment powder, or no colorant at all) added to the aqueous solution for imparting a particular color (e.g. red) to the aqueous solution during application of the product according to the Specification, and (v) a minor amount of biomolecular polymer (e.g. xanthan gum (XG)) added to the aqueous solution for thickening the solution and increasing its viscosity to a desired amount (e.g. 150-400 cP) so that when the mixed aqueous retardant solution is serially delivered and applied to combustible surface, it forms thin coatings on treated surfaces, comprising metal alkali (potassium and sodium) salt crystals mixed within biomolecular polymer constructed from polysaccharide chains (e.g. xanthan gum), upon the evaporation of water molecules from the applied aqueous mixed retardant solution;

FIG. 6A1 is a schematic representation illustrating the primary components of a “wet concentrate” type of environmentally-clean aqueous-based fire retarding liquid biochemical composition of the present invention consisting of major amounts of tripotassium citrate (TPC), minor amounts of sodium benzoate, minor amounts of Xanthan gum, and minor amounts of fugitive red dye powder, formulated with a major amount of water functioning as a solvent, carrier, and dispersant;

FIG. 6A2 is a schematic representation illustrating the primary components of a “dry concentrate” type of fire retarding biochemical composition of the present invention (i.e. dry concentrate) consisting of major amounts of dry tripotassium citrate monohydrate (TPC), minor amounts of dry powder sodium benzoate, minor amounts of dry powder Xanthan gum, and minor amounts of fugitive red dye powder, as components in a package (e.g. bag or container) prepared and ready for mixing with a predetermined quantity of water functioning as a solvent, carrier and dispersant, to make up a predetermined quantity of environmentally-clean liquid fire retarding biochemical composition (i.e. mixed retardant product) for proactively treating and protecting combustible surfaces, and/or suppressing and extinguishing an active wildfire;

FIG. 6B is a schematic representation of a classification schema for long-term fire retardant biochemical products of present invention formulated according to the USDA FS Specification “Long Term Retardant, Wildland Firefighter” 5100-304d—dated Jan. 7, 2020, comprising (i) Forms of Product namely, Wet Concentrate—applied at a Mix Ratio to yield a Mixed Product, and Dry Concentrate—applied at a Mix Ratio to yield a Mixed Product; Color or Uncolored, namely, Red Iron Oxide Pigment Powder; Fugitive Color, namely Red Dye Powder, and Uncolored (relying on use with GPS-tracking and mapping techniques); Storability, namely >52 Weeks in Dry and Wet Concentrate Forms, and when produced as a Mixed Product; Application Methods, namely, HF—Fixed-wing (all delivery systems) land-based, FW-Multi-Engine-Fixed-wing (all delivery systems)—land-based, single-engine (SEAT) aircraft, and HB/G—Helicopters having a bucket suspended below the helicopter; Viscosity Range, namely, Mixed Product Viscosity, 150 and 400 cP; and Base Type, from which the Product will be deployed/applied, namely Mobile and Stationary Airbases;

FIG. 6C is a schematic representation illustrating a process of forming a fire retardant coating comprising a mixture of potassium and sodium salt crystals and biomolecular polymer material consisting of polysaccharides, such as Xanthan gum, applied to combustible surfaces, such as ground cover, native fuel, plant tissue, tree bark, and other combustible plant tissue and like materials in the wildland regions that are coated with the wet chemical fire retarding biochemical liquid/fluid using aerial application equipment and methods, and comprising the aqueous-based fire retarding (i.e. inhibiting) solution of the present invention as illustrated in FIGS. 6, 6A1, and 6A2 and described herein;

FIG. 7 is a schematic representation of a fire retardant product mixing station located on or near an air and/or ground base supporting aircraft and ground-based vehicles of various types (e.g. air tankers and ground tanker) adapted and equipped for carrying large volumes of Mixed Retardant Product produced in accordance with the principles of the present invention and the USDA FS Specification “Long Term Retardant, Wildland Firefighter” 5100-304d, wherein the fire retardant mixing station employs storage containers for containing dry and wet concentrate products according to the present invention, water tanks and/or sources, mixing tanks with stirring equipment for mixing concentrate and water to form mixed retardant product, pumping systems, piping system and mixers, and storage containers for containing mixed retardant product, and filling equipment for filling delivery vehicles with the mixed retardant product, wherein all such equipment may be made from metal and non-metallic materials that may experience corrosion when coming in contact with alkali metal salts, but not when coming in contact with the dry concentrate products, wet concentrate products, and mixed fire retardant products formulated using water during the mixing stage in accordance with the principles of the present invention;

FIG. 8A is a perspective view of a GPS-tracked aircraft system (i.e. helicopter) adapted for depositing an environmentally-clean fire retarding biochemical liquid of the present invention, from the air onto ground and property surfaces in accordance with the principles of the present invention;

FIG. 8B is a schematic representation of the GPS-tracked aircraft system (i.e. helicopter) shown in FIG. 8A, comprising a GPS-tracked and remotely monitored retardant chemical liquid delivery control subsystem interfaced with a micro-computing platform for monitoring the application of fire retarding biochemical liquid from the aircraft when located at specific GPS-indexed location coordinates, and automatically logging and recording such retardant biochemical liquid application operations within the network database system;

FIG. 9A is a perspective view of an autonomously-driven or remotely-controlled unmanned airborne system (i.e. UAS or “drone”) adapted for delivering retardant chemical liquid on building and ground surfaces for costing/treating the same with environmentally-clean fire retarding biochemical liquid in accordance with the principles of the present invention;

FIG. 9B is a schematic representation of the autonomously-driven or remotely-controlled aircraft system (i.e. drone) shown in FIG. 9A, comprising a GPS-tracked and remotely monitored retardant biochemical liquid application control subsystem interfaced with a micro-computing platform for monitoring the application of fire retarding biochemical liquid from the aircraft when located at specific GPS-indexed location coordinates, and automatically logging and recording such fire retardant application operations within the network database system;

FIG. 10A is a perspective view of a GPS-tracked manned or autonomous vehicle system for applying and treating building and ground surfaces with environmentally-clean fire retarding biochemical liquid, in accordance with the principles of the present invention; and

FIG. 10B is a schematic representation of the manned or autonomously-driven vehicle system shown in FIG. 10A, comprising a GPS-tracked and remotely-monitored retardant biochemical liquid spray control subsystem interfaced with a micro-computing platform for monitoring the application of fire retarding biochemical liquid from the vehicle when located at any specific GPS-indexed location coordinates, and automatically logging and recording such retardant biochemical liquid application operations within the network database system.

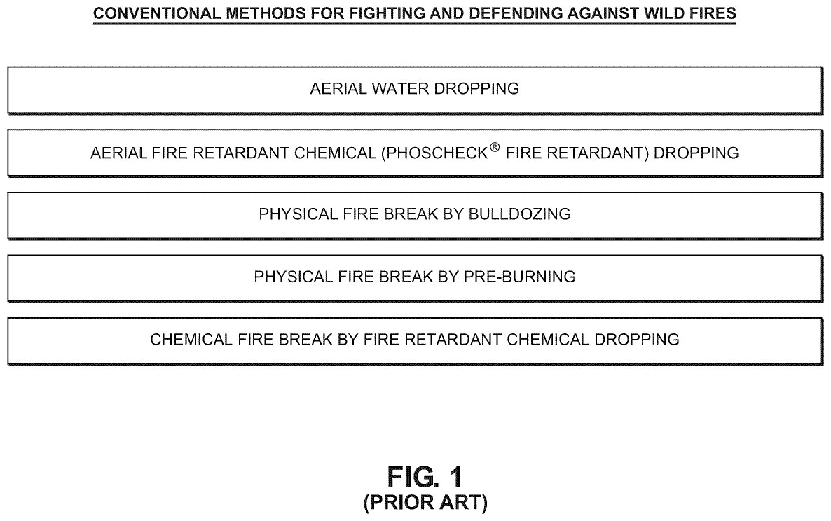

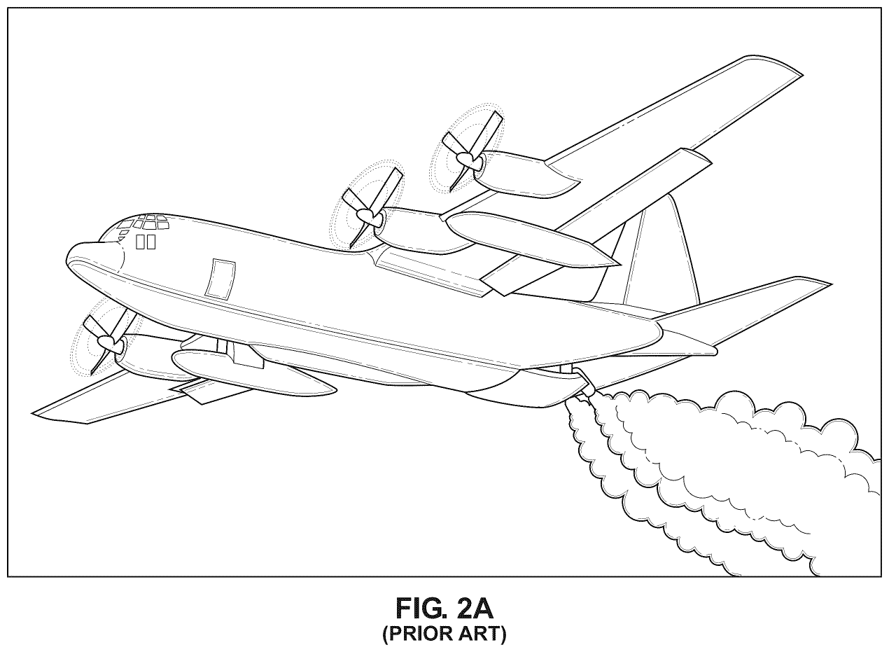

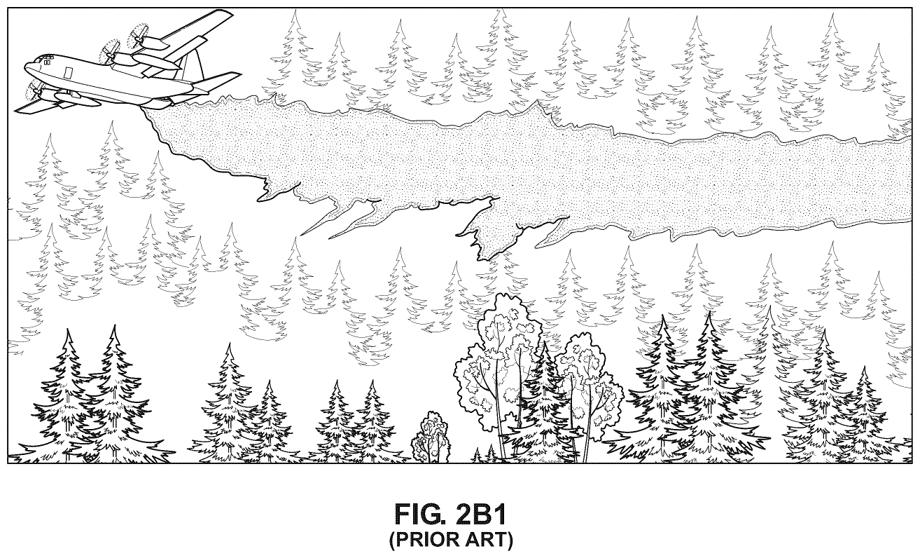

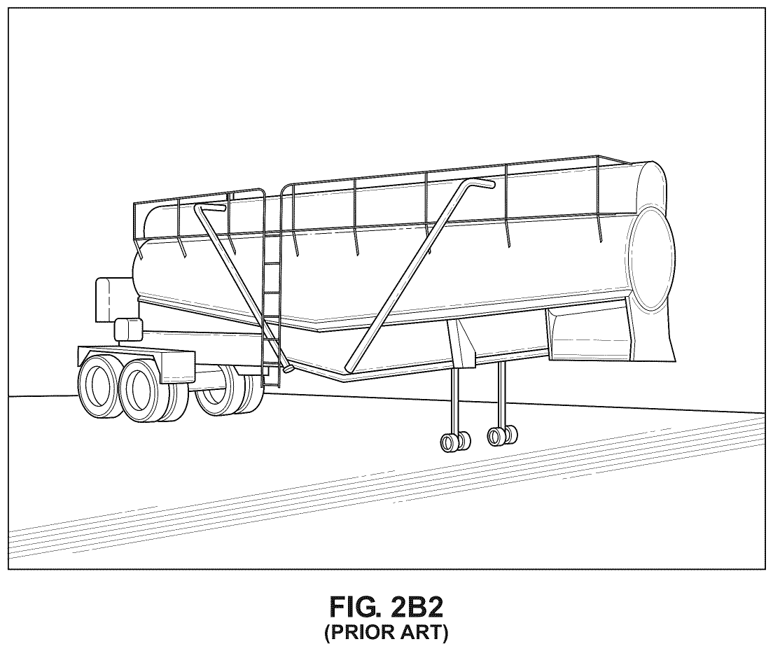

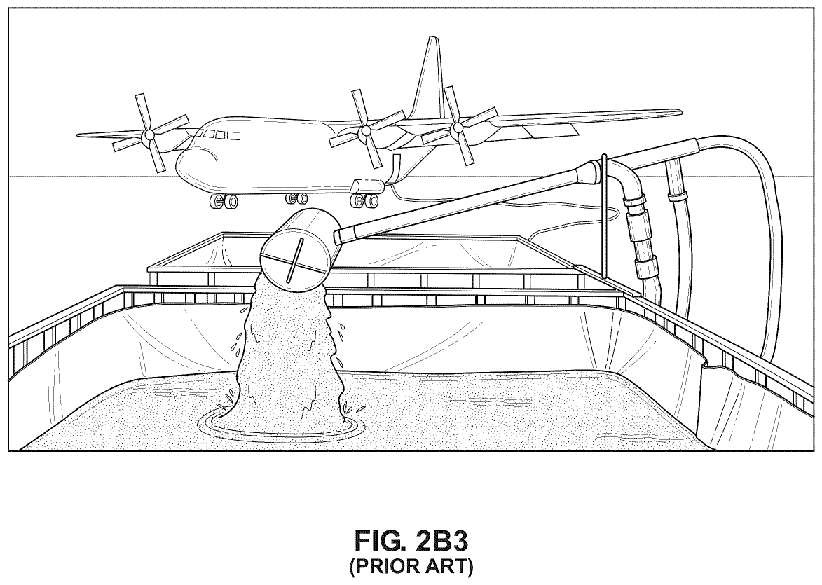

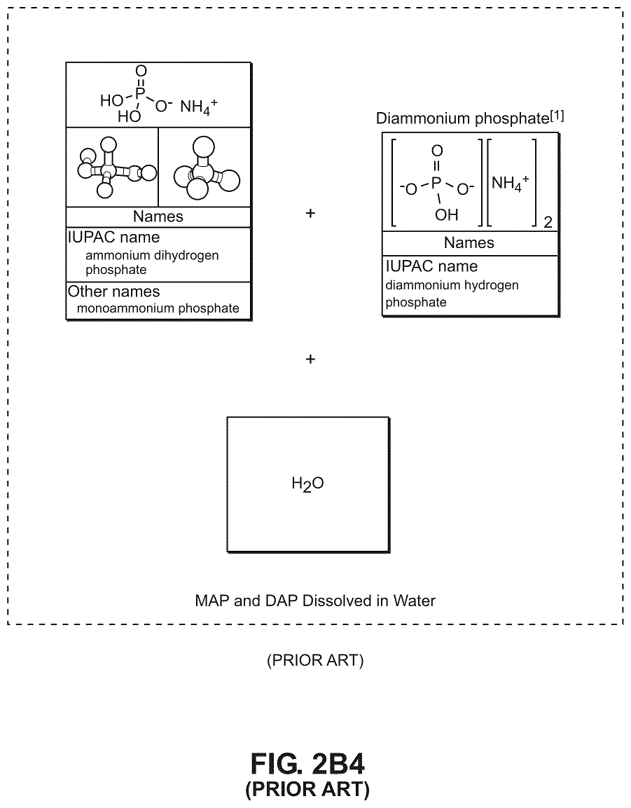

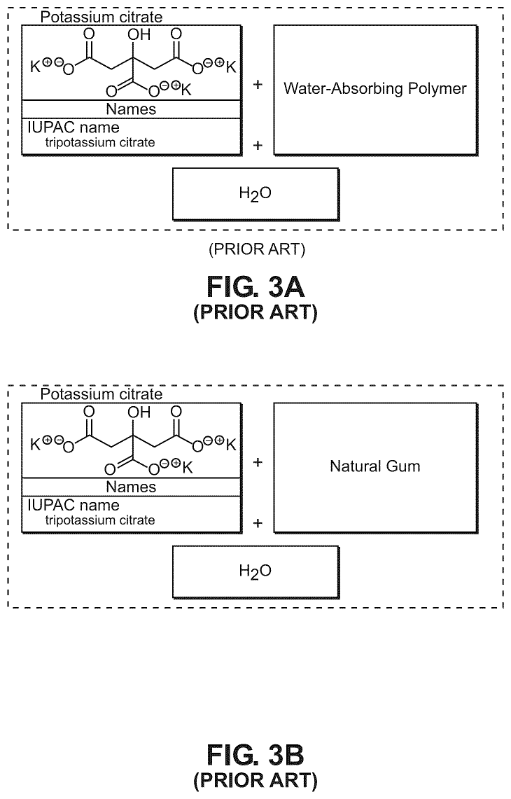

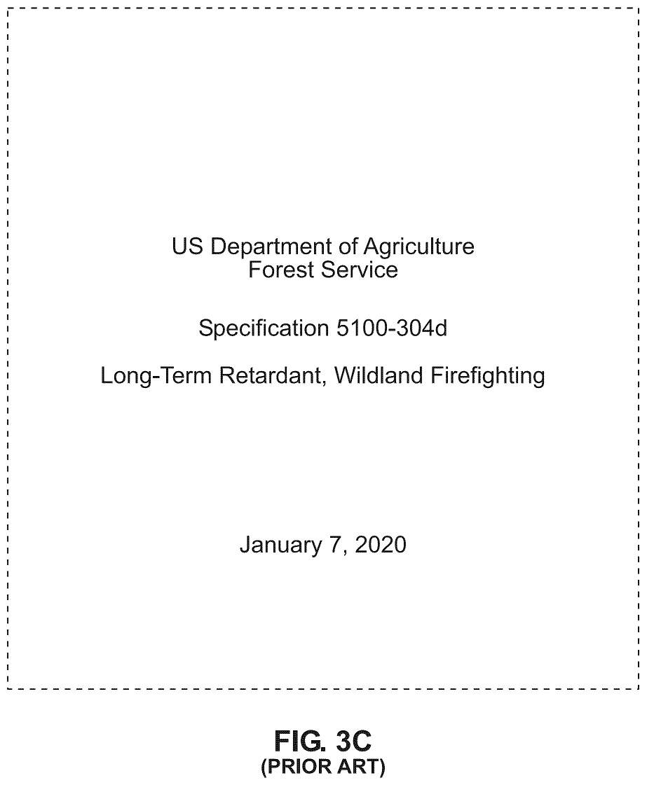

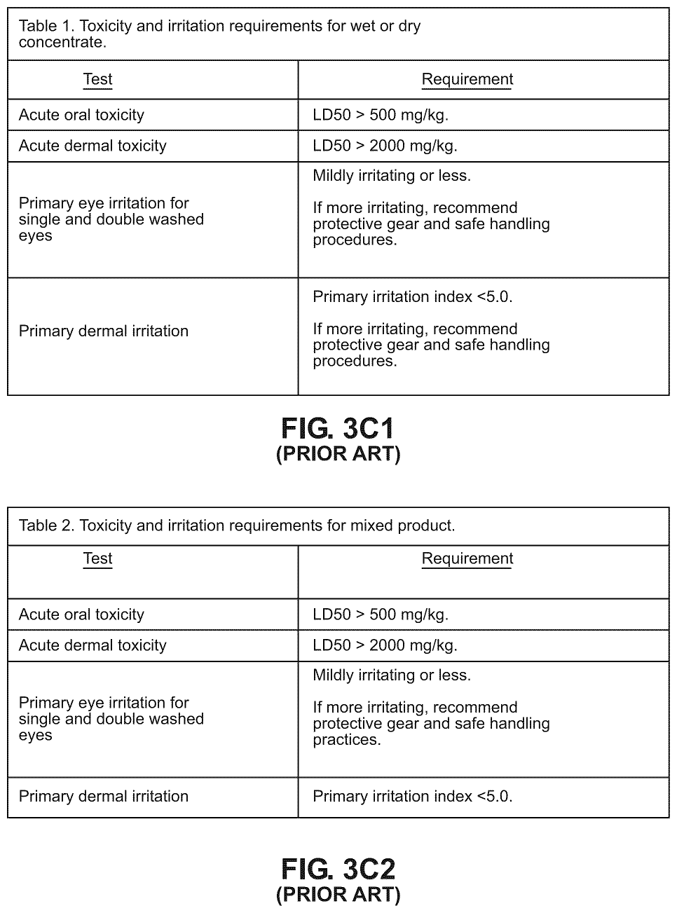

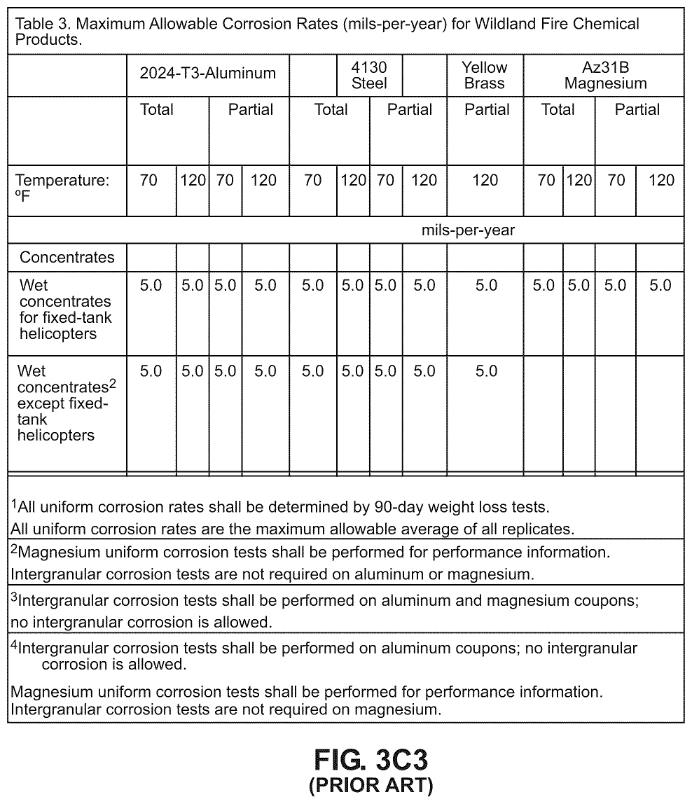

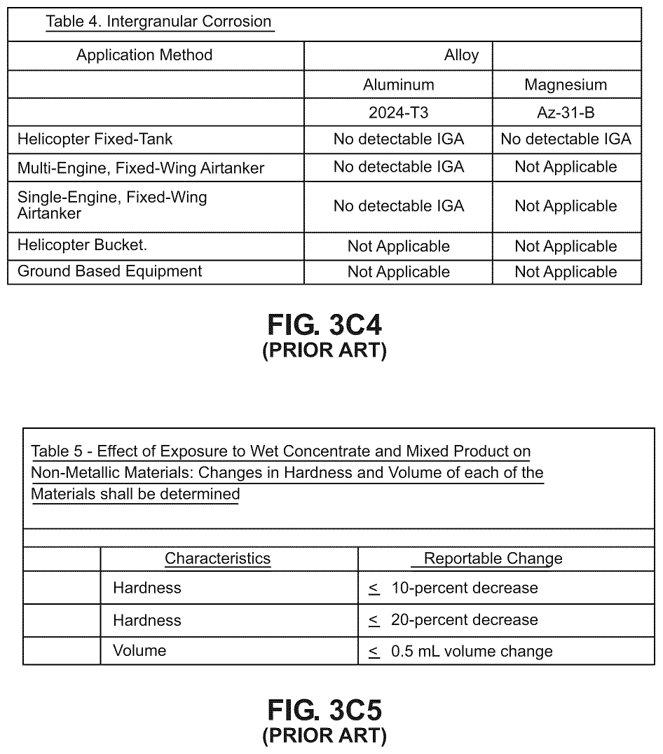

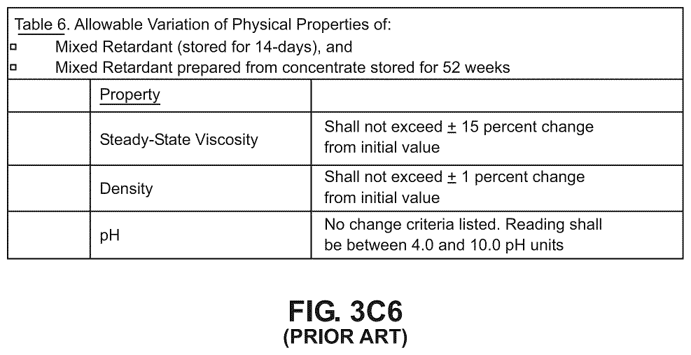

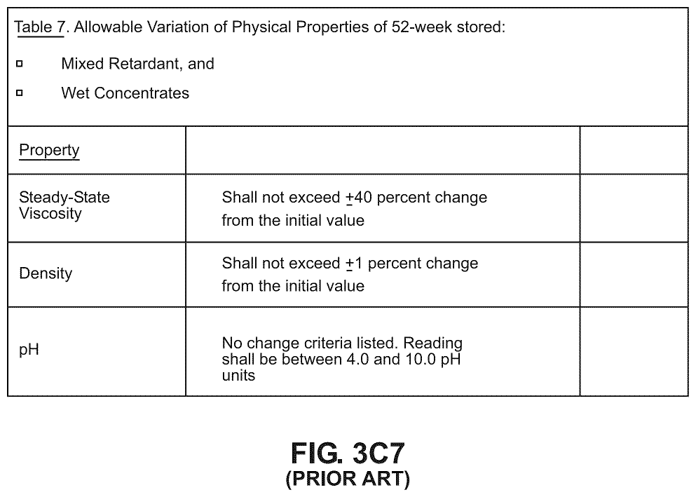

### DETAILED DESCRIPTION OF THE ILLUSTRATIVE EMBODIMENTS OF THE PRESENT INVENTION

Referring to the accompanying Drawings, like structures and elements shown throughout the figures thereof shall be indicated with like reference numerals.

Wireless System Network for Managing the Supply, Delivery and Application of Environmentally-Clean Fire Retarding Biochemical Liquid on Private and Public Property to Reduce the Risks of Damage and/or Destruction Caused by Wild Fires

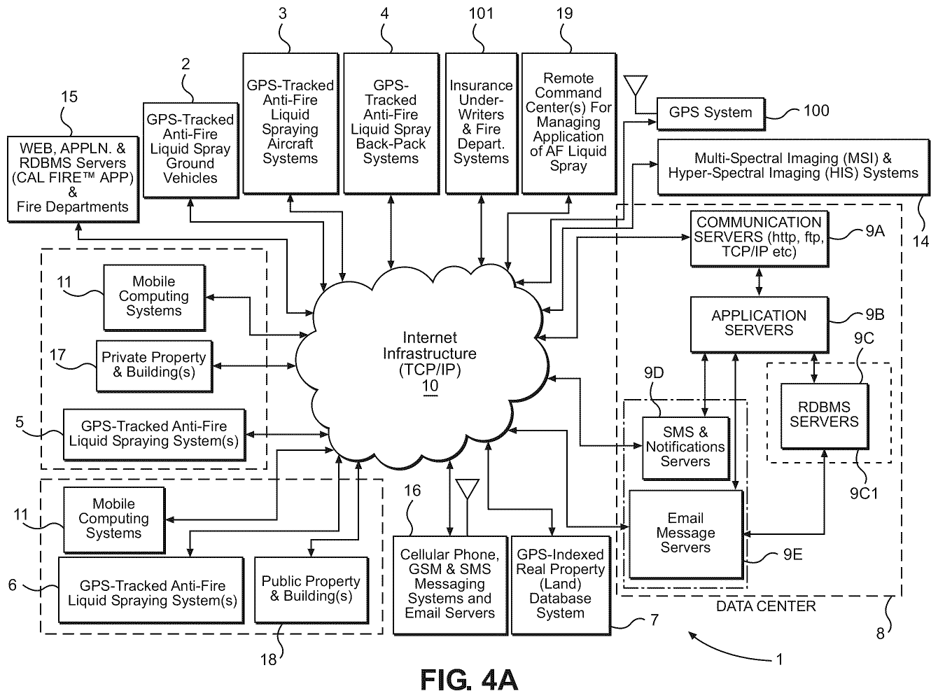

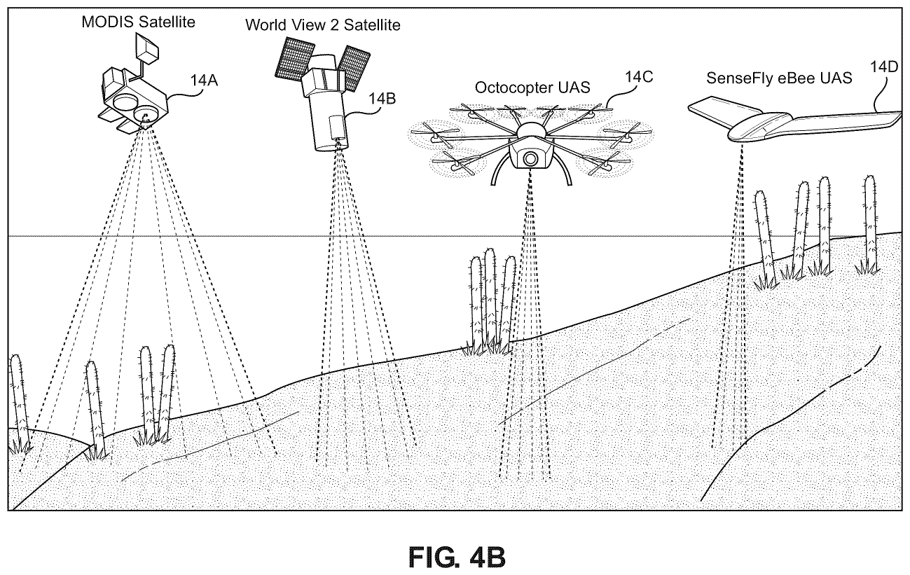

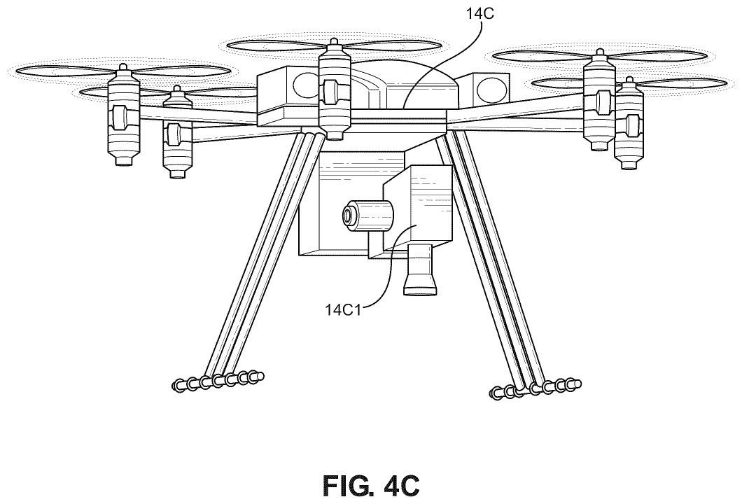

FIG. 4A shows the wireless system network of the present invention 1 designed for managing the supply, delivery, and application of environmentally-clean fire retardant biochemical liquid composition of the present invention, on private and public property to reduce the risks of damage and/or destruction caused by wild fires.

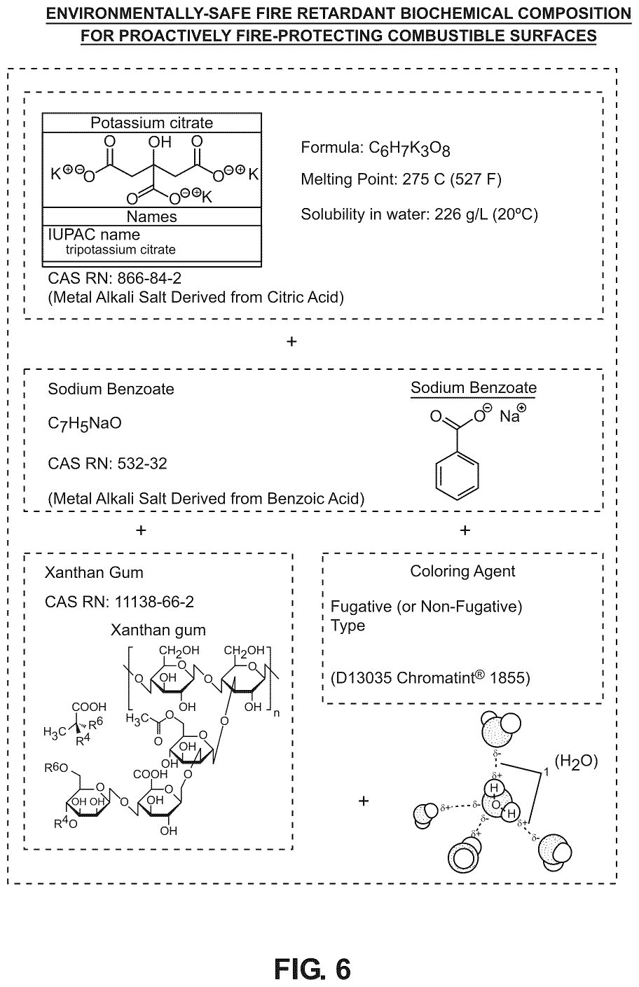

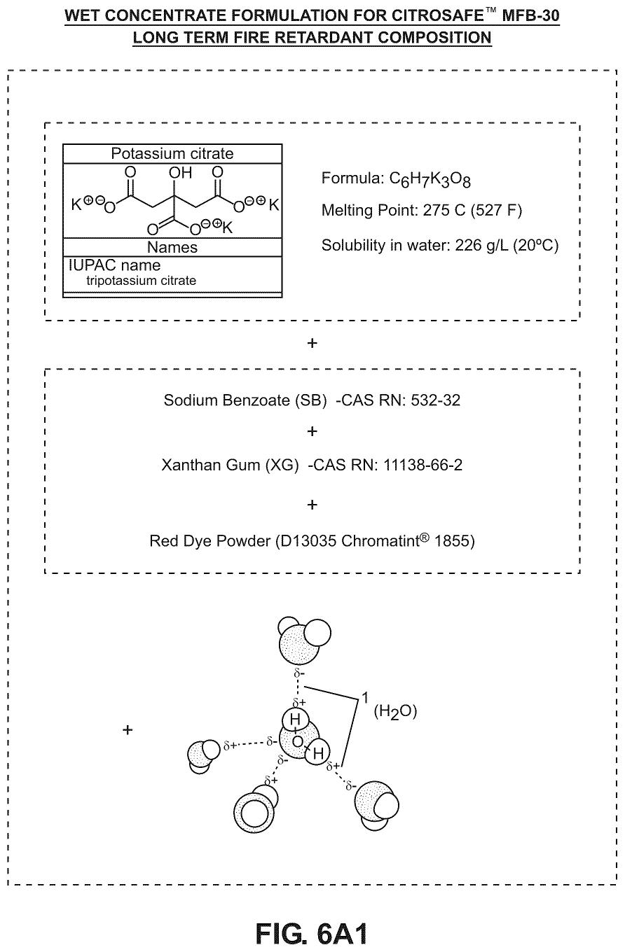

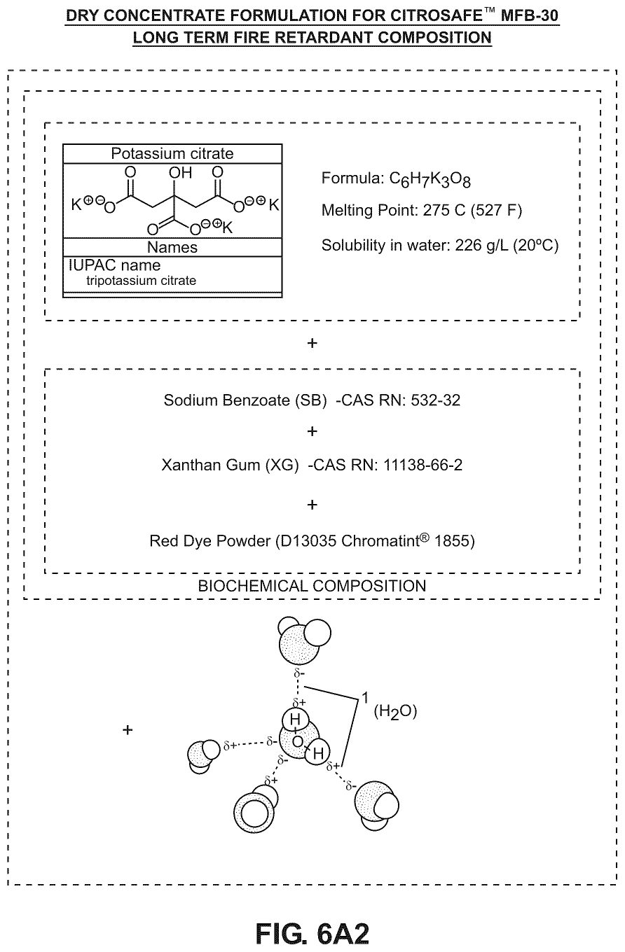

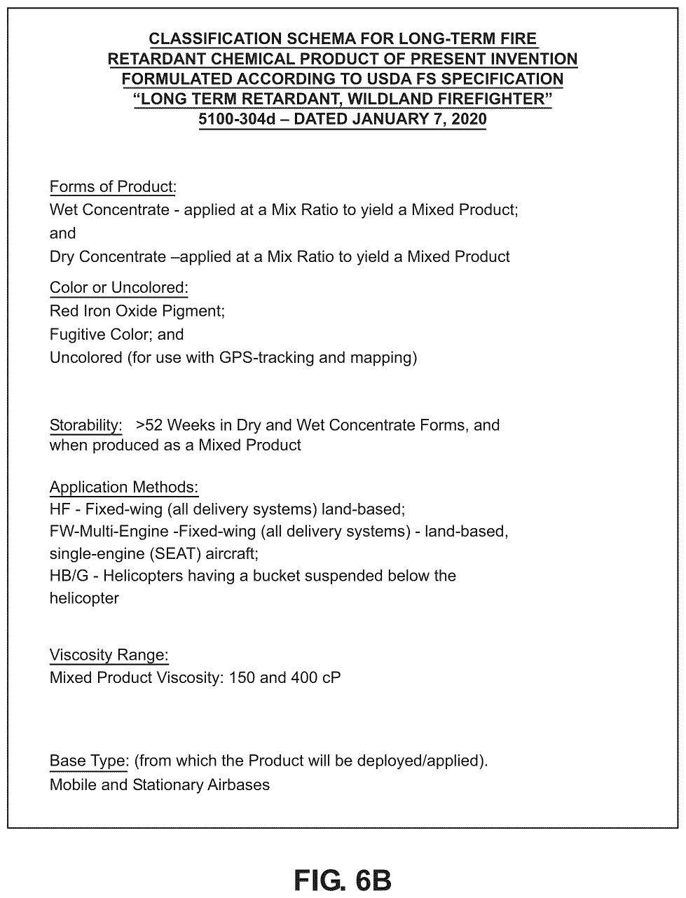

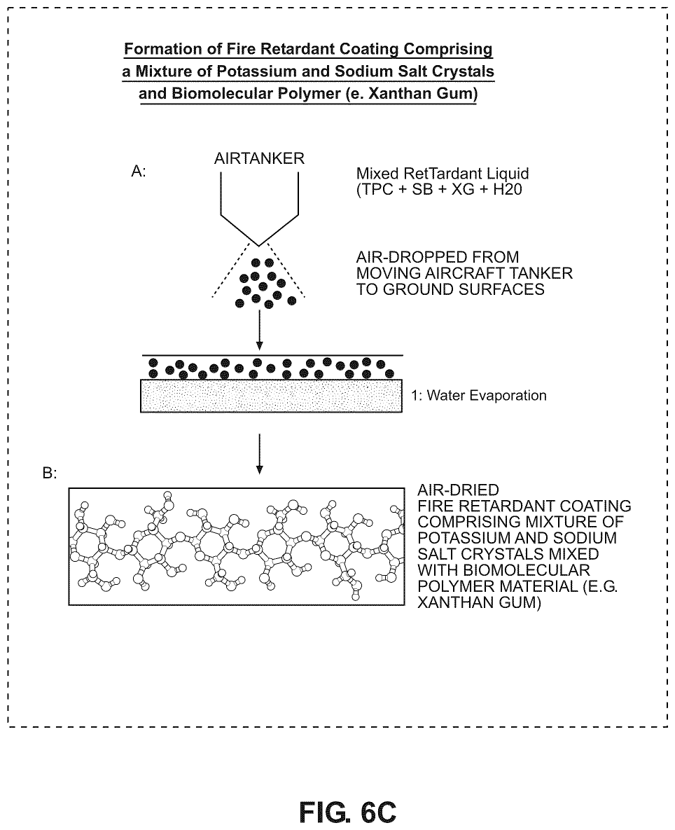

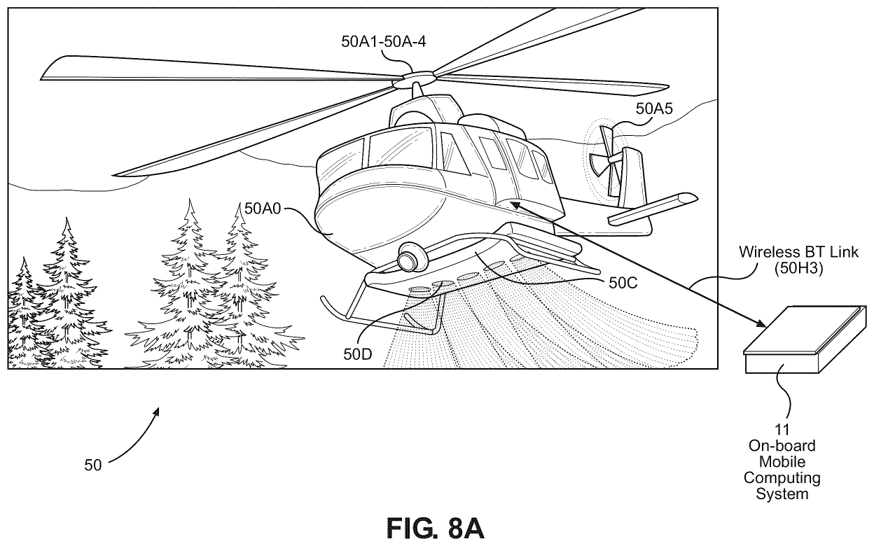

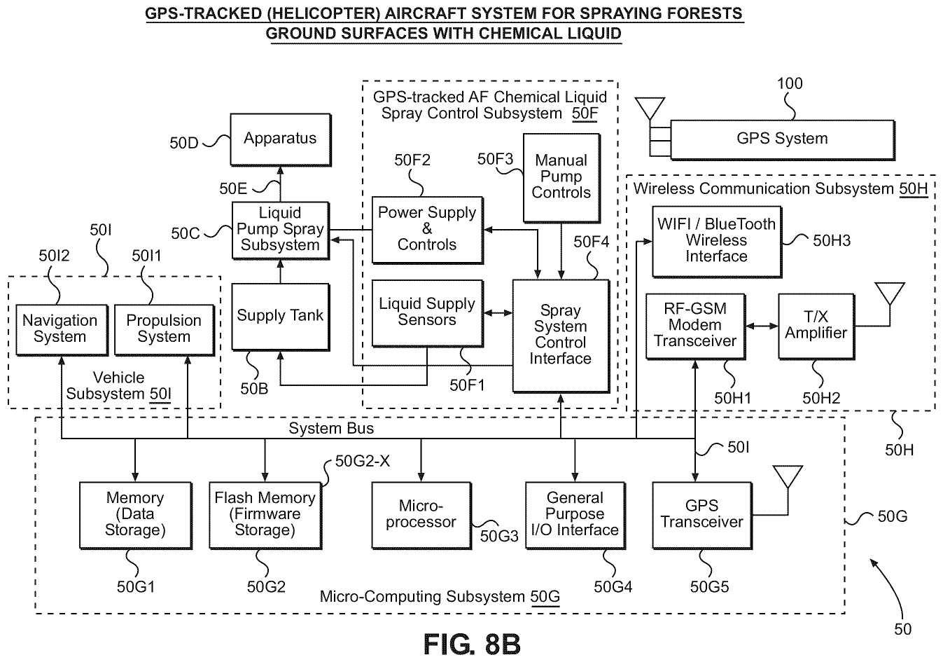

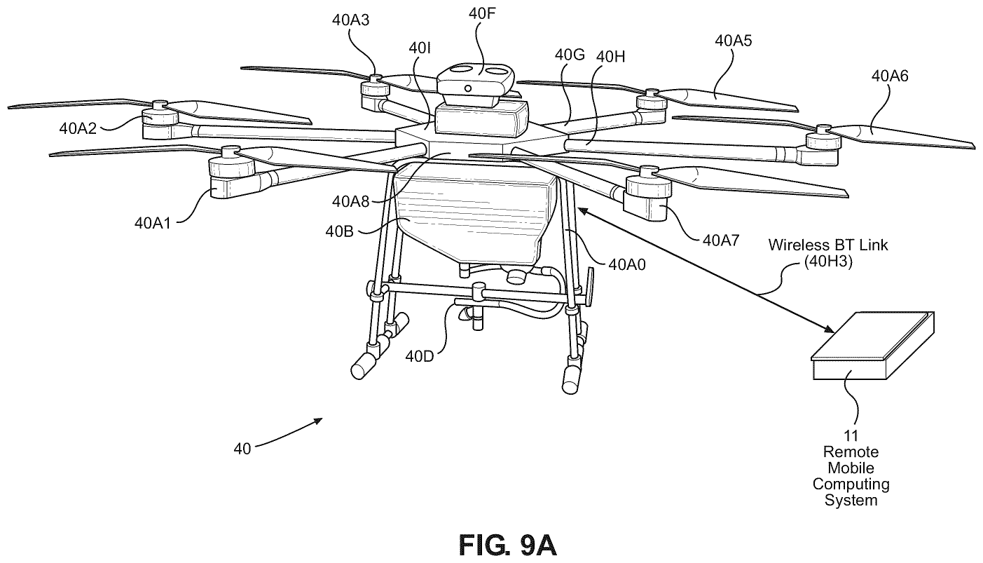

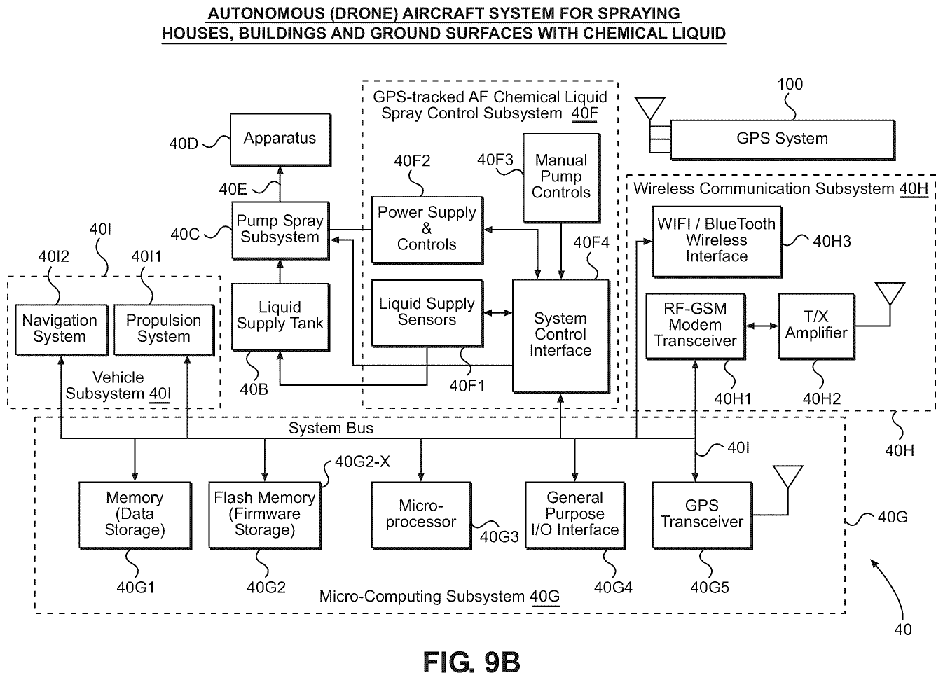

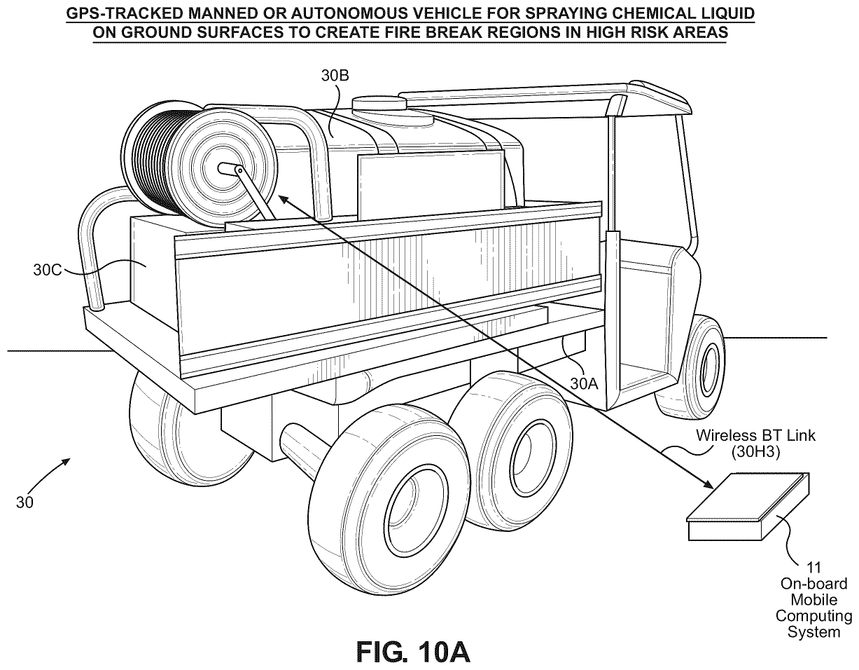

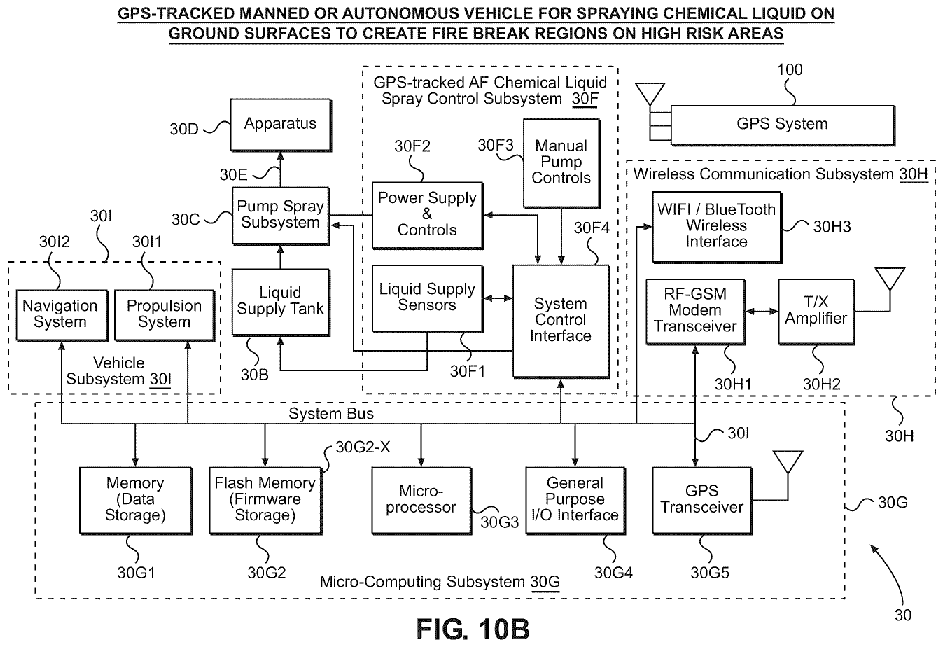

As shown, the wireless system network 1 comprises a distribution of system components, namely: ground-based GPS-tracked/GSM-linked liquid delivery systems 2 (30), as shown in FIG. 10B, for applying fire retarding biochemical liquid (formulated as illustrated in FIGS. 6 through 6C) to combustible surfaces on public real property and buildings and surrounding properties; air-based GPS-tracked fire retarding biochemical liquid delivery vehicles 3 (40, 50, as shown in FIGS. 8A and 9B, for applying fire retarding biochemical liquid of the present invention (formulated as illustrated in FIGS. 6 through 6C) from the air to ground surfaces, brush, bushes and other forms of organic material; GPS-tracked/GSM-linked fire retardant delivery systems 5, 6 (30, 40, and 50) for applying fire retarding biochemical liquid to combustible surfaces on private and public real property and surrounding areas; a GPS-indexed real-property (land) database system 7 for storing the GPS coordinates of the vertices and maps of all land parcels, including private property and building 17 and public property and building 18, situated in every town, county and state in the region over which the system network 1 is used to manage wild fires as they may occur; a cellular phone, GSM, and SMS messaging systems and email servers, collectively 16; and one or more data centers 8 for monitoring and managing GPS-tracking/GSM-linked fire retarding biochemical liquid supply and application systems, including web servers 9A, application savers 9B and database servers 9C (e.g. RDBMS) operably connected to the TCP/IP infrastructure of the Internet 10, and including a network database 9C1, for monitoring and managing the system and network of GPS-tracking fire retarding biochemical liquid application systems and various functions supported by the command center 19, including the management of wild fire suppression and the GPS-guided application of fire retarding biochemical liquid over public and private property, as will be described in greater technical detail hereinafter.

As shown in FIG. 4A, each data center 8 also includes an SMS server 9D and an email message server 9E for communicating with registered users on the system network 1 who use a mobile computing device (e.g. an Applet iPhone or iPad tablet) 11 with the mobile application 12 installed thereon and configured for the purposes described herein. Such communication services will include SMS/text, email and push-notification services known in the mobile communications arts.

During system network operation, the GPS-indexed real-property (land) database system 7 stores the GPS coordinates of the vertices and maps of all land parcels contained in every town, county, and state of the region over which the system network is deployed and used to manage wild fires as they may occur. Typically, databases and data processing methods, equipment and services known in the GPS mapping art, will be used to construct and maintain such GPS-indexed databases 7 for use by the system network of the present invention, when managing GPS-controlled application of clean fire-retardant chemical liquid over GPS-specified parcels of land, at any given time and date, under the management of the system network of the present invention. Examples of such GPS-indexed maps of land parcels are reflected by the task report, and examples of GPS-indexed maps.

As shown in FIG. 4A, the system network 1 also includes a GPS system 100 for transmitting GPS reference signals transmitted from a constellation of GPS satellites deployed in orbit around the Earth, to GPS transceivers installed aboard each GPS-tracking ground-based or air-based fire retarding biochemical liquid application system of the present invention, shown in FIGS. 6A through 10B, as part of the illustrative embodiments. From the GPS signals it receives, each GPS transceiver aboard such fire retarding biochemical liquid application systems is capable of computing in real-time the GPS location of its host system, in terms of longitude and latitude. In the case of the Empire State Building in NYC, NY, its GPS location is specified as: N40° 44.9064′, W073° 59.0735′; and in number only format, as: 40.748440, −73.984559, with the first number indicating latitude, and the second number representing longitude (the minus sign indicates “west”).

As shown in FIG. 4B, the system network 1 further includes multi-spectral imaging (MSI) systems and/or hyper-spectral-imaging (HSI) systems 14 for remotely data sensing and gathering data about wild fires and their progress. Such MSI and HSI systems may be space/satellite-based and/or drone-based (supported on an unmanned airborne vehicle or UAV). Drone-based systems can be remotely-controlled by a human operator, or guided under an artificial intelligence (AI) navigation system. Such AI-based navigation systems may be deployed anywhere, provided access is given to such remote navigation system the system network and its various systems. As the flight time will be limited using available battery technology, there will be a need to provide provisions for recharging the batteries of such drones/UASs in the field. There may also be a need or desire for the actual presence or telepresence of human field personnel to support the flight and remote data sensing and mapping missions of each deployed drone, flying about raging wild fires in connection with the system network of the present invention.

During each wild fire data sensing and mapping mission, carried out by such UAS, a series of MSI images and HSI images can be captured during a wild fire, and mapped to GPS-specific coordinates, and this mapped data can be transmitted back to the system network for storage, analysis and generation of GPS-specified flight plans for fire retarding biochemical liquid delivery operations carried out using methods seeking to stall, retard, and suppress such wild fires, and mitigate risk of damage to property and harm to human and animal life.

FIG. 4B shows a suite of MSI and HSI remote sensing and mapping instruments and technology 14 that is currently being used by the US Geological Survey (USGS) Agency to collect, monitor, analyze, and provide science about natural resource conditions, issues, and problems on Earth. It is an object of the present invention to exploit such instruments and technology when carrying out and practicing the various methods of the present invention disclosed herein. As shown in FIG. 4B, these MSI/HSI remote sensing technologies 14 include: MODIS (Moderate Resolution Imaging Spectro-radiometer) satellite system 14A for generating MODIS imagery subsets from MODIS direct readout data acquired by the USDA Forest Service Remote Sensing Applications Center, to produce satellite fire detection data maps and the like https://fsapps.nwcg.gov/afm/activefiremaps.php; the World View 2 Satellite System 14B manufacture from the Ball Aerospace & Technologies and operated by DigitalGlobe, for providing commercially available panchromatic (B/W) imagery of 0.46 meter resolution, and eight-band multi-spectral imagery with 1.84 meter resolution; Octocopter UAS (e.g. OnyxStar Hyra-12 heavy lifting drone) 14C as shown in FIG. 4B supporting MSI and HSI camera systems for spectral imaging applications, http//www.onyxstar.net and http://www.genidrone.com; and SenseFly eBee SQ UAS 14D for capturing and mapping high-resolution aerial multi-spectral images https://www.sensefly.com/drones/ebee-sq.html.

Any one or more of these types of remote data sensing and capture instruments, tools and technologies can be integrated into and used by the system network 1 for the purpose of (i) determining GPS-specified flight/navigation plans for GPS-tracked fire retarding biochemical liquid application/delivery aircraft and ground-based vehicle systems, described above, and (ii) practicing the various GPS-guided methods of wild fire suppression and described in detail herein.

### Specification of the Network Architecture of the System Network of the Present Invention

FIG. 4A illustrates the network architecture of the system network 1 implemented as a stand-alone platform deployed on the Internet. As shown, the Internet-based system network comprises: cellular phone and SMS messaging systems and email servers 16 operably connected to the TCP/IP infrastructure of the Internet 10; a network of mobile computing systems 11 running enterprise-level mobile application software 12, operably connected to the TCP/IP infrastructure of the Internet 10; an array of mobile GPS-tracked fire retarding biochemical liquid application/delivery systems (20, 30, 40, 50), each provided with GPS-tracking and having wireless internet connectivity with the TCP/IP infrastructure of the Internet 10, using various communication technologies (e.g. GSM, Bluetooth, WIFI, and other wireless networking protocols well known in the wireless communications arts); and one or more industrial-strength data center(s) 8, preferably mirrored with each other and running Border Gateway Protocol (BGP) between its router gateways, and operably connected to the TCP/IP infrastructure of the Internet 10.

As shown in FIG. 4A, each data center 8 comprises: the cluster of communication servers 9A for supporting http and other TCP/IP based communication protocols on the Internet (and hosting Web sites); a cluster of application servers 9B; the cluster of RDBMS servers 9C configured within a distributed file storage and retrieval ecosystem/system, and interfaced around the TCP/IP infrastructure of the Internet well known in the art; the SMS gateway server 9D supporting integrated email and SMS messaging, handling and processing services that enable flexible messaging across the system network, supporting push notifications; and the cluster of email processing servers 9E.

Referring to FIG. 4A, the cluster of communication servers 9A is accessed by web-enabled mobile computing clients 11 (e.g. smart phones, wireless tablet computers, desktop computers, computer workstations, etc.) used by many stakeholders accessing services supported by the system network 1. The cluster of application servers 9A implement many core and compositional object-oriented software modules supporting the system network 1. Typically, the cluster of RDBMS servers 9C use SQL to query and manage datasets residing in its distributed data storage environment, although non-relational data storage methods and technologies such as Apache's Hadoop non-relational distributed data storage system may be used as well.

As shown in FIG. 4A, the system network architecture shows many different kinds of users supported by mobile computing devices 11 running the mobile application 12 of the present invention, namely: the plurality of mobile computing devices 11 running the mobile application 12, used by fire departments and firemen to access services supported by the system network 1; the plurality of mobile computing systems 11 running mobile application 12, used by insurance underwriters and agents to access services on the system network 1; the plurality of mobile computing systems 11 running mobile application 12, used by building architects and their firms to access the services supported by the system network 1; the plurality of mobile client systems 11 (e.g. mobile computers such as iPad, and other Internet-enabled computing devices with graphics display capabilities, etc.) used by spray-project technicians and administrators, and running a native mobile application 12 supported by server-side modules, and various supporting client-side and server-side processes on the system network of the present invention; and a GPS-tracked fire retarding biochemical liquid application/delivery systems 30, 40 and 50 for applying fire retardant on buildings and ground cover to provide protection and defense against wild-fires.

In general, the system network 1 will be realized as an industrial-strength, carrier-class Internet-based network of object-oriented system design, deployed over a global data packet-switched communication network comprising numerous computing systems and networking components, as shown. As such, the information network of the present invention is often referred to herein as the “system” or “system network”. The Internet-based system network can be implemented using any object-oriented integrated development environment (IDE) such as for example: the Java Platform, Enterprise Edition, or Java EE (formerly J2EE); Websphere IDE by IBM; Weblogic IDE by BEA; a non-Java IDE such as Microsoft's .NET IDE; or other suitably configured development and deployment environment well known in the art. Preferably, although not necessary, the entire system of the present invention would be designed according to object-oriented systems engineering (OOSE) methods using UML-based modeling tools such as ROSE by Rational Software, Inc. using an industry-standard Rational Unified Process (RUP) or Enterprise Unified Process (EUP), both well known in the art. Implementation programming languages can include C, Objective C, C, Java, PHP, Python, Google's GO, and other computer programming languages known in the art. Preferably, the system network is deployed as a three-tier server architecture with a double-firewall, and appropriate network switching and routing technologies well known in the art. In some deployments, private/public/hybrid cloud service providers, such Amazon Web Services (AWS), may be used to deploy Kubernetes, an open-source software container/cluster management/orchestration system, for automating deployment, scaling, and management of containerized software applications, such as the mobile enterprise-level application 12 of the present invention, described above.

### Specification of System Architecture of an Exemplary Mobile Smartphone System Deployed on the System Network of the Present Invention

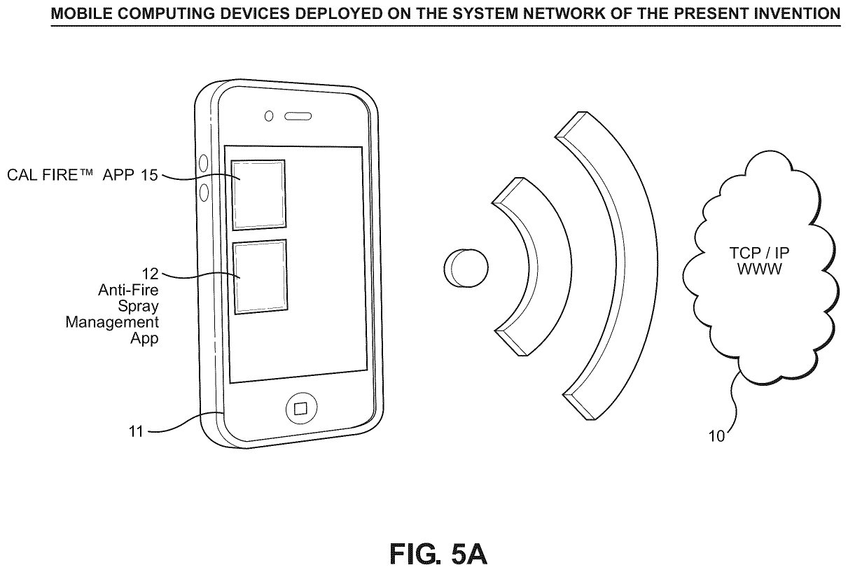

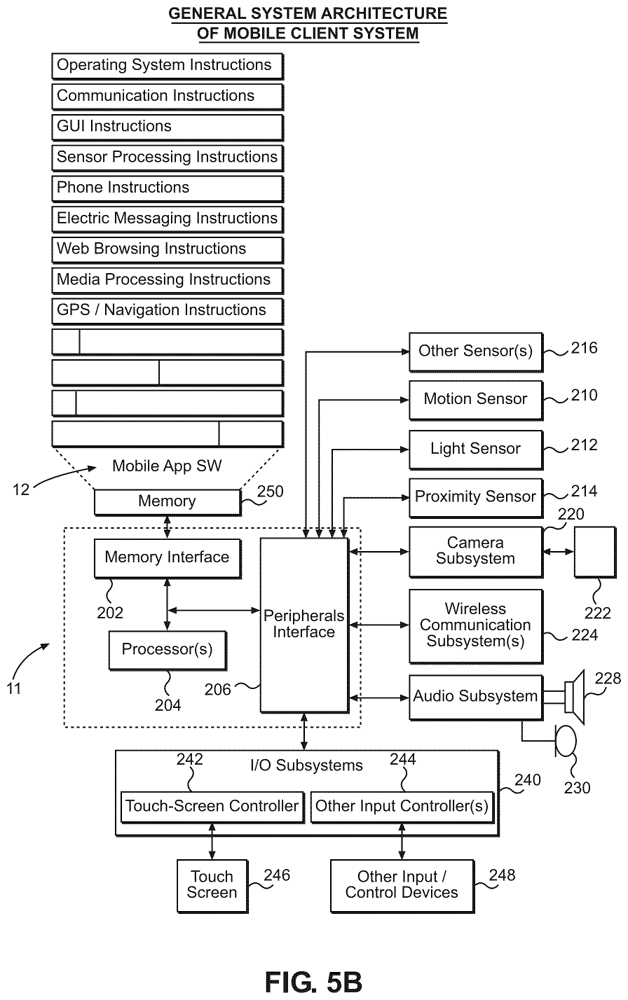

FIG. 5A shows an exemplary mobile computing device 11 deployed on the system network of the present invention, supporting conventional wildfire alert and notification systems (e.g. CAL FIRE® wild fire notification system 14), as well as the mobile fire retardant management application 12 of the present invention, that is deployed as a component of the system network 1.

FIG. 5B shows the system architecture of an exemplary mobile client computing system 11 that is deployed on the system network 1 and supporting the many services offered by system network servers 9A, 9B, 9C, 9D, 9E. As shown, the mobile smartphone device 11 can include a memory interface 202, one or more data processors, image processors and/or central processing units 204, and a peripherals interface 206. The memory interface 202, the one or more processors 204 and/or the peripherals interface 206 can be separate components or can be integrated in one or more integrated circuits. The various components in the mobile device can be coupled by one or more communication buses or signal lines. Sensors, devices, and subsystems can be coupled to the peripherals interface 206 to facilitate multiple functionalities. For example, a motion sensor 210, a light sensor 212, and a proximity sensor 214 can be coupled to the peripherals interface 206 to facilitate the orientation, lighting, and proximity functions. Other sensors 216 can also be connected to the peripherals interface 206, such as a positioning system (e.g. GPS receiver), a temperature sensor, a biometric sensor, a gyroscope, or other sensing device, to facilitate related functionalities. A camera subsystem 220 and an optical sensor 222, e.g. a charged coupled device (CCD) or a complementary metal-oxide semiconductor (CMOS) optical sensor, can be utilized to facilitate camera functions, such as recording photographs and video clips. Communication functions can be facilitated through one or more wireless communication subsystems 224, which can include radio frequency receivers and transmitters and/or optical (e.g. infrared) receivers and transmitters. The specific design and implementation of the communication subsystem 224 can depend on the communication network(s) over which the mobile device is intended to operate. For example, the mobile device 11 may include communication subsystems 224 designed to operate over a GSM network, a GPRS network, an EDGE network, a Wi-Fi or WiMax network, and a Bluetooth™ network. In particular, the wireless communication subsystems 224 may include hosting protocols such that the device 11 may be configured as a base station for other wireless devices. An audio subsystem 226 can be coupled to a speaker 228 and a microphone 230 to facilitate voice-enabled functions, such as voice recognition, voice replication, digital recording, and telephony functions. The I/O subsystem 240 can include a touch screen controller 242 and/or other input controller(s) 244. The touch-screen controller 242 can be coupled to a touch screen 246. The touch screen 246 and touch screen controller 242 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 246. The other input controller(s) 244 can be coupled to other input/control devices 248, such as one or more buttons, rocker switches, thumb-wheel, infrared port, USB port, and/or a pointer device such as a stylus. The one or more buttons (not shown) can include an up/down button for volume control of the speaker 228 and/or the microphone 230. Such buttons and controls can be implemented as a hardware objects, or touch-screen graphical interface objects, touched and controlled by the system user. Additional features of mobile smartphone device 11 can be found in U.S. Pat. No. 8,631,358 incorporated herein by reference in its entirety.

### Different Ways of Implementing the Mobile Client Machines and Devices on the System Network of the Present Invention

In one illustrative embodiment, the enterprise-level system network is realized as a robust suite of hosted services delivered to Web-based client subsystems 1 using an application service provider (ASP) model In this embodiment, the Web-enabled mobile application 12 can be realized using a web-browser application running on the operating system (OS) (e.g. Linux, Application IOS, etc.) of a mobile computing device 11 to support online modes of system operation, only. However, it is understood that some or all the services provided by the system network 1 can be accessed using Java clients, or a native client application, running on the operating system of a client computing device, to support both online and limited off-line modes of system operation. In such embodiments, the native mobile application 12 would have access to local memory (e.g. a local RDBMS) on the client device 11, accessible during off-line modes of operation to enable consumers to use certain or many of the system functions supported by the system network during off-line/off-network modes of operation. It is also possible to store in the local RDBMS of the mobile computing device 11 most if not all relevant data collected by the mobile application for any fire-protection project, and to automatically synchronize the dataset for users projects against the master datasets maintained in the system network database 9C1, within the data center 8 shown in FIG. 4A. This way, when using a native application, during off-line modes of operation, the user will be able to access and review relevant information regarding any building fire protection project, and make necessary decisions, even while off-line (i.e. not having access to the system network).

As shown and described herein, the system network 1 has been designed for several different kinds of user roles including, for example, but not limited to: (i) public and private property owners, residents, fire departments, local, county, state, and federal officials; and (ii) wild fire suppression administrators, contractors, technicians et al registered on the system network. Depending on which role, for which the user requests registration, the system network will request different sets of registration information, including name of user, address, contact information, etc. In the case of a web-based responsive application on the mobile computing device 11, once a user has successfully registered with the system network, the system network will automatically serve a native client GUI, or an HTML5 GUI, adapted for the registered user. Thereafter, when the user logs into the system network, using his/her account name and password, the system network will automatically generate and serve GUI screens described below for the role that the user has been registered with the system network.

In the illustrative embodiment, the client-side of the system network 1 can be realized as mobile web-browser application, or as a native application, each having a “responsive-design” and adapted to run on any client computing device (e.g. iPhone, iPad, Android, or other Web-enabled computing device) 11 and designed for use by anyone interested in managing, monitoring, and working to defend against the threat of wild fires.

Specification of Environmentally-Clean Aqueous-Based Liquid Fire Retardant Bio-Chemical Compositions and Formulations and Methods of Making the Same in Accordance with the Principles of the Present Invention

Another object of the present invention is to provide new and improved family of environmentally-clean (“i.e. Green”) aqueous-based fire retardant biochemical solutions (i.e. wet concentrate liquid compositions, and dry concentrate powder compositions) for producing (i) mixed biochemical fire retardant products that demonstrate good immediate extinguishing effects when applied to extinguish a burning or smoldering fire, and (ii) very good long-term fire retarding effects when proactively applied on combustible surfaces so as to protect against the threat of fire, by forming thin fire retardant coatings on combustible surfaces, comprising alkali metal potassium and sodium salt crystals mixed within the polysaccharide chains of the biomolecular polymer material added to the mixed fire retarding biochemical liquid, providing a long duration of persistent fire protection long after the water molecules in the applied mixed retardant product have evaporated to the ambient environment.

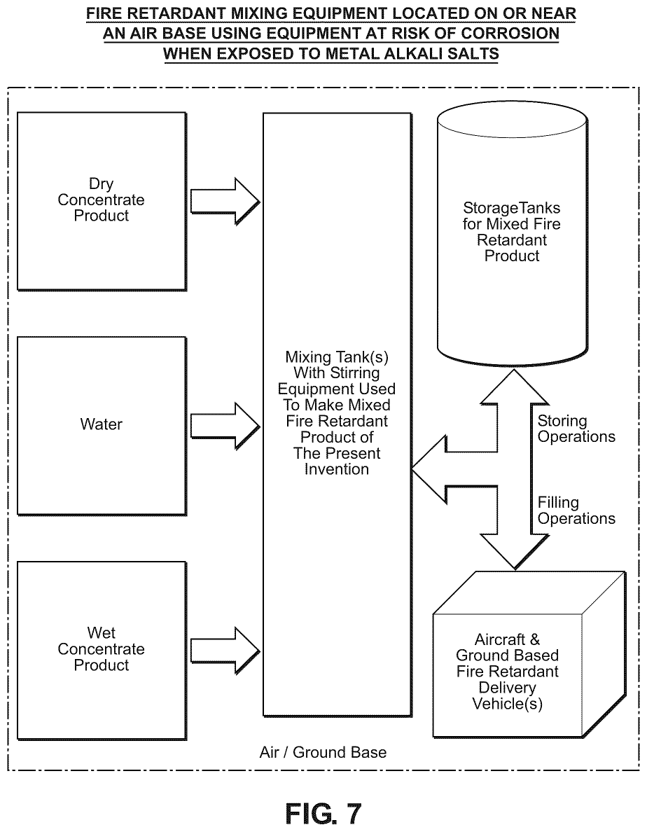

While a preferred formulation of the liquid fire retardant is the “ready-to-use” formulation, not requiring the addition of any water and/or mixing before use, the liquid fire retardant composition can also be produced in two forms: (i) a wet concentrate liquid form designed for mixing with a specified amount of water prior to use (according to a specified Wet Concentrate Mix Ratio) using mixing equipment and/or other suitable apparatus illustrated in FIG. 7.

In general, as illustrated in the chemical formulation model of FIG. 6, the new and improved environmentally-clean (“i.e. Green”) aqueous-based fire retarding biochemical composition of the present invention comprises: (i) a major amount of a first alkali metal salt (derived from a saturated non-polymerized carboxylic acid where the number of carbon atoms C is less than 7); (ii) a minor amount of a second alkali metal salt that functions as a secondar fire retarding agent and as a corrosion inhibiting agent for the protection of specific metals, namely, 2024-T3 Aluminum, 4130 Steel, Yellow Brass, and Az31B Magnesium (used to fabricate equipment shown in FIG. 7 during fire retardant product mixing, storage and delivery application operations) against surface corrosion caused by the presence of the alkali metal (potassium and sodium) ions dissolved in aqueous solution; (iii) a minor amount of thickening agent in the form of biomolecular polymer powder consisting of polysaccharides, such as Xanthan gum (XG) powder, functioning to adjust the viscosity of the mixed fire retardant within the required Specifications (e.g. 150-400 cP or greater for Medium Viscosity and High Viscosity); and (iv) a minor amount of a color-producing agent, such as fugitive red dye powder or non-fugitive red iron oxide pigment (e.g. red iron oxide powder); wherein each said component is dissolved in (v) a major amount of water so as to dissolve and disperse alkali metal (i.e. potassium and sodium) ions in aqueous solution with dissolved polysaccharides from the biomolecular polymer (i.e. viscosity thickener), so as to form a thin fire retardant coating comprising a mixture of alkali metal potassium and sodium salt crystals and polysaccharides (e.g. Xanthan gum material) applied to combustible surfaces, as water molecules evaporate from the applied mixed retardant to the atmosphere, to provide the combustible surface with proactive protection against fire ignition and flame spread, without producing toxic and/or otherwise detrimental effects to human, animal, and plant/botanical life.

The starting biochemicals, namely the non-polymerized saturated carboxylic acid, is an organic acid which contains a carboxyl group (C(═O)OH) attached to an R-group (R=alkyl or aryl). Carboxylic acids (denoted by R—COOH) are weak acids, meaning they are not 100% ionized in water. Generally, only about 1% of the molecules of a carboxylic acid dissolved in water are ionized at any given time. The remaining molecules are undissociated in solution. Being “saturated” means in this case, that each carbon (C) atom is bonded to four other atoms (hydrogen or carbon)—the most possible, and that there are no double or triple bonds in the molecules. The word saturated has the same meaning for hydrocarbons as it does for the dietary fats and oils: the molecule has no carbon-to-carbon double bonds (C═C).

The carbon-hydrogen bond (C—H bond) in the saturated non-polymerized carboxylic acid is a chemical bond between carbon and hydrogen atoms that can be found in many organic compounds. This bond is a covalent, single bond, meaning that carbon share its outer valence electrons with up to four hydrogens. This completes both of their outer shells, making them stable. The C—H bond in general is very strong, so it is relatively unreactive.

The term “non-polymerized” means that carbon and hydrogen atoms in the saturated carboxylic acid have not undergone polymerization or any process of reaction in which relatively small molecules (monomer molecules) are reacted or combined chemically together in a chemical reaction to form very large chainlike or network molecule, called a polymer chains or three-dimensional network. In understanding that there are many forms of polymerization and different systems exist to categorize them.

A tricarboxylic acid, by the name itself, says that it is a category of carboxylic acid which has 3 C(═O)OH groups. In a carboxylic acid group, a carbon (C) atom is bonded to an oxygen (O) atom by a double bond, and to a hydroxyl group (—OH) by a single bond i.e., its functional group represented as C(═O)OH. Carboxylic acids occur widely in nature and its derivatives are of utmost importance in various chemical reactions. Tricarboxylic acids belong to the class of carboxylic acids which contains 3 carboxyl groups (C(═O)OH) attached to R-groups (R=alkyl or aryl).

At this juncture, it will be helpful to briefly identify a few kinds of carboxylic acids that are found in nature and which are of significance for purposes of the present invention, namely: the citric acid compound, a weak acid naturally occurring in citric fruits, which carries 3 carboxyl groups (C(═O)OH) attached to the parent chain, and hence is a tricarboxylic acid, a weak acid which naturally occurs in citric fruits; malonic acid, which carries only 2 carboxyl groups (C(═O)OH), and therefore is a dicarboxylic acid; succinic acid, which carries only 2 carboxyl groups (C(═O)OH), and therefore is a dicarboxylic acid; and malic acid, which also carries only 2 carboxyl groups (C(═O)OH), and therefore is a dicarboxylic acid. Since tricarboxylic acids have 3 carboxyl groups (C(═O)OH) attached to R-groups, it does have the ability to form strong hydrogen bonds, and this results in their high boiling points. Reference is made to the published organic chemistry textbook titled “MARCH'S ADVANCED ORGANIC CHEMISTRY: Reactions, Mechanisms, and Structures (Eighth Edition)”, Michael B. Smith, published by John Wiley & Sons, Inc., 2020, and incorporated herein by reference. Whenever available, all chemical substances and compounds disclosed herein have been provided with their CAS Registration Nos. as registered in the CAS Common Chemistry Database https://commonchemistry.css.org/

In general, the novel environmentally-clean (i.e. “green”) fire retarding biochemical liquid compositions comprise a number of core elements, namely: (a) a dispersing agent in the form of a major quantity of water, for dispersing metal ions dissolved in water; (b) a major amount of a primary fire retarding agent in the form of a primary alkali metal salt of a nonpolymeric saturated carboxylic acid, for providing metal potassium ions dispersed in the water when the primary alkali metal potassium salt is dissolved in the water, (c) a minor amount of a secondary fire retarding agent in the form of a secondary alkali metal salt of a nonpolymeric saturated carboxylic acid, for providing metal sodium ions dispersed in the water when the alkali metal sodium salt is dissolved in the water and also inhibiting the corrosion of specific metals, namely 2024-T3 Aluminum, 4130 Steel, Yellow Brass, and Az31B Magnesium (used to fabricate retardant mixing, storage and delivery equipment) caused by the reaction of alkali metal potassium ions dispersed in the water with metallic components used during mixing, storing and application operations of the mixed retardant product; (d) a minor amount of a thickening agent in the form of a biomolecular polymer consisting of polysaccharides, such a Xanthan Gum, for increasing the viscosity of the mixed retardant liquid during mixed retardant application operations; and (e) a minor amount of a coloring agent in the form of a fugitive colorant dye powder or non-fugitive colorant pigment powder for imparting a visible color (e.g. red or green) when the mixed fire retarding biochemical liquid composition is being applied to combustible surfaces to be protected against fire, while water molecules in the mixed retardant liquid evaporate during drying, and after the formation of thin fire retardant coatings comprising a mixture of alkali metal potassium and sodium salt crystals and polysaccharides of biomolecular polymer, such as Xanthan Gum or other biomolecular polymer material.

In the world of organic chemistry, there are many possible non-polymeric saturated carboxylic acids that can be used to derive and produce alkali metal salts thereof for use in producing environmentally-clean aqueous-based liquid fire retardant that can be applied to combustible surfaces and form thin fire retardant coatings comprising a mixture of alkali metal potassium and sodium salt crystals and polysaccharides of biomolecular polymer that inhibit fire ignition and flame spread.

Such possible carboxylic acids include, but are not limited to, the following carboxylic acids organized according to the number of carbon atoms (Ci) contained therein, namely:
(C1) The C1 Class of Carboxylic Acids having 1 carbon atom (C=1) including formic acid (i.e. methanoic acid) CH₂O₂, and carbonic acid (i.e. hydroxymethanoic acid) H₂CO₃;
(C2) The C2 Class of Carboxylic Acids having 2 carbon atoms (C=2) including acetic acid (ethanoic acid) CH₃COOH, glycolic acid (hydroxyacetic acid) C₂H₄O₃, and glyoxylic acid C₂H₂O₃;
(C3) The C3 Class of Carboxylic Acids having 3 carbon atoms (C=3) including propionic acid C₃H₆O₂, lactic acid C₃H₆O₃, glyceric acid C₃H₆O₄, pyruvic acid C₃H₄O₃, and tartaric acid C₃H₆O₆;
(C4) The C4 Class of Carboxylic Acids having 4 carbon atoms (C=4) including butyric acid CH3(CH2)2COOH, malic acid C₄H₆O₅, and malonic acid C₃H₄O₄;
(C5) The C5 Class of Carboxylic Acids having 5 carbon atoms (C=5) including pivalic acid C₅H₁₀O₂;
(C6) The C6 Class of Carboxylic Acids having 6 Carbon Atoms (C=6) including caproic acid CH3(CH2)4COOH, adipic (hexanedioic) acid HOOC(CH2)4COOH, citric acid HOC(COOH)((CH2)COOH)2, and d-gluconic acid C₆H₁₂O₇; and
(C7) The C7 Class of Carboxylic Acids having 7 carbon atoms (C=7) including benzoic acid C₇H₆O.

While many alkali metal salts can be produced from these carboxylic acids listed above, the alkali metal salts of citric acid under Group C6 are particularly preferred, as will be further explained hereinbelow.

While the efficacy of the alkali metal salts increases in the order of lithium, sodium, potassium, cesium and rubidium, the salts of potassium and the salts of sodium are preferred for cost of manufacturing reasons. Potassium carboxylates are very particularly preferred, but tripotassium citrate monohydrate (TPC) is the preferred primary alkali metal salt for use in formulating the environmentally-clean fire retarding biochemical compositions of the present invention.

While it is understood that other alkali metal salts are available to practice the biochemical compositions of the present invention, it should be noted that the selection of tripotassium citrate as the preferred alkali metal salt, includes the follow considerations: (i) the atomic ratio of carbon to potassium (the metal) in the utilized alkali metal salt (i.e. tripotassium citrate); (ii) that tripotassium citrate is relatively stable at transport and operating temperatures; (iii)tripotassium citrate is expected to be fully dissociated to citrate and potassium when dissolved in water, and that the dissociation constant is not relevant for the potassium ions, while citric acid/citrate has three ionizable carboxylic acid groups, for which pKa values of 3.13, 4.76 and 6.4 at 25° C. are reliably reported in the European Chemicals Agency (ECHA) handbook; and (iv) tripotassium citrate produces low carbon dioxide levels when dissolved in water.

Tripotassium citrate is an alkali metal salt of citric acid (a weak organic acid) that has the molecular formula C₆H₈O₇. While citric acid occurs naturally in citrus fruit, in the world of biochemistry, citric acid is an intermediate in the celebrated “Citric Acid cycle, also known as the Krebs Cycle (and the Tricarboxylic Acid Cycle), which occurs in the metabolism of all aerobic organisms. The role that citric acid plays in the practice of the preferred embodiments of the biochemical compositions and solutions of the present invention will be described in greater detail hereinafter.

Preferably, the secondary fire retarding agent is in the form of another alkali metal salt of a nonpolymeric saturated carboxylic acid, selected to provide inhibition to the corrosion of specific metals, namely 2024-T3Aluminum, 4130 Steel, Yellow Brass, and Az31B Magnesium, while functioning as a secondary fire retardant agent. When using tripotassium citrate (TPC) as the primary fire retarding agent, the use of sodium benzoate is preferred as a secondary fire retarding and anti-corrosion agent, as sodium benzoate has shown to have good molecular and chemical compatibility with tripotassium citrate during laboratory experimentation and testing. Significantly, the sodium ions produced from the alkali metal sodium salt and dissolved in the water functions as a corrosion inhibiting agent inhibiting surface corrosion reactions involving specific metals used in the fabrication of mixing, storage and/or delivery equipment, in which the mixed fire retarding biochemical liquid of the present invention may come in surface contact during expected use. Tis involves the sodium ions combining with other chemical components in the aqueous solution of the mixed liquid retardant to form thin films that function as barriers and inhibitors to the formation of chemical surface reactions involving such specific metals, namely, 2024-T3Aluminum, 4130 Steel, Yellow Brass, and Az31B Magnesium, in illustrative embodiment, which involve oxidation of such metals and cause corrosion and other forms of deterioration which is undesirable, costly and should be avoided.

In a preferred application, the use of a colorant, or coloring agent, may be advantageous with or without opacifying assistants, to the fire retarding chemical compositions of the present invention. The coloring agent may be realized in the form of a fugitive colorant such as a fugitive colorant dye powder (e.g. D13035 Chromatint Red 1855 by Chromatech; Sanolin Rhodamine B 02 by Heubach; Pylaklor Bright Pink LX-9811 by Pylam; FD&C Red No. 40 Granular by Sensient; FD&C No. 40 by Pylam; and Liquitint DR Azalea Pink by Milliken). Alternatively, the colorant may be realized in the form of a non-fugitive colorant, such as a non-fugitive colorant pigment powder (e.g. red iron oxide powder, or green iron oxide powder) for imparting a visible color (e.g. red) when the fire retardant is dispersed into the environment. When using a coloring agent, areas which have already been treated are easier to identify, for example, from the air. However, in some applications, no colorant may be used, and instead, GPS tracking and mapping may be used to track and map where fire retardant has been deposited for fire protection. Preferably, the concentration of the colorant dye in the fire-retarding biochemical composition is preferably in the range from 0.005% to 10% by weight, more preferably in the range from 0.01% to 5% by weight, and most preferably in the range from 0.015% to 2% by weight.

Of advantage in other applications are fugitive colorants, such as dyes and food dyes for example, which fade as the fire-retarding composition dries and gradually decompose or are otherwise easily removable, for example, by flushing with water.

A preferred thickening agent, realized in the form of a biomolecular polymer consisting of polysaccharides, may be any material selected from the group consisting of starch, glycogen, and galactogen, and cellulose, wood cellulose fiber, chitin, and one or more microbial polysaccharides produced by microorganisms selected from the group consisting of xanthan gum, dextran, welan gum, gellan gum, diutan gum and pullulan. Once selected, the thickening agent is added in minor amounts to thicken the mixed fire retarding biochemical liquid and increase and/or control its viscosity (e.g. to within the range of 150-400 cP for Low Viscosity Applications, to within the range of 401-800 cP for Medium Viscosity Applications, to within the range of 801-1500 cP for High Viscosity Applications, or to within the range of 5-149 [cP] for Ultra-Low Viscosity Applications). The viscosity that will be required will depend on the delivery method and environmental conditions a discussed hereinabove.

In general, for serial delivery, the viscosity of the mixed retardant liquid aboard an airtanker should be selected so that the mixed retardant liquid when dropped from the airtanker—moving at particular speed and altitude above the Earth's surface—will produce a cloud of liquid retardant droplets that will fall upon and adhere to combustible target surfaces, while being GPS-tracked and mapped, so that thin fire retardant coatings are formed comprising potassium and sodium salt crystals mixed within the polysaccharide chains of the biomolecular polymer, to provide long duration proactive fire protection. Preferably, the concentration of the thickening agent used in the fire-retarding biochemical liquid composition is preferably in the range from 0.005% to 10% by weight, more preferably in the range from 0.01% to 5% by weight, and most preferably in the range from 0.015% to 2% by weight.

The fire retarding biochemical liquid compositions of the present invention are producible and prepared by mixing the components in specified amounts with water to produce the fire retarding composition products. The order of mixing is discretionary. It is advantageous to produce aqueous preparations by mixing the components other than water, into water.

The fire retarding biochemical liquid compositions of the present invention have a good long term fire retarding effect and a good immediate fire extinguishing effect, and are specially adapted for aerial delivery to ground-based surface targets. However, the fire retarding liquid can be used in ground spraying applications when its viscosity is suitably adapted for ground applications which typically will be in the in the Ultra-Low Viscosity range of 10 [cP]-149 [cP].

The compositions of the present invention are also useful as a fire extinguishing agent for fighting fires of Class A, B, C and D. For example, an aqueous biochemical solution of the present invention may be prepared and deployed for firefighting uses in diverse applications. However, as taught herein, the aqueous fire retardant biochemical composition can made in Concentrate form and not mixed with the specified amount of water to produce Mixed Retardant until it is needed, and when so, by either (i) mixing Dry Concentrate powder with a quantity of water according to the Dry Concentrate Mix Ratio, or (ii) by mixing Wet Concentrate liquid with proportioned amounts of water according to a Wet Concentrate Mix Ratio, using a mixing nozzle, in a conventional manner.

### Specification of Preferred Embodiments of Aqueous-Based Fire Retardant Biochemical Compositions of Matter

As indicated above, while there are many species of Applicant's aqueous-based fire retarding biochemical liquid solution, based on different kinds of non-polymeric saturated carboxylic acids and alkali metal salts dissolved in water for forming thin fire-retarding alkali metal salt crystal and polysaccharide based coatings, Applicant's preferred solutions and compositions are based on a mixture of alkali metal salts comprising (i) alkali metal potassium salts derived from the citric carboxylic acid, (ii) alkali metal sodium salts derived from the benzoic acid, and (iii) the polysaccharides of a biomolecular polymer material, such as xanthan gum material, dissolved in a major amount of water. These preferred embodiments will be specified in great technical detail below.

In the first preferred embodiment of the fire retarding liquid biochemical composition/solution of the present invention, the components are realized as follows: (a) the dispersing agent is realized in the form of a major amount of water, for dispersing alkali metal ions dissolved in the water, (b) a major amount of a first fire retarding agent realized in the form of a first alkali metal salt of a nonpolymeric saturated carboxylic acid, specifically, tripotassium citrate, for providing metal (potassium) ions dispersed in the water when the at least one alkali metal salt is dissolved in the water to form a mixed retardant solution; (c) a minor amount of a second fire retarding agent realized in the form of a second alkali metal salt of a nonpolymeric saturated carboxylic acid, specifically, sodium benzoate (SB), for providing metal (sodium) ions dispersed in the water when the at least one alkali metal salt is dissolved in the mixed retardant solution, for inhibiting surface corrosion reactions involving metals contacting the mixed retardant solution, including specific metals, namely, 2024-T3 Aluminum, 4130 Steel, Yellow Brass, and Az31B Magnesium, while functioning as a secondary fire retardant agent; (d) a minor amount of thickening agent in the form of a biomolecular polymer consisting of polysaccharides, for increasing the viscosity of the mixed retardant liquid during application operations; (e) a minor amount of coloring agent in the form of fugitive red dye powder, or non-fugitive red iron oxide pigment powder, for imparting a visible color (e.g. red) when the fire retarding biochemical liquid composition is applied to a surface to be protected against fire, while water molecules in the retardant liquid evaporate during drying, to form a thin fire retardant coating having a characteristic visible color (e.g. red) and comprising a mixture of alkali metal salt crystals and the polysaccharide chains of the biomolecular polymer material, such as Xanthan gum material, deposited on the treated surfaces.

In the second preferred embodiment of the fire retarding biochemical liquid biochemical solution of the present invention, the components are realized as follows; (a) the dispersing agent is realized in the form of a major amount of water, for dispersing alkali metal ions dissolved in the water; (b) a major amount of a first fire retarding agent realized in the form of a first alkali metal salt of a nonpolymeric saturated carboxylic acid, specifically, tripotassium citrate, for providing metal (potassium) ions dispersed in the water when the at least one alkali metal salt is dissolved in the water to form a mixed retardant solution; (c) a minor amount of a second fire retarding agent realized in the form of a second alkali metal salt of a nonpolymeric saturated carboxylic acid, specifically, sodium benzoate (SB), for providing metal (sodium) ions dispersed in the water when the at least one alkali metal salt is dissolved in the mixed retardant solution, for inhibiting surface corrosion reactions involving metals contacting the mixed retardant solution, including specific metals, namely 2024-T3Aluminum, 4130 Steel, Yellow Brass, and Az31B Magnesium, while functioning as a secondary fire retardant agent; (d) a minor amount of thickening agent in the form of a biomolecular polymer consisting of polysaccharide chains, for increasing the viscosity of the mixed retardant liquid during application operations, when the fire retarding biochemical liquid composition is applied to a surface to be protected against fire, while water molecules in the retardant liquid evaporate during drying, to form a thin fire retardant coating not having a characteristic color (e.g. red) comprising alkali metal (potassium and sodium) salt crystals mixed within the polysaccharide chains of a biomolecular polymer material added to the mixed retardant liquid, to provide a long duration of proactive fire protection to the treated surface, long after the water molecules evaporate to the ambient environment.

Polysaccharides (or polycarbohydrates) are the most abundant carbohydrates found in food. They are large, long-chain, high-molecular weight polymer molecule, called polymeric carbohydrates, that are composed of from ten to thousands of monosaccharide units bound or joined together by glycosidic linkages. This polycarbohydrate can react with water (hydrolysis) using amylase enzymes as catalyst, which produce constituent sugars (monosaccharides, or oligosaccharides). They range in structure from linear to highly branched. Examples include (i) storage polysaccharides such as starch, glycogen and galactogen, and structural (ii) polysaccharides such as cellulose and chitin. Polysaccharide can be differentiated according to the nature of monosaccharides components, length of chains, and the branching of those chains.

As a rule of thumb, polysaccharides contain more than ten monosaccharide units, whereas oligosaccharides contain three to ten monosaccharide units, but the precise cutoff varies somewhat according to the convention. Polysaccharides are an important class of biological polymers. Their function in living organisms is usually either structure-related, or storage-related. Starch (a polymer of glucose) is used as a storage polysaccharide in plants, being found in the form of both amylose and the branched amylopectin. In animals, the structurally similar glucose polymer is the more densely branched glycogen, sometimes called “animal starch”. Glycogen's properties allow it to be metabolized more quickly, which suits the active lives of moving animals. In bacteria, they play an important role in bacterial multicellularity.

Bacteria and many other microbes, including fungi and algae, often secrete polysaccharides to help them adhere to surfaces and to prevent them from drying out. Humans have developed some of these polysaccharides into useful products, including xanthan gum, dextran, welan gum, gellan gum, diutan gum and pullulan.

Most of these polysaccharides exhibit useful visco-elastic properties when dissolved in water at very low levels. This makes various liquids used in everyday life, such as some foods, lotions, cleaners, and paints, viscous when stationary, but much more free-flowing when even slight shear forces are applied by stirring or shaking, pouring, wiping, or brushing. This property is named pseudoplasticity or shear thinning. The study of such matters is called rheology.

In view of the above, the thickening agent used in the fire retarding biochemical liquid to provide the biomolecular polymer consisting of polysaccharides, can be realized using a wide variety of materials such as: storage polysaccharides such as starch, glycogen and galactogen; and structural polysaccharides such as cellulose and chitin. The storage polysaccharides include microbial polysaccharides produced by microorganisms such as bacteria, fungi, yeast, and algae, such as xanthan gum, dextran, welan gum, gellan gum, diutan gum and pullulan, and microbial polysaccharides accumulated inside the cells such as glycogen where they function as energy and carbon reserves. The structural polysaccharides include the abundant biopolymer, cellulose, which is a non-branched polysaccharide polymer consisting of a linear chain of several hundred to many thousands of β (1→4) linked D-glucose units. For wood fibers, the cellulose chain has an average length of 5 μm corresponding to a degree of polymerization (i.e., glucose units) of 10,000.

Preferably, wood cellulose fiber, produced from recycled wood fiber collected from trees removed during forest management, can be treated and conditioned to liberate cellulose from ground wood fibers and used as a thickening agent when making the Dry Concentrate, Wet Concentrate and Read-to-Use forms of the Mixed Retardant Products of the present invention. Wood cellulose fiber consists of cellulose fibers obtained from wood pulp through a series of chemical and mechanical processes. Wood cellulose fiber primarily consists of cellulose, hemicellulose, and lignin. However, cellulose is the dominant component, comprising up to 90% of the fiber. These fibers are incredibly fine, making wood cellulose fiber an ideal candidate for various applications. Wood cellulose fiber has remarkable properties, including high tensile strength, biodegradability, and excellent absorbency. In addition to being eco-friendly, sourced from sustainably managed forests, and biodegradable, wood cellulose fiber can be used as a thickening agent for controlling the viscosity of the mixed fire retarding biochemical liquid of the present invention.

In aerial and ground based retardant delivery applications, illustrated using the vehicles shown and described in FIGS. 8A through 10B, when the wood cellulose fiber is used as a thickening agent for the mixed retardant liquid, it is understood that the viscosity can be selected to be rather high (e.g. in the range between 401-800 [cP] Medium Viscosity, or between 801-1500 [cP] High Viscosity), in order to create and form relatively thick long term fire retardant coatings that serve as long term wildfire breaks and protection zones, formed around power and communication utility poles and related structures, and other building structures, and other strategic locations. In such applications, it may be advantageous to add to the mixed retardant liquid solution, a minor amount of dispersant/surfactant, such a triethyl citrate (TEC), an ester of citric acid, disclosed in U.S. patent application Ser. No. 18/669,077 filed May 20, 2024, to reduce surface tension within the retardant liquid solution and enable the potassium and sodium ions dissolved in solution to penetrate and bind to the cellulose wood fiber material, especially dissolved polysaccharides associated with the wood cellulose fiber thickening agent. Through such surface penetration action, it will be possible to form and maintain more enduring fire retardant coatings when the water molecules in the applied retardant liquid coating evaporate to the environment, thereby enhancing the durability of the long ten fire retardant coatings of the present invention under such circumstances.

In the preferred embodiment(s) of the present invention shown for use in aerial delivery operations, the preferred thickening agent used in the mixed fire retardant product(s) is Xanthan gum—the extracellular polysaccharide produced by the bacterium Xanthomonas. The primary structure of xanthan gum is a biomolecular polymer consisting of a cellulose backbone (of β-glucose-linked β-units substituted on glucose residues replaced by a side-chain trisaccharide) with branches of the sugars galactose and mannose. However, unlike like starch, xanthan gum also builds viscosity over a wide variety of temperatures; but unlike starch, xanthan gum does not break down into simple sugars when consumed. Favorably, Xanthan gum can take on a helical structure as illustrated in Step B of FIG. 6C which provides a suitable structure for encapsulating and arranging potassium and sodium salt crystals within a polysaccharide matrix of sorts, foaming the applied long team fire retardant coatings of the present invention.

Once the mixed retardant (liquid) solution of the present invention is prepared according to the formulations specified above, the mixed retardant product is stored in property labeled containers, bottle, or totes (i.e. packages) suitable for end user applications in mind. Thereafter, the filled package of mixed retardant product should be sealed with appropriate sealing technology. The package of fare retardant product (in dry concentrate form) or mixed retardant product (ready-to-use or wet concentrate form) should be immediately labeled with a specification of (i) its biochemical components, with weight percent measures where appropriate, and the date and time of manufacture, printed and recorded in accordance with good quality control (QC) practices well known in the art. Where necessary or desired, barcode symbols and/or barcode/RFID identification tags and labels can be produced and applied to the sealed package to efficiently track each barcoded package containing a specified quantity of fire retardant biochemical composition. All products and QC information should be recorded in a globally accessible network database, for use in tracking the movement of the package as it moves along the supply chain from its source of manufacture, towards its end use at a GPS specified location.

Specification of Preferred Embodiments of the Dry Fire Retardant Biochemical Compositions of Matter Assembled as a Fire Retardant Biochemical Composition for Use with Specified Quantities of Water

In the third preferred embodiment of the fire retarding biochemical liquid biochemical solution of the present invention, the components are realized as follows: (a) the fire inhibiting agent is realized in the form of major amount of a first alkali metal salt of a nonpolymeric saturated carboxylic acid, specifically, tripotassium citrate (TPC), for providing metal potassium ions to be dissolved and dispersed in a quantity of water; (b) a minor amount of a second fire retarding agent realized in the form of a second alkali metal salt of a nonpolymeric saturated carboxylic acid, specifically, sodium benzoate (SB), for providing metal sodium ions dispersed in the water when the at least one alkali metal salt is dissolved in the mixed retardant solution, for inhibiting surface corrosion reactions involving metals contacting the mixed retardant solution, including specific metals, namely 2024-T3 Aluminum, 4130 Steel, Yellow Brass, and Az31B Magnesium, while functioning as a secondary fire retarding agent along with the potassium ions; (c) a minor amount of thickening agent in the form of a biomolecular polymer consisting of polysaccharides (e.g. Xanthan gum) for increasing the viscosity of the mixed retardant liquid during application operations; (d) a minor amount of coloring agent in the form of fugitive red dye powder or non-fugitive red iron oxide pigment powder, for imparting a visible color (e.g. red), of fugitive or non-fugitive type, when the fire retarding biochemical liquid composition is applied to a surface to be protected against fire; wherein the dry powder components described above are mixed together and dissolved in a major amount of water to produce a mixed retardant solution in either read-to-use non-diluted form, or wet concentrate form for mixing with a specified amount of water, to produce a mixed fire retardant product adapted for application to combustible surfaces by aerial delivery or ground application, while water molecules in the retardant liquid evaporate during drying, to form a thin fire retardant coating having a characteristic red color and comprising a mixture of alkali metal (potassium and sodium) salt crystals mixed with the polysaccharide chains of the biomolecular polymer material (e.g. Xanthan gum material) deposited on the treated combustible surfaces.

In the fourth preferred embodiment of the fire retarding biochemical liquid solution of the present invention, the components are realized as follows: (a) a major amount of a first fire retarding agent realized in the form of a first alkali metal salt of a nonpolymeric saturated carboxylic acid, specifically, tripotassium citrate, for providing metal potassium ions to be dissolved and dispersed in a quantity of water; (b) a minor amount of a second fire retarding agent realized in the form of a second alkali metal salt of a nonpolymeric saturated carboxylic acid, specifically, sodium benzoate (SB), for providing metal (sodium) ions dispersed in the water when the at least one alkali metal salt is dissolved in the mixed retardant solution, and for inhibiting surface corrosion reactions involving metals contacting the mixed retardant solution, including specific metals, namely 2024-T3 Aluminum, 4130 Steel, Yellow Brass, and Az31B Magnesium, while functioning as a secondary fire retardant agent along with potassium ions from the first fire retarding; (d) a minor amount of thickening agent in the form of a biomolecular polymer consisting of polysaccharides (e.g. Xanthan Gum (XG) material) for increasing the viscosity of the mixed retardant liquid during application operations, when the fire retarding biochemical liquid composition is applied to a combustible surface to be protected against fire; wherein the dry powder components described above are mixed together and dissolved in a major amount of water to produce a mixed retardant solution in either read-to-use non-diluted form, or wet concentrate form for mixing with a specified amount of water, to produce a mixed fire retardant product adapted for application to combustible surfaces by aerial delivery or ground application, while water molecules in the retardant liquid evaporate during drying, while water molecules in the retardant liquid evaporate during drying, to form a thin fire retardant coating not having a characteristic color and comprising a mixture of alkali metal potassium and sodium salt crystals mixed within the polysaccharide chains of a biomolecular polymer material (e.g. Xanthan Gum material) deposited on the treated combustible surfaces.

### Selecting Tripotassium Citrate (TCP) as a Preferred Fire Retarding Agent for Use in the Fire Retarding Biochemical Compositions of the Present Invention

In the preferred embodiments of the present invention, tripotassium citrate (TPC) is selected as an active fire retardant chemical component in fire inhibiting biochemical solution. In dry form, TPC is known as tripotassium citrate monohydrate (C₆H₅K₃O₇·H₂O) which is the common tribasic potassium salt of citric acid, also known as potassium citrate. It is produced by complete neutralization of citric acid with a high purity potassium source, and subsequent crystallization. Tripotassium citrate occurs as transparent crystals or a white, granular powder. It is an odorless substance with a cooling, salty taste. It is slightly deliquescent when exposed to moist air, freely soluble in water and almost insoluble in ethanol (96%).

Tripotassium citrate is a non-toxic, slightly alkaline salt with low reactivity. It is chemically stable if stored at ambient temperatures. In its monohydrate form, TPC is very hygroscopic and must be protected from exposure to humidity. Care should be taken not to expose tripotassium citrate monohydrate to high pressure during transport and storage as this may result in caking. Tripotassium citrate monohydrate is considered “GRAS” (Generally Recognized As Safe) by the United States Food and Drug Administration without restriction as to the quantity of use within good manufacturing practice. CAS Registry Number for tripotassium citrate monohydrate: [6100-05-6]. E-Number: E332.

Tripotassium citrate monohydrate (TPC) is a non-toxic, slightly alkaline salt with low reactivity. It is a hygroscopic and deliquescent material. It is chemically stable if stored at ambient temperatures. In its monohydrate form, it is very hygroscopic and must be protected from exposure to humidity. Its properties are:
Monohydrate
White granular powder
Cooling, salty taste profile, less bitter compared to other potassium salts
Odorless
Very soluble in water
Potassium content of 36%
Slightly alkaline salt with low reactivity
Hygroscopic
Chemically and microbiologically stable
Fully biodegradable
Allergen and GMO free

Jungbunzlauer (JBL), a leading Swiss manufacturer of biochemicals, manufactures and distributes TPC for food-grade, healthcare, pharmaceutical and over the counter (OTC) applications around the world. As disclosed in JBL's product documents, TPC is an organic mineral salt which is so safe to use around children and adults alike. Food scientists worldwide have added TPC to (i) baby/infant formula powder to improve the taste profile, (ii) pharmaceuticals/OTC products as a potassium source, and (iii) soft drinks as a soluble buffering salt for sodium-free pH control in beverages, improving stability of beverages during processing, heat treatment and storage.

### Specification of Preferred Formulations for the Fire Retarding Biochemical Compositions of Matter According to the Present Invention

### Example #1: Liquid-Based Fire Retardant Biochemical Composition

FIG. 6A1 illustrates the primary components of a first environmentally-clean aqueous-based fire retarding liquid biochemical composition of the present invention (i.e. a “wet concentrate” fire retarding solution) consisting of tripotassium citrate (TPC), sodium benzoate (SB), Xanthan Gum (XG), and red iron oxide pigment, formulated with a major amount of water functioning as a solvent, carrier, and dispersant in the biochemical fire retardant composition.

Example 1: Schematically illustrated in FIG. 6A1: A fire-extinguishing and/or fire-retarding biochemical composition, in “wet concentrate” form, was produced by stirring the components into 0.87 [gallons] of water at 72 F temperature. The composition comprises: 1.35 [Lbs.] (612.34 [gm]) of tripotassium citrate (TPC) as primary fire retarding agent (i.e. alkali metal salt); 2.65 [oz] (75.00 [gm]) of sodium benzoate (SB) as a secondary fire retarding agent and corrosion inhibiting agent; 3.38 [oz] (95.85 [gm]) of Xanthan Gum (XG); 0.14 [oz] (4.0 [gm]) of red dye powder (i.e. D13035 Chromatint® 1855-Water Soluble Red Dye Powder from Chromatech, Inc.), as a fugitive red dye colorant, mixed together an dissolved in 0.87 gallons of water to produce a resultant mixed retardant solution having a total 1.0 gallon of volume, and total weight equaling 8.98 pounds (i.e. 4074.40 [gm] A wherein the volumetric expansion factor of the mixed retardant solution is 1/0.87=1.15.

The weights and measures for CitroSafe™ MFB-30 Ready-To-Use (Wet Concentrate) Retardant Formulation are set forth as follows:

### Ready-To-Use/Wet Concentrate Formulation:

Water: 0.87 [US Gallon]*8.33 [lbs./Gallon −70F]=7.247 [Lbs.]*453.59 [gm/Lbs.]=3287.21 [gm]
Tripotassium Citrate (TPC)=612.34 gm (1.35 lbs.)
Sodium Benzoate (SB)=75.00 gm (2.65 oz.)
Xanthan Gum (XG)=95.85 gm (3.38 oz.)
D13035 Chromatint® 1855-Water Soluble Red Dye Powder from Chromatech Inc.)=4.0 gm (0.14 Oz)
Final Volume of CitroSafe™ MFB-30 Mixed Retardant=1.0 [Gallon]
Total Weight of 1 Gallon of CitroSafe™ MFB-30 Retardant=4074.40 [Grams]=8.98 [Lbs.]

### Summary of Calculated Mass Percentage % of Chemical Components Based on Formulation of CitroSafe™ MFB-30 Ready-To-Use Liquid Chemical Fire Retardant

The Mass Percentage % by weight of the components used to make CitroSafe™ MFB-30 Ready-to-Use Retardant Formulation are set forth as follows:
Water (H₂O) (CAS: 7732-18-5): 80.67% (by weight)
TPC (Tripotassium Citrate monohydrate) (CAS: 6100-05-6): 15.02%
Sodium Benzoate (SB) (CAS: 532-32-1): 1.84%
Xanthan Gum (XG) (CAS: 11138-66-2): 2.35%
Red Dye Powder—D13035 Chromatint® 1855 from Chromatech Inc.: 0.098%
The Density of CitroSafe™ MFB-30 Ready-to-Use (Premixed) Retardant Formulation is obtained as follows:

Density (i.e. Mass/Volume): 4074.40 [gm/Gallon]→4074.40 [gm/Gallon]*1/453.592 [Lbs./gm]=8.98 [Lbs./Gallon]

### Example #2: Dry-Powder Fire Retarding Biochemical Composition

FIG. 6A2 illustrates the primary components of a fire retarding biochemical composition of the present invention, comprising: dry tripotassium citrate (TPC) powder, sodium benzoate (SB) powder, Xanthan gum (XG) powder, and red dye powder components mixed and blended for mixing with a predetermined quantity of water functioning as a solvent, carrier, and dispersant, to make up a predetermined quantity of environmentally-clean mixed fire retarding biochemical liquid composition for proactively protecting combustible products.

Example 2: Schematically Illustrated in FIG. 6A2: A fire-extinguishing and/or fire-retarding biochemical composition was produced by blending the following components, in amounts proportional to the formulation comprising: 612.34 [gm] of tripotassium citrate (TPC) powder as primary fire retarding agent (i.e. alkali metal salt); 75.00 [gm] of sodium benzoate (SB) powder as a secondary fire retarding agent and corrosion inhibitor involving specific metals, namely 2024-T3Aluminum, 4130 Steel Yellow Brass, and Az31B Magnesium; 95.85 [gm] pounds of Xanthan gum (XG) powder, and 4.0 [gm] of non-fugitive red iron oxide pigment; packaging the blended components together in a container or package for mixing with 0.87 gallons of water, to produce a resultant mixed retardant solution having a total volume of 1.0 [gallon], and a total weight equaling 8.98 pounds (i.e. 4074.40 [gm]0, wherein the volumetric expansion factor of the mixed retardant solution is 1/0.87=1.15.

### Summary of Calculated Mass Percentage % of Chemical Components Based on Formulation of CitroSafe™ MFB-30 “Dry-Concentrate” Fire Retardant Product

The weights and measures the CitroSafe™ MFB-30 Dry Concentrate Retardant

Formulation are set forth as follows:
Tripotassium Citrate (TPC): 612.34 [grams]
Sodium Benzoate (SB): 75.00 [8m]
Xanthan Gum (XG): 95.85 [gm]
Red Dye Powder—D13035 Chromatint® 1855=4.0 [gm]
   Total Mass of Dry Concentrate to be Mixed with 0.87 [Gallon] of Water:
Tripotassium Citrate (TPC): 612.34 [gm]
Sodium Benzoate (SB): 75.00 [8m]
Xanthan Gum (XG): 95.85 [gm]
Red Dye Powder—D13035 Chromatint® 1855=4.0 [gm]

TOTAL MASS: 787.14 [gm]*1/453.59 [Lbs./gm]=1.739 [Lbs.]

Weight Percentage of Components in the CitroSafe™ MFB-30 Dry Concentrate Fire Retardant Formulation for Mixing with 0.87 [Gallon] of Water
TPC (Tripotassium Citrate monohydrate) (CAS: 6100-O-6): 77.89%
Sodium Benzoate (SB) (CAS: 532-32-1): 9.52%
Xanthan Gum (XG) (CAS: 11131-66-2): 12.17%
Red Dye Powder—D13035 Chromatint® 1855 from Chromatech, Inc.: 0.50%

$$MASS \% BALANCE CHECK = 77.89 \% ( TPC ) + 9.52 \% ( SB ) + 12.17 \% ( XG ) + 0.5 \% ( Red Dye ) = 100 \%$$

### Use Level Analysis of the Dry Concentrate Formulation of CitroSafe™MFB-30 Fire Retardant Product (1.9 Mix Ratio):

Dry Concentrate Mix Ratio (i.e. Amount Of Dry Concentrate CitroSafe™ MFB-30 Powder To Be Added Per Gallon Of Water): 1.99 [Lbs./Gallon Water]

Dry Concentrate Yield of Mixed Retardant Liquid when Using CitroSafe™ MFB-30 (at 1.9 Dry Concentrate Mix Ratio)

Using a 1.9 Mix Ratio for use with Dry Concentrate CitroSafe™ MFB-30 Fire Retardant, one 1 ton (i.e. 2000 lbs.) of CitroSafe™ MFB-30 Dry Concentrate (dry powder form) can yield 1155 [Gallons] of CitroSafe MFB-30 Mixed Retardant. This Yield would involve adding 1005 [Gallons] of water into a Mixing Tank as shown in FIG. 7, and then adding 2000 [Lbs.] of CitroSafe™ MFB-30 Dry Concentrate Powder (however packaged) to the water in the Mixing Tank, while mixing together using paddle mixers in the tank until all of the solid powder components are dissolved in the water and a Mixed Retardant Liquid is produced. Then, the Mixed Retardant Liquid Product is ready for either: (i) storage in Storage Tanks during storing operations; or filling operations aboard Aircraft Retardant Delivery Vehicles (i.e. Airtankers) during filling operations to support serial delivery of the Mixed Retardant Liquid to targeted ground surfaces, from a stationary or mobile air bases, as the case may be.

### Preferred Weights Percentages of the Components of the Fire Retarding Biochemical Formulation of the Present Invention

In the biochemical compositions of the present invention, the ratio of the sodium benzoate to the alkali metal salt of a nonpolymeric saturated carboxylic acid (e.g. tripotassium citrate) may be major amount between 1:100: to 1:1000 and is typically in the range from 1:1 to 1:100, preferably in the range from 1:2 to 1:50, more preferably in the range from 1:4 to 1:25.

A preferred biochemical fire retarding biochemical liquid composition according to the present invention comprises: a major amount from 1% to 65% by weight, preferably from 20% to 50% by weight and more preferably from 30% to 55% by weight, of water a a solvent and dispersant a major amount from 1% to 65% by weight, preferably from 20% to 50% by weight and more preferably from 30% to 55% by weight, of at least one alkali metal salt of a nonpolymeric saturated carboxylic acid (e.g. tripotassium citrate monohydrate or TPC); a minor amount from 0.08% to 5% by weight, preferably from 0.5% to 2% by weight and more preferably from 0.1% to 1.0% by weight, of sodium benzoate (SB); a minor amount from 0.08% to 5% by weight, preferably from 0.5% to 2% by weight and more preferably from 0.1% to 1.0% by weight, of Xanthan gum (XG) powder to increase the viscosity of the resultant mixed retardant solution when water is dissolved in the dry powder ingredients; and minor amount from 0.08% to 5% by weight, preferably from 0.5% to 2% by weight and more preferably from 0.01% to 1.0% by weight, of red dye powder (i.e. fugitive colorant or non-fugitive colorant), to impart the color red to the resultant mixed retardant solution when water is mixed with the dry powder ingredients; wherein the sum by % weight of the components (a) and (b) should not exceed 100% by weight.

In a preferred embodiment, the viscosity of the aqueous fire retarding biochemical liquid preparation is preferably at least 150.0 [cP] (or 150.0 millipascal-seconds, mPas, in SI units, where viscosity is defined a the internal friction of a liquid to the application of pressure or shearing stress determined using a rotary viscometer), and preferably not more than 400 [cP] for Low Viscosity Application Applications; preferably the viscosity of the fire retarding biochemical liquid is between 401-800 [cP] for Medium Viscosity Applications; preferably, the viscosity of the fire retarding biochemical liquid is between 801-1500 [cP] for High Viscosity Applications; and preferably, the viscosity of the fire retarding biochemical liquid is between 10-149 [cP] for Ultra-Low Viscosity Applications. Preferably, the pH of the mixed retardant solution is between 7.0 and 8.6, but may fall within the range of 6 to 9 in alternative embodiments of the present invention.

Depending on the airspeed of the aircraft tanker delivering the mixed fire retardant solution to targeted ground surfaces via serial delivery, there may be a need for the mixed retardant liquid to have a significantly greater viscosity than water (1.0 [cP]) so that the mixed retardant liquid stream being dropped from the airtanker does not rapidly evaporate to the ambient environment during dropping operations. Also, a fire retardant delivery aircraft (i.e. airtanker) moving at sufficiently high speeds (e.g. 200 mph or more) may be able to more effectively deliver mixed retardant liquid to ground surface targets, if the viscosity of the mixed retardant liquid being dropped is sufficiently great (e.g. 150 [cP] rather than 50 [cP]) to enable spontaneous generation of microdroplets, in response to sheer forces acting on the dropping liquid stream, during liquid retardant dropping operations. Those skilled in the aerial liquid retardant dropping art will have the tools and know how to select the preferred viscosity of the liquid fire retardant that will produce a cloud of liquid retardant droplets that will fall down upon the targeted ground surface, as the airtanker (i) travels above the ground surface at a predetermined speed and altitude, and (ii) drops a stream of liquid fire retardant towards the targeted ground surface.

Specification of Various Species of Environmentally-Clean Aqueous-Based Liquid Fire Retardant Solutions Containing Dissolved Alkali Metal Salts Derived from Different Kinds of Non-Polymerized Saturated Carboxylic Acids Having Carbon-Atom Chain Lengths Less than Eight (8)

While the preferred embodiment of the environmentally-clean aqueous-based biochemical fire retarding biochemical liquid solution is based on alkali metal salts of citric carboxylic acid and benzoic carboxylic acid, it is possible to formulate and produce many other species of the present invention, wherein each liquid fire retardant solution comprises: (i) a major amount of first and second alkali metal salt derived from different kinds of non-polymerized saturated carboxylic acids, dissolved in a major amount of water, and having carbon-atom chain lengths less than eight (8), which contributes to solubility of the alkali metal ions dissolved in water, while inhibiting the corrosion of specific metals, namely, 2024-T3 Aluminum, 4130 Steel, Yellow Brass, and Az31B Magnesium, that may come in surface contact with the mixed retardant liquid during its use in mixing, storage and serial delivery; and (ii) minor amounts of a thickening agent in the form of a biomolecular polymer consisting of polysaccharides dissolved in the water, for increasing the viscosity of the mixed retardant liquid for use during aerial delivery.

When applied to combustible surfaces and allowed to dry, the new and improved fire retarding biochemical liquid solution forms thin fire retarding coatings produced from a set of alkali metal salts derived from two or more carboxylic acids (R—COOH) selected from the group consisting of: formic acid (i.e. methanoic acid); carbonic acid (i.e. hydroxymethanoic acid); acetic acid (ethanoic acid); glycolic acid (hydroxyacetic acid); glyoxylic acid; propionic acid; lactic acid; glyceric acid; tartaric acid; malic acid; malonic acid; caproic acid; adipic (hexanedioic) acid; citric acid; and benzoic acid; wherein the set of alkali metal salts cooperate to inhibit corrosion of specific metals, namely, 2024-T3 Aluminum, 4130 Steel, Yellow Brass, and Az31B Magnesium, that may come in surface contact with the mixed retardant liquid during its use in mixing, storage and aerial delivery.

A wide variety of alkali metal salts can be produced from these nonpolymeric saturated carboxylic acids for inclusion in the fire retarding biochemical liquid composition of the present invention, including, but not limited to: (i) alkali metal salts of formic acid (i.e. methanoic acid); (ii) alkali metal salts of carbonic acid (i.e. hydroxymethanoic acid); (iii) alkali metal salts of acetic acid (i.e. ethanoic acid); (iv) alkali metal salts of glycolic acid (i.e. hydroxyacetic acid); (v) alkali metal salts of glyoxylic acid; (vi) alkali metal salts of propionic acid; (vii) alkali metal salts of lactic acid; (viii) alkali metal salts of glyceric acid; (ix) alkali metal salts of tartaric acid. (x) alkali metal salts of malic acid; (xi) alkali metal salts of malonic acid; (xii) alkali metal salts of caproic acid; (xiii) alkali metal salts of adipic (hexanedioic) acid; (xiv) alkali metal salts of citric acid; and (xv) alkali metal salts of benzoic acid.

The details of these different species of liquid fire inhibitor solutions of the present invention, and its underlying carboxylic acid and alkali metal salt(s), are specified in great technical detail in Applicant's copending U.S. patent application Ser. No. 18/669,077, incorporated herein by reference.

### Physical Examination and Fire-Performance Testing of the Thin Metal Salt Crystalline Structures Formed Using the Biochemical Compositions and Method and Apparatus of the Present Invention

One method of viewing the metal salt crystal and polysaccharide structure of the fire retardant coatings of the present invention, as illustrated in FIG. 6C, would be to use atomic force microscope to form atomic force microscopy (AFM) images of these biochemical fire retardant coatings. Another method of viewing the resulting the metal salt crystal and polysaccharide structure of the fire retardant coatings of the present invention would be to use a scanning electron microscope to form scanning electron microscopy (SEM) images. Expectedly, using either instrument, such images will show thin coatings comprising potassium and sodium salt crystals mixed within the polysaccharide chains of the biomolecular polymer, such as Xanthan gum, that provides good adhesion to combustible surfaces being treated with fire protection using the fire retarding liquid of the present invention.

FIG. 6C illustrate the primary steps involved during the formation of thin fire retardant coatings on treated ground surfaces to be proactively protected against ignition and flame spread of incident fire.

At Step A, a discharge chute (or alternative, a very-wide wide nozzle) aboard an aircraft tanker carrying the mixed retardant liquid is used to drop liquid fire retardant (of a specified retardant salt concentration % by weight, and viscosity) while the aircraft tanker is moving at high speed (e.g. 120-250 mph). While the stream of liquid fire retardant is flowing, shear forces cause the liquid to form or explode into a cloud of small liquid droplets of liquid retardant (of a particular size) and cover a target ground surface and form a liquid coating of a retardant solution onto combustible surfaces to be protected by the retarding salts in the composition, once water molecules therein are evaporated, at a rate determined by ambient temperature, prevailing wind currents, and atmospheric turbulence caused by any nearby wildfires.

While not shown, it is well known that airtanker delivery of fire retardant fluids causes the dispersal of many gallons of liquid fire retardant into a cloud of droplets that settles onto the fuel on the ground. Measurements of the viscosity, elasticity, surface tension, and density of the fluid allows an estimate of droplet size ultimately delivered to the targeted ground surface. This information can be used to predict the performance of various liquid fire retardants and in selecting the viscosities and concentrations of their retardant components. Preferably, a computer-based Aerial Drop Modelling System is used for real-time simulation, control and management of aerial drops from a fixed-wing aircraft and other aircraft, involving a wide range of product viscosities, from water to highly thickened long-term liquid fire retardants. The computer-based Aerial Drop Modelling System can be used to simulate the continuous stripping of droplets from the liquid jet stream of liquid fire retardant being dropped from the airtanker due to aerodynamic forces, and provides an improved understanding and prediction of the behavior and effectiveness of aerially delivered firefighting liquids.

At Step B, a water molecules evaporate, potassium and sodium salt crystals and polysaccharides from the biomolecular polymer material (e.g. Xanthan gum) form a thin fire retardant coating that adheres to the combustible surface, to which the mixed retardant liquid was applied in Step A during the aerial delivery process. The thin coating of fire retarding biochemical liquid contains potassium and sodium salt crystals mixed within an extracellular polysaccharide structure, illustrated in FIG. 6C. The dried fire retardant coating that forms will have a dry coating thickness that is less than the applied wet coating thickness, and will be dependent on (i) various biochemical parameters of the fire retarding liquid, a well as (u) environmental and atmospheric parameters (e.g. temperature, relative humidity, pressure, etc.) present at the time of application and coating formation process.

Artificial Intelligence (AI) and Machine Intelligence can be used with the Aerial Drop Modelling System to provide an AI-Based Aerial Drop Modelling System capable of: (i) real-time monitoring of the actual size of microdroplets of liquid fire retardant produced during aerial retardant dropping operations under a specified set of conditions; (ii) determining the optimal viscosity for mixed fire retarding biochemical liquid being aerially delivered from an airtanker moving a specific airspeed at a specific altitude high above a target ground surface to be treated with fire retardant chemistry of the present invention; and (iii) generating and sending instructions to the supporting airbase where the mixed retardant liquid is being mixed and produced for use in aerial dropping operations.

To determine and confirm that fire retarding biochemical liquid compositions of the present invention actually produce potassium and sodium salt crystals and polysaccharide coatings on treated surfaces that have attained certain standards of fire retarding/inhibiting protection, it is necessary to test such treated surface specimens according to specific nationally and internationally recognized fire protection standards. In the USA, ASTM E84 Flame Spread and Smoke Development Testing can be used to test how well surfaces made of wood, cellulose and other combustible materials perform during E84 testing, and then compared against industry benchmarks. The environmentally-clean fire retarding biochemical liquid compositions disclosed herein are currently being tested according to ASTM E84 testing standards and procedures, and it is expected that these ASTM test will show that fire-protected surfaces made of Douglas Fir (DF) will demonstrate Flame Spread Indices and Smoke Development Index to qualify for Class-A fire protected certification, when treated by the fire retarding biochemical compositions of the present invention disclosed and taught herein.

### Methods of Blending Making and Producing a Biochemical Liquid Formulations

The fire retarding liquid compositions illustrated in FIGS. 6A1, 6A2, 6B1, 6B2 are reproducible by mixing the components described and shown in FIG. 7. Preferably, during field mixing operations on or about a permanent or mobile air base, the Dry Concentrate Retardant will be mixed with water according to a specified Mix Ratio (pounds of Dry Concentrate Retardant with each gallon of water) to make a Mixed Retardant solution for loading onto aircraft for aerial delivery, or storage for subsequent delivery according to schedule. While the order of mixing is discretionary, it is advantageous to produce aqueous preparations by mixing the components other than water, into the quantity of water in the mixing tank.

### Specification of the Methods of Preparing and Applying the Fire Retardant Biochemical Compositions of the Present Invention

Once the fire retarding compositions are prepared in accordance with the formulations described above, the mixture is then stirred for several minutes at room temperature, and subsequently, the mixture is then packaged, barcoded with chain of custody information and then either stored, or shipped to its intended destination for use and application in accordance with present invention. As described herein, the preferred method of delivery/application involves using, for example, an aircraft tanker carrying a sufficient supply of mixed retardant liquid/solution (product) that can be dropped from the moving airtanker to targeted ground surfaces of GPS-specified property, on which the fire retardant biochemical composition is to be applied to form a proactive fire protective coating on treated surfaces of combustible material on a specific parcels of property.

During aerial dropping methods, the viscosity of the mixed retardant liquid will depend on several factors including: (i) the height from which the airtanker will drop its fire retarding biochemical liquid; (ii) the speed at which the airtanker will be traveling during fire retarding biochemical liquid dropping operations; (iii) the ambient temperature into which the fire retarding biochemical liquid will be dropped; (iv) the aerodynamic turbulence of the air stream through which the fie retarding biochemical liquid stream will pass during dropping operations and experience sheering, that causes droplet formation during serial retardant delivery operations; (v) etc. The USDA FS Specification 5100-304d has defined three different ranges of viscosity for Mixed Retardant liquid, namely:
High Viscosity Mixed product with a viscosity between 801 and 1500 [cP].
Medium Viscosity Mixed product with a viscosity between 401 and 800 [cP].
Low Viscosity Mixed product with a viscosity between 150 and 400 [cP].

In the illustrative embodiment, the preferred in the range of viscosity for the mixed retardant liquid is from 150 to 400 [cP] to cover and support serial dropping using the Low Viscosity Application range. However, the viscosity can be increased to a greater viscosity value in the Medium Viscosity range, or in the High Viscosity Range, as the aerial delivery application, working environment and conditions may require.

Increasing the viscosity of the mixed fire retarding biochemical liquid from the Low Viscosity range to the Medium Viscosity range can be achieved by adding an increased amount of biomolecular polymer powder (e.g. Xanthan gum powder) to the Dry Concentrate formulation so that the Mixed Retardant Product has a viscosity somewhere between 401 and 800 [cP], to meet the application requirements without undue experimentation and laboratory testing. Also, Increasing the viscosity of the mixed fire retarding biochemical liquid from the Low Viscosity range to the High Viscosity range can be achieved by adding an increased amount of biomolecular polymer powder (e.g. Xanthan gum powder) to the Dry Concentrate formulation so that the Mixed Retardant Product has a viscosity somewhere between 801 and 1500 [cP] to meet the application requirements without undue experimentation and laboratory testing.

In some aerial delivery applications, for example involving low altitude flying aircraft such a un-manned retardant applying drones a shown in FIGS. 9A and 9B, it may be desired or otherwise advantageous to use a mixed fire retarding biochemical liquid having a viscosity in the Ultra-Low Viscosity Applicant range (i.e. 10-149 [cP]). Also, in some ground delivery application, a shown in FIG. 10, for example, involving a ground-based tanker equipped with appropriate spray nozzles, where it may be desired or otherwise advantageous to use a mixed fire retarding biochemical liquid having a viscosity in the Ultra-Low Viscosity Applicant range (i.e. 10-149 [cP]) so as to be able to spray the fire retarding biochemical liquid onto ground surfaces containing native fuel requiring fire protection.

In general, the methods of and apparatus for delivering and GPS-tracking of fire retarding biochemicals of the present invention taught herein, as shown in FIGS. SA through 10B, can be used with excellent results, provided that mixed retardant liquids are used with viscosity properties that meet the requirements for serial delivery, or ground delivery, as the application requires.

During examination and testing protocols, all fire retarding biochemical formulations of the present invention are proactively applied to combustible wood surfaces, allowed to dry, and are then analyzed and tested for adhesion properties in a conventional manner, as well as subjected to strict ASTM E84 fire protection testing to ensure the fire retarding potassium and sodium salt crystal and polysaccharide coatings meet Class A Fire Protection Standards, if and as required by the application at hand.

### Useful Application for the Fire Retarding Biochemical Liquid Compositions of the Present Invention

As disclosed, the fire retarding biochemical compositions of the present invention are very useful in two ways: (i) producing fire retarding coatings formed by thin alkali metal (potassium and sodium) salt crystals and polysaccharides from a biomolecular polymer (e.g. Xanthan gum), deposited on surfaces during “retardant drops” on land to be protected against fire; and (ii) extinguishing active fires by application of the fire retarding biochemical composition of the present invention onto the fire during “suppression drops” to suppress and extinguish the wildfire (i.e. bushfire). The biochemical compositions of the present invention can be used for firefighting in forests, tire warehouses, landfill sites, coal stocks, oil fields, timberyards, and mines, for proactively fighting wildfires from the air, by airplanes and helicopters and drone. Also, the clean wildfire chemistry of the present invention can be used around animal such as horses, dogs, cats, and other pets without posing my health risk to such creatures, while mitigating the risks that raging wildfires will present to their lives. Also, and most significantly, the fire retarding biochemical compositions are substantially free of the many disadvantages and dangers associated with the use of phosphorus-based and nitrogen-based compounds, including ammonium-based compounds, which historically have been used in forest firefighting, and which may at the same time have an adverse effect as fertilizers in watercourses.

Furthermore, the fire retarding biochemical compositions of the present invention are very resistant to freezing when used or applied in sub-zero temperatures (e.g. less than 32 F). Thus, it is possible to obtain an aqueous biochemical composition according to the present invention which is still sprayable at temperatures below 0° C.

Notably, the liquid biochemical compositions of the present invention are non-corrosive, especially when coming in physical contact with specific metals, such as 2024-T3 Aluminum, 4130 Steel, Yellow Brass, and Az31B Magnesium, and other metals that may be used as containers for the biochemical solutions of the present invention, especially during mixing, storage, and application operations. This feature is of particular importance in relation to the proactive defense of wild fires from the air using GPS-tracked aircraft-based application/delivery vehicles (e.g. airplanes and helicopters) of the present invention shown in FIGS. 8A and 8B.

The mixed fire retarding biochemical products can also be used to proactively fight wildfire fires from the air using drones shown in FIGS. 9A and 9B, by applying and GPS-tracking the application of environmentally-clean fire retarding biochemical liquid over ground and property surfaces to create and maintain clean-chemistry fire breaks and barriers where wildfire is not to be permitted to targeted property to be protected, in accordance with the principles of the present invention. In such applications, it is best to use a mixed fire retardant solution having a formulation with the lowest viscosity as possible so that the liquid retardant will flow easily and be sprayable onto ground surfaces using a suitable nozzle technology well known in the art.

The biochemical mixed retarding products of the present invention can be used for proactively firefighting wildfires and fires that may break out in many places including, but not limited to, forests, WUI regions, tire warehouses, landfill sites, coal stocks, timberyards and even mines. The biochemical mixed retarding products of the present invention are effective in the dry state (long-term action) retarding fire ignition and flame spread on combustible surfaces treated with these mixed retardant products.

Specification of GPS-Tracked Aircraft (i.e. Helicopter) for Aerial Dropping Mixed Retardant Liquid on Ground Surfaces

FIG. 8A shows a mobile GPS-tracked manned aircraft (i.e. helicopter) system 50 adapted for serial delivery of environmentally-clean mixed fire retarding biochemical liquid of the present invention to ground surfaces in accordance with the principles of the present invention.

As shown, the aircraft system 50 comprises: a lightweight airframe 50A0 supporting a propulsion subsystem 50I provided with a set of axially-mounted helicopter blades 50A1-50A2 and 50A5, driven by combustion-engine and controlled and navigated by a GPS-guided navigation subsystem 50I2; an integrated supply tank 50B supported on the airframe 50A0, and connected to a gasoline/diesel operated motor-driven delivery pump, 50C; a control assembly 50D connected to the delivery pump 50C by way of a conduit 50E, for releasing a stream of environmentally-clean fire retarding biochemical liquid under the control of GPS-specified coordinates defining its programmed flight path during aerial dropping operations.

FIG. 8B shows the GPS-tracked fire retardant delivery system 50 of FIG. 8A as comprising a number of subcomponents, namely: a GPS-tracked and remotely-monitored AF chemical liquid delivery control subsystem 50F; a micro-computing platform or subsystem 50G interfaced with the GPS-tracked and remotely-monitored AF chemical liquid spray control subsystem 50F by way of a system bus 50I; a wireless communication subsystem 50H interfaced to the micro-computing platform 50G via the system bus 50I; and a vehicular propulsion and navigation subsystem 50I employing propulsion subsystem 50I1, and AI-driven or manually-driven navigation subsystem 50I2.

As configured in the illustrative embodiment, the GPS-tracked fire retardant delivery system 50 enables and supports (i) the remote monitoring of the application of fire retarding chemical product from the system 50 when located at specific GPS-indexed location coordinates, and (ii) the logging of an such GPS-indeed spray application operations, and recording the data transactions thereof within a local database maintained within the micro-computing platform 50G, as well as in the remote network database 9C1 maintained at the data center 8 of the system network 1.

As shown in FIG. 8B, the micro-computing platform 50G comprises: data storage memory 50G1; flash memory (firmware storage) 50G2; a programmable microprocessor 50G3; a general purpose I/O (GPIO) interface 50G4; a GPS transceiver circuit/chip with matched antenna structure 50G5; and the system bus 401 which interfaces these components together and provides the necessary addressing, data and control signal pathways supported within the system 50. As such, the micro-computing platform 50G is suitably configured to support and run a local control program 50G2-X on microprocessor 50G3 and memory architecture 50G1, 40G2 which is required and supported by the enterprise-level mobile application 12 and the suite of services supported by the system network 1 of the present invention.

As shown in FIG. 8B, the wireless communication subsystem 50H comprises: an RF-GSM modem transceiver 50H1; a T/X amplifier 50H2 interfaced with the RF-GSM modem transceiver 50H1; and a WIFI interface and a Bluetooth wireless interface 50H3 for interfacing with WIFI and Bluetooth data communication networks, respectively, in a manner known in the communication and computer networking art.

As shown in FIG. 8B, the GPS-tracked and remotely-controllable fire retardant delivery control subsystem 50F comprises: retardant chemical liquid supply sensor(s) 50F1 installed in or on the retardant chemical liquid supply tank 50B to produce an electrical signal indicative of the volume or percentage of the retardant liquid supply tank containing fire retarding biochemical liquid at any instant in time, and providing such signals to the retardant delivery system control interface 50F4; a power supply and controls 50F2 interfaced with the retardant liquid pump subsystem 50C, and also the retardant delivery system control interface 50F4; manually-operated retardant pump controls interface 50F3, interfaced with the retardant delivery system control interface 50F4; and the retardant delivery system control interface 50F4 interfaced with the micro-computing subsystem 50G, via the system bus 50I. The flash memory storage 50G2 contains microcode for a control program that run on the microprocessor 50G3 and realizes the various GPS-specified retardant delivery control, monitoring, data logging and management functions supported by the system 50.

### Specification of GPS-Tracked Autonomously-Driven Drone System Adapted for Spraying Anti-Fire (AF) Liquid on Buildings and Ground Surfaces

FIG. 9A shows a mobile GPS-tracked unmanned airborne system (UAS) or drone 40 adapted for applying environmentally-clean retardant chemical liquid of the present invention on exterior building surfaces and ground surfaces in accordance with the principles of the present invention.

As shown, the drone vehicle system 40 comprises: a lightweight airframe 40A0 supporting a propulsion subsystem 40I provided with a set of eight (8) electric-motor driven propellers 40A1-40A8, driven by electrical power supplied by a rechargeable battery module 409, and controlled and navigated by a GPS-guided navigation subsystem 4012; an integrated supply tank 40B supported on the airframe 40A0, and connected to either rechargeable-battery-operated electric-motor driven spray pump, or gasoline/diesel or propane operated motor-driven retardant pump, 40C; a control assembly 40D connected to the retardant pump 40C by way of a flexible hose 40E, for delivering environmentally-clean retardant liquid under the control of GPS-specified coordinates defining its programmed flight path during aerial delivery operations.

FIG. 9B shows the GPS-tracked retardant liquid spraying system 40 of FIG. 9A as comprising a number of subcomponents, namely: a GPS-tracked and remotely-monitored retardant chemical liquid delivery control subsystem 40F; a micro-computing platform or subsystem 40G interfaced with the GPS-tracked and remotely-monitored retardant chemical liquid delivery control subsystem 40F by way of a system bus 401; a wireless communication subsystem 40H interfaced to the micro-computing platform 40G via the system bus 401; and a vehicular propulsion and navigation subsystem 40I employing propulsion subsystem 40I1, and AI-driven or manually-driven navigation subsystem 40I2.

As configured in the illustrative embodiment, the GPS-tracked retardant liquid delivering system 40 enables and supports (i) the remote monitoring of the delivery of retardant chemical liquid from the system 40 when located at specific GPS-indexed location coordinates, and (ii) the logging of all such GPS-indexed spray application operations, and recording the data transactions thereof within a local database maintained within the micro-computing platform 40G, as well as in the remote network database 9C1 maintained at the data center 8 of the system network 1.

As shown in FIG. 9B, the micro-computing platform 40G comprises: data storage memory 40G1; flash memory (firmware storage) 40G2; a programmable microprocessor 40G3; a general purpose I/O (GPIO) interface 40G4; a GPS transceiver circuit/chip with matched antenna structure 40G5; and the system bus 401 which interfaces these components together and provides the necessary addressing, data and control signal pathways supported within the system 40. As such, the micro-computing platform 40G is suitably configured to support and run a local control program 40G2-X on microprocessor 40G3 and memory architecture 40G1, 40G2 which is required and supported by the enterprise-level mobile application 12 and the suite of services supported by the system network 1 of the present invention.

As shown in FIG. 9B, the wireless communication subsystem 30H comprises: an RF-GSM modem transceiver 40H1; a T/X amplifier 40H2 interfaced with the RF-GSM modem transceiver 40H1; and a WIFI interface and a Bluetooth wireless interface 40H3 for interfacing with WIFI and Bluetooth data communication networks, respectively, in a manner known in the communication and computer networking art.

As shown in FIG. 9B, the GPS-tracked and remotely-controllable retardant chemical liquid delivery control subsystem 40F comprises: retardant chemical liquid supply sensor(s) 40F1 installed in or on the retardant chemical liquid supply tank 30B to produce an electrical signal indicative of the volume or percentage of the retardant liquid supply tank containing retardant chemical liquid at any instant in time, and providing such signals to the retardant liquid delivery system control interface 40F4; a power supply and controls 40F2 interfaced with the liquid pump spray subsystem 40C, and also the retardant liquid delivery system control interface 40F4; manually-operated spray pump controls interface 40F3, interfaced with the retardant liquid delivery system control interface 30F4; and the retardant liquid delivery system control interface 40F4 interfaced with the micro-computing subsystem 40G, via the system bus 401. The flash memory storage 40G2 contains microcode for a control program that run on the microprocessor 40G3 and realizes the various GPS-specified retardant chemical liquid delivery control, monitoring, data logging and management functions supported by the system 40.

### Specification of GPS-Tracked Manned or Autonomous Vehicle for Ground Delivery of Mixed Fire Retarding Biochemical Liquid on Ground Surface Targets

FIG. 10A shows a mobile GPS-tracked manned or autonomous retardant delivery vehicle system 30 for applying environmentally-clean retardant chemical liquid on exterior building surfaces and ground surfaces in accordance with the principles of the present invention. As shown, the vehicle system 30 is supported on a set of wheels 30A driven by a propulsion drive subsystem 30 and navigated by GPS-guided navigation subsystem 301, and carrying an integrated supply tank 30B with either rechargeable-battery-operated electric-motor driven pump, or gasoline/diesel or propane operated motor-driven hydraulic pump, 30C, for deployment on private and public property parcels having building structures, for delivering environmentally-clean retardant liquid of the present invention disclosed herein (illustrated in FIGS. 6 to 7) to combustible surface targets (e.g. road exit ramps, road corridors, etc.) using a spray nozzle assembly 30D connected to the hydraulic pump 30C by way of a flexible hose 30E.

FIG. 10B shows the GPS-tracked mobile retardant delivery system 30 of FIG. 10A as comprising a number of subcomponents, namely: a GPS-tracked and remotely-monitored retardant chemical liquid delivery control subsystem 30F; a micro-computing platform or subsystem 30G interfaced with the GPS-tracked and remotely-monitored retardant chemical liquid delivery control subsystem 30F by way of a system bus 301; a wireless communication subsystem 30H interfaced to the micro-computing platform 30G via the system bus 301; and a vehicular propulsion and navigation subsystem 30I employing a propulsion subsystem 30I1 and AI-driven or manually-driven navigation subsystem 30I2.

As configured in the illustrative embodiment, the GPS-tracked mobile retardant liquid delivery system 30 enables and supports (i) the remote monitoring of the delivering retardant chemical liquid from the system 30 when located at specific GPS-indexed location coordinates, and (ii) the logging of all such GPS-indexed spray application operations, and recording the data transactions thereof within a local database maintained within the micro-computing platform 30G, as well as in the remote network database 9C1 maintained at the data center 8 of the system network 1.

As shown in FIG. 10B, the micro-computing platform 30G comprises: data storage memory 30G1; flash memory (firmware storage) 30G2; a programmable microprocessor 30G3; a general purpose I/O (GPIO) interface 30G4; a GPS transceiver circuit/chip with matched antenna structure 30G5; and the system bus 30I which interfaces these components together and provides the necessary addressing, data and control signal pathways supported within the system 30. As such, the micro-computing platform 30G is suitably configured to support and run a local control program 30G2-X on microprocessor 30G3 and memory architecture 30G1, 30G2 which is required and supported by the enterprise-level mobile application 12 and the suite of services supported by the system network 1 of the present invention.

As shown in FIG. 10B, the wireless communication subsystem 30H comprises: an RF-GSM modem transceiver 30H1; a T/X amplifier 30H2 interfaced with the RF-GSM modem transceiver 30H1; and a WIFI interface and a Bluetooth wireless interface 30H3 for interfacing with WIFI and Bluetooth data communication networks, respectively, in a manner known in the communication and computer networking art.

As shown in FIG. 10B, the GPS-tracked and remotely-controllable retardant chemical liquid delivery control subsystem 30F comprises: retardant chemical liquid supply sensor(s) 30F1 installed in or on the anti-fire chemical liquid supply tank 30B to produce an electrical signal indicative of the volume or percentage of the retardant liquid supply tank containing retardant chemical liquid at any instant in time, and providing such signals to the retardant liquid delivery system control interface 30F4; a power supply and controls 30F2 interfaced with the liquid pump spray subsystem 30C, and also the retardant liquid delivery system control interface 30F4; manually-operated spray pump controls interface 30F3, interfaced with the retardant liquid delivery system control interface 30F4; and the retardant liquid spraying system control interface 30F4 interfaced with the micro-computing subsystem 30G, via the system bus 301. The flash memory storage 30G2 contains microcode for a control program that runs on the microprocessor 20G3 and realizes the various GPS-specified retardant chemical liquid delivery control, monitoring, data logging and management functions supported by the system 30.

Using GPS-Tracking, Mapping and Recording Techniques to Know where Clean-Chemistry Wild Fire Breaks and Zones were Formed by Whom, and when

Using the cloud-based wildfire defense network's integrated GPS-tracking, mapping and recording techniques, as illustrated in FIGS. 4A to 5B, and 8A through 10B, fire jurisdictions can plan, create and maintain clean-chemistry wildfire breaks and zones to proactively protect property and life from raging wildfires—by effectively inhibiting specific regions of combustible fuel from ignition, along the path towards targeted property and life to be protected from the incidence of wildfire. Proactive wildfire protection according to the principles of the present invention is simple. Wherever combustible ground cover is coated with the fire retarding biochemical composition of the present invention, the combustible phase of wildfire will be interrupted, taking the energy out of a raging wildfire, by reducing fire ignition and flame spread, thereby protecting property that has been treated in advance of a wildfire incidence.

In hot dry climates, conditioned by hot dry prevailing winds, the relative humidity will be expectedly low, and in the absence of rain, the all-natural (clear) wild fire retardant dropped over targeted ground surfaces to create chemical-based wild fire breaks and zone regions, will last for long durations into weeks and months in many situations. However, whenever rain occurs, the Network will know and advise fire departments and homeowner alike that clean-chemistry wildfire breaks and zones need to be maintained by an additional application of wildfire retarding biochemical liquid, while being GPS-tracked, mapped and recorded for management purposes.

Modifications to the Present Invention which Readily Come to Mind

While the preferred embodiments of the present invention are shown and described as being formulated using a multiple alkali metal salts derived from non-polymeric saturated carboxylic acids having carbon chain length less than eight (8) to meet practical solubility requirements, it is understood that three or more alkali metal salts derived from different non-polymeric saturated carboxylic acids may be further combined together and dissolved in aqueous solution, along with a suitable thickening agent and coloring agent, to produce additional embodiments of the water-based retardant solutions of the present invention that can perform with excellent long term fire retarding functions. Such modifications fall within the scope and spirit of the present invention.

The illustrative embodiments disclose the formulation, application and we of environmentally-clean fire retarding biochemical solutions and compositions of matter. Such biochemical solutions and compositions, and serial-based methods and apparatus for dispensing and applying the same, are disclosed and taught herein for use in proactively costing the combustible surfaces such as existing on wood, lumber, and timber, and other combustible matter, wherever fire may exist or wherever wild fires may travel. However, it is understood that alternative clean fire retarding biochemical liquids may be used to practice the various wild fire prevention methods according to the principles of the present invention.

While several modifications to the illustrative embodiments have been described above, it is understood that various other modifications to the illustrative embodiment of the present invention will readily occur to persons with ordinary skill in the art. All such modifications and variations are deemed to be within the scope and spirit of the present invention as defined by the accompanying Claims to Invention.

1. A mixed fire retarding biochemical liquid for use in forming thin fire retarding potassium and sodium salt crystal and polysaccharide coatings on ground surface targets, said mixed fire retarding biochemical liquid comprising:
a major amount of water for providing an aqueous solution;
a major amount of an alkali metal potassium salt derived from the citric carboxylic acid is dissolved in the water to produce potassium ions in the aqueous solution;
a minor amount of an alkali metal sodium salt derived from the benzoic acid is also dissolved in the water to produce sodium ions in the aqueous solution,
wherein the sodium ions produced from the alkali metal sodium salt dissolved in water function as inhibitors to surface corrosion reactions involving specific metals used in the fabrication of mixing, storage and/or delivery equipment in which said mixed fire retarding biochemical liquid may come in surface contact during expected use; and
a minor amount of thickening agent in the form of a biomolecular polymer consisting of polysaccharides dissolved in the aqueous solution, to (i) form a wet concentrate liquid that can be used as is in ready-to-use form or diluted with additional water according to a wet concentrate mix ratio, so as to produce a mixed fire retarding liquid having a viscosity suitable for use in delivery of said mixed fire retarding liquid to ground surface targets to form thin fire retarding coatings comprising alkali metal potassium and sodium salt crystals mixed with polysaccharide chains of said biomolecular polymer, to provide proactive wildfire protection to treated ground surfaces.

2. The mixed fire retarding biochemical liquid of claim 1, wherein said thickening agent is biomolecular polymer selected from the group consisting of starch, glycogen, and galactogen, and cellulose, wood cellulose fiber, chitin, and one or more microbial polysaccharides produced by microorganisms selected from the group consisting of xanthan gum, dextran, welan gum, gellan gum, diutan gum and pullulan.

3. The mixed fire retarding biochemical liquid of claim 1, which further comprises a minor amount of coloring agent dissolved in said water for imparting a visible color of the fugitive or non-fugitive type when the fire retarding biochemical liquid is applied to a surface to be protected against fire, while water molecules in the retardant liquid evaporate during drying, to form said thin fire retardant coating having a characteristic visible color and comprising alkali metal potassium and sodium salt crystals mixed with the polysaccharide chains of the biomolecular polymer material.

4. The mixed fire retarding biochemical liquid of claim 1, wherein said specific metals are selected from the group consisting of Aluminum, Steel, Brass, and Magnesium.

5. The mixed fire retarding biochemical liquid of claim 1, wherein said mixed fire retarding biochemical liquid has a viscosity suitable for use in aerial delivery of said mixed fire retarding liquid from an airtanker flying at a speed and altitude relative to ground surface targets to form said thin fire retarding coatings comprising alkali metal potassium and sodium salt crystals mixed with polysaccharide chains of said biomolecular polymer, to provide proactive wildfire protection to said treated ground surfaces.

6. The mixed fire retarding biochemical liquid of claim 1, wherein said mixed fire retarding biochemical liquid has a viscosity suitable for use in ground-based delivery of said mixed fire retarding liquid from a ground-based tanker moving at a speed relative to ground surface targets to form said thin fire retarding coatings comprising alkali metal potassium and sodium salt crystals mixed with polysaccharide chains of said biomolecular polymer, to provide proactive wildfire protection to said treated ground surfaces.

7. A mixed fire retarding biochemical liquid for use in forming thin fire retarding potassium and sodium salt crystal and polysaccharide coatings on ground surface targets, said mixed fire retarding biochemical liquid comprising:
(a) the dispersing agent is realized in the form of a major amount of water, for dispersing alkali metal ions dissolved in the water;
(b) a major amount of a first fire retarding agent realized in the form of a first alkali metal salt of a nonpolymeric saturated carboxylic acid, specifically, tripotassium citrate powder, for providing potassium ions dispersed in the water when the first one alkali metal salt is dissolved in the water to form a mixed retardant solution;
(c) a minor amount of a second fire retarding agent realized in the form of a second alkali metal salt of a nonpolymeric saturated carboxylic acid, specifically, sodium benzoate (SB) powder, for providing sodium ions dispersed in the water when the second alkali metal salt is dissolved in the mixed retardant solution, functioning as a secondary fire retardant agent while inhibiting surface corrosion reactions involving specific metals used in the fabrication of mixing, storage and/or delivery equipment in which said mixed fire retarding biochemical liquid may come in surface contact during expected use; and
(d) a minor amount of thickening agent in the form of a biomolecular polymer consisting of polysaccharide chains, for increasing the viscosity of the mixed fire retarding biochemical liquid during retardant delivery operations,
wherein when said mixed fire retarding biochemical liquid has been applied to a ground surface to be protected against wildfire, while water molecules in said mixed fire retarding biochemical liquid evaporate during drying, to form a thin fire retardant coating comprising potassium and sodium salt crystals mixed within the polysaccharide chains of the biomolecular polymer material, deposited on the treated surfaces.

8. The mixed fire retarding biochemical liquid of claim 7, wherein said thickening agent is biomolecular polymer selected from the group consisting of starch, glycogen, and galactogen, and cellulose, wood cellulose fiber, chitin, and one or more microbial polysaccharides produced by microorganisms selected from the group consisting of xanthan gum, dextran, welan gum, gellan gum, diutan gum and pullulan.

9. The mixed fire retarding biochemical liquid of claim 7, which further comprises a minor amount of coloring agent dissolved in said water for imparting a visible color of the fugitive or non-fugitive type when the fire retarding biochemical liquid is applied to a surface to be protected against fire, while water molecules in the retardant liquid evaporate during drying, to form said thin fire retardant coating having a characteristic visible color and comprising alkali metal potassium and sodium salt crystals mixed with the polysaccharide chains of the biomolecular polymer material, deposited on the treated ground surfaces.

10. The mixed fire retarding biochemical liquid of claim 7, wherein said specific metals are selected from the group consisting of Aluminum, Steel, Brass, and Magnesium.

11. The mixed fire retarding biochemical liquid of claim 7, wherein said mixed fire retarding biochemical liquid has a viscosity suitable for use in aerial delivery of said mixed fire retarding liquid from an airtanker flying at a speed and altitude relative to ground surface targets to form said thin fire retarding coatings comprising alkali metal potassium and sodium salt crystals mixed with polysaccharide chains of said biomolecular polymer, to provide proactive wildfire protection to said treated ground surfaces.

12. The mixed fire retarding biochemical liquid of claim 7, wherein said mixed fire retarding biochemical liquid has a viscosity suitable for use in ground-based delivery of said mixed fire retarding liquid from a ground-based tanker moving at a speed relative to ground surface targets to form said thin fire retarding coatings comprising alkali metal potassium and sodium salt crystals mixed with polysaccharide chains of said biomolecular polymer, to provide proactive wildfire protection to said treated ground surfaces

13. A dry concentrate fire retarding biochemical composition for mixing with water according to a mix ratio to produce a mixed fire retarding biochemical liquid for use in aerial retardant dropping operations, said dry concentrate fire retarding biochemical composition comprising:
(a) a minor amount of a first fire retarding agent realized in the form of major amount of a first alkali metal salt of a nonpolymeric saturated carboxylic acid, specifically, tripotassium citrate (TPC), for providing metal potassium ions to be dissolved and dispersed in a major amount of water;
(b) a minor amount of a second fire retarding agent realized in the form of a second alkali metal salt of a nonpolymeric saturated carboxylic acid, specifically, sodium benzoate (SB) powder, for providing sodium ions dispersed in the water when the second alkali metal salt is dissolved in the mixed retardant solution, functioning as a secondary fire retardant agent while inhibiting surface corrosion reactions involving specific metals used in the fabrication of mixing, storage and/or delivery equipment in which said mixed fire retarding biochemical liquid may come in surface contact during expected use;
(c) a minor amount of thickening agent in the form of a biomolecular polymer consisting of polysaccharide chains, for increasing the viscosity of the mixed fire retarding biochemical liquid during aerial dropping operations,
wherein the dry powder components described above are mixed together and dissolved in the major amount of water to produce a mixed retardant product in either ready-to-use non-diluted form, or wet concentrate form for mixing with a specified amount of water, so as to produce the mixed fire retardant product adapted for application to combustible surfaces on the ground by aerial delivery or ground delivery methods, while water molecules in the mixed retardant liquid evaporate during drying, form a thin fire retardant coating on the combustible surfaces, and comprising potassium and sodium salt crystals mixed with the polysaccharides chains of said biomolecular polymer material, that provide proactive fire protection long after the water molecules have evaporated to the ambient environment.

15. The dry concentrate fire retarding biochemical composition of claim 13, wherein said thickening agent is biomolecular polymer selected from the group consisting of starch, glycogen, and galactogen, and cellulose, wood cellulose fiber, chitin, and one or more microbial polysaccharides produced by microorganisms selected from the group consisting of xanthan gum, dextran, welan gum, gellan gum, diutan gum and pullulan.

16. The dry concentrate fire retarding biochemical composition of claim 13, which further comprises a minor amount of coloring agent dissolved in said water for imparting a visible color of the fugitive or non-fugitive type when the fire retarding biochemical liquid is applied to a surface to be protected against fire, while water molecules in the retardant liquid evaporate during drying, to form said thin fire retardant coating having a characteristic visible color and comprising alkali metal potassium and sodium salt crystals mixed with the polysaccharide chains of the biomolecular polymer material, deposited on the treated ground surfaces.

17. The dry concentrate fire retarding biochemical composition of claim 13, wherein said specific metals are selected from the group consisting of Aluminum, Steel, Brass, and Magnesium.

18. The dry concentrate fire retarding biochemical composition of claim 13, wherein said mixed fire retarding biochemical liquid has a viscosity suitable for use in aerial delivery of said mixed fire retarding biochemical liquid from an airtanker flying at a speed and altitude relative to ground surface targets to form said thin fire retarding coatings comprising alkali metal potassium and sodium salt crystals mixed with polysaccharide chains of said biomolecular polymer, to provide proactive wildfire protection to said treated ground surfaces.

19. The dry concentrate fire retarding biochemical composition of claim 13, wherein said mixed fire retarding biochemical liquid has a viscosity suitable for use in ground-based delivery of said mixed fire retarding biochemical liquid from a ground-based tanker moving at a speed relative to ground surface targets to form said thin fire retarding coatings comprising alkali metal potassium and sodium salt crystals mixed with polysaccharide chains of said biomolecular polymer, to provide proactive wildfire protection to said treated ground surfaces.

20. A mixed fire retardant liquid for delivery to ground surface targets by way of aerial or ground delivery methods, said mixed fire retardant liquid comprising:
a major amount of water for providing an aqueous solution;
a major amount of alkali metal potassium salt derived from citric carboxylic acid dissolved in the aqueous solution;
a minor amount of alkali metal sodium salt derived from benzoic carboxylic acid, dissolved in the aqueous solution;
a minor amount of thickening agent in the form of polysaccharides of a biomolecular polymer, specifically wood cellulose fiber, dissolved in the aqueous solution; and
a minor amount of coloring agent dissolved in the aqueous solution to form a mixed retardant liquid and imparting a characteristic color to said mixed fire retardant liquid for delivery to ground surface targets by way of aerial or ground delivery methods, so as to form thin fire-retarding potassium and sodium salt crystal and polysaccharide based coatings, that provide long duration proactive fire protection to the ground surface targets.
